(19) United States
(12) Patent Application Publication
(10) Pub. No.: US 2025/0371302 A1
(43) Pub. Date: Dec. 4, 2025

(54) SMART CARD FOR COMMUNICATION WITH AN EXTERNAL READER

(71) Applicant: AdvanIDe Holdings Pte Ltd., Singapore (SG)

(72) Inventors: Ralf Henn, Singapore (SG); Joe Lo, Singapore (SG); Holger Roessner, Singapore (SG)

(21) Appl. No.: 19/224,391

(22) Filed: May 30, 2025

Related U.S. Application Data
(63) Continuation-in-part of application No. 18/680,339, filed on May 31, 2024, now Pat. No. 12,353,936.

(51) Int. Cl. G06K 19/07; G06K 19/077

(52) U.S. Cl. CPC G06K 19/0726; G06K 19/07754; G06K 19/07779

(57) ABSTRACT

The application relates to a smart card comprising a first, second and third coil. The second coil is part of an LC network and is preferably positioned within the third coil. The second coil improves the tuning of the third coil, which acts as an antenna coil, to match the third coil to an external reader. This arrangement allows improved interaction between the smart card and an external reader.

### CROSS REFERENCE TO RELATED APPLICATIONS

The present application is a continuation-in-part of U.S. Non-Provisional patent application Ser. No. 18/680,339, entitled “SMART CARD FOR COMMUNICATION WITH AN EXTERNAL READER”, filed on May 31, 2024, and U.S. Non-Provisional patent application Ser. No. 19/222,663, entitled “SMART CARD FOR COMMUNICATION WITH AN EXTERNAL READER”, filed on May 29, 2025. The entire contents of the above-listed applications are hereby incorporated by reference for all purposes.

### TECHNICAL FIELD

The present application generally relates to a smart card, and more particularly to a smart card comprising a first, a second and a third coil, wherein the second coil is arranged within an interior space of the third coil and configured as a passive, non-radiating component of an LC network for matching the third coil with an external reader antenna.

### BACKGROUND

Generally, a smart card is a portable device equipped with embedded integrated circuits that can process and store data securely. These cards utilize contact or contactless methods to communicate with readers, performing functions such as authentication, data storage, and application processing. Commonly used in financial transactions, identity verification, access control, and public transport systems, smart cards provide enhanced security over traditional magnetic stripe cards. Synonyms for a smart card may include terms such as chip card, integrated circuit card (ICC), microchip card, and electronic card, among others. This list is merely a representative selection of the various alternative names used.

### SUMMARY

To enable data exchange between an external reader and a smart card, the external reader generates a high frequency magnetic field. This magnetic field induces a current in an antenna coil. The antenna coil is connected to a microchip, possibly by inductive coupling. This coupling provides the necessary power to operate the microchip and facilitates the transmission of data.

US20130075477 A1 discloses a data carrier such as a smart card comprising an antenna module and a booster antenna. The booster antenna has an outer winding and an inner winding, each of which has an inner end and an outer end. A coupler coil is provided, connecting the outer end of the outer winding and the inner end of the inner winding. The inner end of the outer winding and the outer end of the inner winding are left un-connected. The coupler coil may have a clockwise or counterclockwise sense which is the same as or opposite to the sense of the outer and inner windings. Various configurations of booster antennas are disclosed.

The object of the application is to provide a smart card which improves the performance and functionality in communication with external readers.

The object of the application is solved by the features of the independent claims. Advantageous embodiments of the application are described in the dependent claims.

The application provides solutions for enhancing the matching between the smart card's antenna system and the external reader antenna, thus enabling efficient communication.

In this context, the disclosed smart card comprises in particular a unique coil configuration which allows and optimized inductive coupling with external readers. This configuration provides an antenna system in the smart card with three coils, wherein a second coil is part of an LC network, which is arranged in an interior space of a third coil and improves the matching of the third coil, which acts as an antenna coil, to the resonant frequency of the external reader. In addition, the third coil can be connected to a first coil which can be coupled to a microchip. Through this design, the smart card achieves a higher sensitivity and more reliable data exchange, making it ideal for various applications requiring secure and rapid communication.

The structural design of the smart card according to the application not only enhances communication capabilities, but also ensures that the card is robust, maintaining high structural integrity. The arrangement of the coils and the use of durable materials help to ensure that the smart card retains its functionality when subjected to physical stresses such as bending or pressure. In addition, this design allows for efficient use of space within the card, facilitating the integration of additional features such as security elements or personalization options, without compromising performance or size.

In a first aspect the application refers to elements of the configuration of three coils for a smart card, various advantageous effects can be seen. These elements can be combined with the other elements in the present application as described below.

The smart card may comprise a first coil, a second coil and a third coil. The first coil has turns defining a perimeter of a first surface area of the smart card and defining a first interior space within the first surface area surrounded by turns of the first coil. The second coil has turns defining a perimeter of a second surface area of the smart card and defining a second interior space within the second surface area surrounded by turns of the second coil. The third coil has turns defining a perimeter of a third surface area of the smart card and defining a third interior space within the third surface area surrounded by turns of the third coil. The second coil is arranged within the third interior space and configured as a passive, non-radiating component of an LC network for matching the third coil with an external reader antenna.

The configuration of the first, second, and third coils with distinct interior spaces and perimeters allows for the optimization of the card's inductive coupling capabilities with various external reader antennas, enhancing communication reliability. The arrangement of the second coil within the third interior space as a passive component of an LC network facilitates matching the resonance characteristics of the third coil with the external readers antenna. Moreover, this arrangement allows for a compact design of the coils, particularly of the third coil, which maintains effective bidirectional communication capabilities. Since the third coil is matched to an external reader antenna by the second coil, the matching of the third coil to the external reader is not determined solely by the geometric design of the third coil. A small third coil can therefore be used which is still matched to the external reader by the second coil. This leads to more space on the card for personalization, e.g. by laser engraving.

Compared to a system in which only a capacitor is used for tuning or matching, the inclusion of a dedicated second coil (or tuning coil or matching coil) allows for a more refined and spatially decoupled adjustment of the resonance characteristics. This enables precise electromagnetic tuning without requiring direct modification of the antenna coil (third coil) itself, thereby improving field control, reducing sensitivity to manufacturing tolerances, and simplifying the overall system design.

As used herein, the term “non-radiating” does not imply the complete absence of electromagnetic fields, since any current-carrying conductor inevitably generates such fields in its vicinity. Rather, the term is used to characterize conductive structures which are not configured, dimensioned, or functionally intended to emit electromagnetic energy beyond the immediate region.

In this context, the second coil is implemented as a passive component of an LC matching network, designed to tune or match the third coil (e.g., an antenna coil) to an external reader antenna. Compared to the third coil, the second coil is not intended to radiate and generates only minimal electromagnetic fields, insufficient to serve as an active transmitting element.

In other words, the second coil is designed such that, by itself, it is neither resonant with nor impedance-matched to the external reader antenna, and therefore does not effectively absorb or extract energy from the external electromagnetic field.

The first coil can be used to ensure that the signal or energy received from the third coil is transmitted to an IC module, which includes a microchip, via inductive coupling. Therefore, the first coil can be electrically connected to the third coil. When a current is induced in the third coil, it simultaneously induces a current in the first coil, which in turn generates a magnetic field.

This first coil is positioned in relation to an IC module coil such that the magnetic field it generates can induce a current in the IC module coil. The IC module coil, located on the IC module, then supplies current to the microchip. Thus, the first coil also functions as a first coupler coil and the IC module coil as a second coupler coil. Insofar, the first coil may be configured to couple to an IC module coil. By configuring the first coil to couple specifically to an IC module coil, the design ensures a dedicated and efficient energy transfer pathway for powering the smart card's microchip.

The first coil is further designed so that it does not match with the external reader and, as a result, does not effectively absorb any energy from it.

The smart card may further comprise a second coil being separate from the first coil. The distinct configuration of the first and second coils can provide spatial separation that reduces electromagnetic interference between the coils, resulting in clearer signal transmission and reception.

The second coil can be particularly configured to match the third coil with an external reader antenna. In this context, the second coil functions as a passive, non-radiating component of an LC network, which is a synonym for a resonant circuit, resonance circuit or inductor capacitor circuit. In order for the second coil to act as a component of an LC network, it can be connected to a capacitive element. This connection can be either in parallel or in series with the capacitive element. The second coil does not radiate energy (being passive) nor does it absorb substantial radiation from the external reader. This is because the second coil is not effectively matched with the external reader antenna. Instead, the energy from the reader antenna is primarily absorbed by the third coil, which is specifically designed to be matched with the external reader's antenna. Furthermore, the second coil is neither configured as a dipole nor as a quasi-dipole.

The third coil can act as an antenna for the smart card and is therefore referred to as an antenna coil. In order to absorb as much energy as possible from the external reader, the third coil must match the resonant frequency. This can be achieved by the design of the coil and can also be influenced by an additional LC network. Since the third coil is tuned to the resonant frequency and the first and second coils are not close to the resonant frequency due to their design, the amount of induced current in the first and second coils is an order of magnitude lower than the current induced in the third coil. Accordingly, the sensitivity of reception depends greatly on characteristics of the third coil.

The design approach ensures that the smart card can operate effectively within transmission protocols such as AM (Amplitude Modulation) and SSB (Single Side Band), maintaining clear and reliable communication.

Amplitude Modulation (AM) is generally a modulation technique used in wireless communication to transmit information through waves. In this method, the amplitude of a carrier wave, typically a sine wave, is varied in direct proportion to the amplitude of the signal being transmitted.

Single Side Band (SSB) is generally a refinement of amplitude modulation that reduces bandwidth and power usage by eliminating one of the sidebands and the carrier frequency in an AM signal. SSB transmits only one of the sidebands (either upper or lower) which contains the actual information, making it more efficient than AM.

Using the high-frequency magnetic field, information can be transmitted. In this setup, the smart card can send information back to the reader. The external reader emits an electromagnetic field through its antenna, which the smart card captures. Through induction, a current is generated in the smart card's antenna coil, powering the microchip. This activated microchip may decode commands from the external reader. Subsequently, the smart card can encode and modulate the response into the emitted field. This allows the smart card to transmit its serial number or other requested information. The smart card itself does not produce a field but modifies the electromagnetic transmission field of the reader. By changing the impedance via integrated switching circuits, a distinct signal can be created. This alteration in the field can be detected by the external reader and utilized for digital communication. The smart card can modulate the carrier signal, which is then received by the reader for communication.

Furthermore, the second coil can be separate from the third coil, the third coil being larger in diameter than the first and second coils. The larger diameter of the third coil compared to the first and second coils can increase the effective inductive coupling area, which may enhance the range and strength of communication with external reader antennas. The separation of the second coil from the third coil allows for the third coil to be specifically optimized for interactions with reader antennas. Additionally, the increased diameter of the third coil permits the accommodation of the other two coils within its structure, thereby supporting a compact and integrated design.

In this context, “separate” particularly refers to a spatial separation, in particular enabling each coil to generate its own magnetic field independently. However, the coils can still be interconnected, possibly configured in serial or parallel arrangements. This refers in particular to the separation of the second coil from the third coil, as well as the separation of the second coil from the first coil. However, the first coil can also be separated from the third coil.

The smart card can further comprise a third surface area being larger than the first and second surface areas. The larger third surface area provides a greater spatial region for inductive coupling, which can lead to a more robust communication link with the external reader. A larger third surface area can also accommodate additional electronic components or the first and second coil, thus offering flexibility in design and functionality. In particular, when the third surface area includes the first and second surface areas, i.e. the first and second coils, it enables a compact and integrated coil design.

The first and second surface areas may not overlap one another. The first and second surface areas can either both lie within the third surface area, or the second surface area lies within the third surface area and the first surface area outside the third surface area, or vice versa. Or neither of the two surface areas lies within the third surface area. This spatial separation can reduce the risk of interference between different functional areas of the card, thereby improving the reliability and performance of the card's electronic functions.

In the context of a smart card with multiple coils, “surface area” pertains to the area enclosed by the perimeter of the turns of each coil. These coils may be arranged in a flat, planar configuration on the smart card, such that the turns of each coil encompass an internal area. This configuration can include both the physical space occupied by each coil on the card and the inner area circumscribed by the turns of the coils.

As already mentioned above, second coil may be configured as a non-energy capturing and non-energy absorbing component that is not involved with signal transmission between the smart card and the external reader. The second coil is insofar configured so as to reduce or avoid being a load to a send coil of the external reader. Due to its design, the second coil is not tuned to the resonant frequency of the external reader's antenna, which means that it only absorbs minimal or almost no energy when exposed to the reader's high-frequency magnetic field. This effectively prevents the magnetic field generated by the second coil from interfering with the third coil, which could otherwise disrupt the received signal. It has been shown that the energy absorption of the second coil and the magnetic field generated by it is within the range of the normal noise already acting on the smart card, and in particular on the third coil.

In the context of communication systems, noise refers to any unwanted electrical or electromagnetic interference that distorts or corrupts the signal being transmitted. Noise can originate from various sources, both internal and external to the system, including thermal activity within electronic components, electromagnetic disturbances from other electronic devices, and atmospheric phenomena such as lightning and solar flares.

Furthermore, the smart card may comprise a microchip and a capacitive element, wherein the second coil and the capacitive element form the LC network, and wherein the IC module coil is connected to the microchip. As already indicated in the passages above, the integration of a resonance circuit comprising a second coil and a capacitive element enhances the efficiency of energy transfer between the smart card and an external reader, thereby improving the reliability of data transmission. Since the microchip receives its energy from the IC module coil, which is generated by the inductive coupling with the first coil, a modular structure is possible, leading to simplified assembly. This means that the microchip and the IC module coil can be assembled as a module in any smart card without having to be wired. In addition, the microchip can be better protected against interference from the third coil, as it is not directly connected to it. In the same way, the microchip does not affect the third coil. The microchip can further comprise a memory or other relevant components for data processing and transmitting.

The capacitive element and the second coil can be a structural unit, wherein the capacitive element is formed by two wire ends of the second coil. Combining the capacitive element and the second coil into a single structural unit simplifies the card's design, which can lead to a reduction in manufacturing complexity and associated costs. The capacitive element being formed by two wire ends of the second coil can provide a self-contained LC network with minimal components, which can improve the card's durability by reducing the number of potential failure points.

Furthermore, it is possible that the capacitive element and the second coil are separate elements. In this regard, the capacitive element may be connected to both wire ends of the second coil to constitute a parallel resonance circuit. A parallel resonance circuit configuration can contribute to a more stable tuning of the resonance frequency.

Preferably, the microchip can be mounted on an IC module. In this respect, the smart card may comprise an IC module with a module substrate. The IC module can comprise terminal electrodes serving as a contact-type transmission section and an IC module coil which serves as a non-contact-type transmission section. The inclusion of terminal electrodes on the module substrate allows for reliable electrical contact when the card is used in contact-type readers, ensuring consistent data transmission. The IC module coil serving as a non-contact-type transmission section provides the flexibility of contactless communication. Insofar, the arrangement allows dual interface operations with the smart card, i.e. contact and non-contact transmission. The IC module's dual functionality, with terminal electrodes for contact-type transmission and an IC module coil for non-contact-type transmission, offers versatility in communication methods, allowing the card to be used with a wider range of external communication devices. By incorporating both contact and non-contact transmission sections within the same IC module, the card can provide seamless user experiences, switching between transmission modes as required without the need for additional external components. IC is preferably the short form for the term “integrated circuit”.

The terminal electrodes and the IC module coil can be formed on different surfaces of the module substrate by etching the double-sided cladded module substrate. Forming terminal electrodes and the IC module coil on different surfaces of a double-sided cladded module substrate optimizes the use of space and can reduce the overall thickness of the card. The etching process used to form the electrodes and coil can achieve high precision. By utilizing different surfaces of the module substrate, the card can achieve a separation of electrical components.

Further, the microchip can be connected to the terminal electrodes of the module substrate via through-holes that are filled with a conductive material. Connecting the microchip to the terminal electrodes via through-holes filled with conductive material ensures a robust and durable electrical connection that can withstand mechanical stress. The use of through-holes filled with conductive material for chip connection allows for a more streamlined design by eliminating the need for wire bonding or surface-mount techniques.

The microchip can be connected to the IC module coil by wire-bonding to constitute a circuit. The wire-bonding can be made of Au or Ag wires. The choice of Au or Ag wires for wire-bonding offers good corrosion resistance, ensuring the longevity and durability of the electrical connections under various environmental conditions. It is possible that the wire bonding and/or the microchip are encapsuled by glob-top or dam-and-fill material. This protects the components from physical damage and environmental contaminants, thereby enhancing the card's overall robustness. The use of encapsulation materials such as glob-top or dam-and-fill can also provide effective thermal management for the microchip and wire bonds.

The first coil, the second coil, the third coil may comprise a wire having a thickness of 0.8 mm. The utilization of a wire with a specific thickness for the first, second, and third coils ensures that the card can be designed with a precise control over the electrical characteristics, such as resistance and inductance, which can improve the card's performance in terms of energy efficiency and signal clarity. The choice of wire thickness may also contribute to the mechanical robustness of the coils, potentially enhancing the durability of the card against physical stresses and strains during everyday use.

The first coil, the second coil, the third coil may be formed by winding insulation-coated conductor wires. Winding the coils with insulation-coated conductor wires can prevent short-circuits and electrical leakage between adjacent turns of the coil, thereby improving the reliability and safety of the smart card. The insulation coating can also protect the conductor wires from environmental factors such as moisture and chemicals, which can extend the lifespan of the smart card by preventing corrosion and degradation of the coils. The insulation used on the on the coated conducted wires can be for example polyurethane or polyesterimide. It is important that the coating is free of magnetic particles so that no undesirable attenuation of HF signals occurs.

Moreover, the first coil, the second coil and the third coil may have different pitches. Having coils with different pitches can allow for the optimization of each coil's inductive properties for specific functions, such as energy transfer or data communication, leading to enhanced overall performance of the smart card. In this regard, the pitch of the first coil is adjusted such that there is a good coupling between the first coil and the third coil. The pitch of the third coil is adjusted such that there is a good coupling between the first coil and the second coil and the external reader antenna. The pitch of second coil is adjusted such that there is a good coupling between the first coil and third coil. The pitch of a coil can, for example, be defined as the distance between the individual turns or loops of the coil.

In addition, a system can be provided. The system comprises a smart card according to the application and an external reader, wherein the external reader is configured to emit a high-frequency magnetic field which can induce a current in the third coil. The configuration of the external reader to emit a high-frequency magnetic field that can induce a current in the third coil allows for efficient energy transfer and communication between the reader and the smart card, even at a distance. The ability of the external reader to induce current in the third coil can enable passive operation of the smart card, eliminating the need for an internal power source and thus reducing the card's weight and thickness.

Furthermore, a method for communication between a smart card and an external reader with a transceiver coil can be provided. The method comprises the following method steps: emitting a high-frequency magnetic field from the transceiver coil, and providing the smart card according to the application in the high-frequency magnetic field so that a current is induced in the third coil. The method of communication enables a contactless interface between the smart card and the external reader, which not only enhances user convenience but also reduces wear and tear on the physical components, extending the card's lifespan. By inducing a current in the third coil through the high-frequency magnetic field, the method ensures a rapid and efficient energy transfer. The simplicity of the communication method, involving just the emission of a magnetic field and the placement of the card within it, allows for easy implementation and scalability across various smart card applications and systems.

The skilled person will recognize that the advantages, technical effects and preferred embodiments discussed in connection with the smart card, or the system apply analogously to the method for communication between a smart card and an external reader. Likewise, all the advantages, technical effects and preferred embodiments described in connection with the method are transferable to the smart card or system.

In further aspects that refer to elements of embedding of coils in an antenna substrate, various advantageous effects can be seen. These elements can be combined with the other elements in the present application as described above and below.

In this respect, the application relates to a method of wire embedding for a smart card. The method may comprise the following steps. A wire of a first coil and a third coil are applied to an antenna substrate of the smart card so as to embed the wire of the first and third coils onto the antenna substrate using a constant downward force throughout the laying and embedding of the two coils. The first coil has turns of wire defining a perimeter of a first surface area of the smart card and defining a first interior space within the first surface area surrounded by turns of wire of the first coil. The third coil has turns of wire defining a perimeter of a third surface area of the smart card and defining a third interior space within the third surface area surrounded by turns of the third coil. The application of a constant downward force throughout the laying and embedding process ensures uniform embedding depth of the wire into the antenna substrate, which leads to improved structural integrity and reliability of the smart card. Further, the constant force applied avoids the need for varying downward forces during different stages of the embedding process. Insofar, the force profile according to the application is flat. Additionally, the constant force leads to much faster method and is more reliable than working with a force profile. Accordingly, simpler embedding equipment can be used.

The downward force can refer to a force exerted downward on an object as the wires or the smart card. In physics and engineering contexts, it typically describes the pressure applied by a mechanism. Preferably, the downward force is the vertical force applied downward during the embedding process. In this context, the downward force can also refer to the constant pressure exerted to press materials into an antenna substrate uniformly. In sense of the application downward force can be synonym simply to force or downforce.

Furthermore, the method can further comprise that a wire of a second coil is applied to the antenna substrate of the smart card so as to embed the wire of the second coil onto the antenna substrate using a constant downward force throughout the laying and embedding of the second coil. The second coil has turns of wire defining a perimeter of a second surface area of the smart card and defining a second interior space within in the second surface area surrounded by turns of wire of the second coil. Embedding the second coil using the same constant downward force as the first and third coils ensures consistency in the manufacturing process, leading to a uniform product quality. It leads to the already mentioned advantages of manufacturing that apply to the method steps of applying the first and second coils with a constant downward force. As described above, the second coil can be part of an LC network and thus match the third coil to the resonant frequency of the antenna.

The method step of applying wire of the first, second, and third coils may include ultrasonic vibration along with the constant downward force for embedding the wire into the antenna substrate. The use of ultrasonic vibration in conjunction with the constant downward force can enhance the embedding process by promoting better adhesion of the wire to the substrate, reducing the likelihood of wire detachment over time. Ultrasonic vibration may also allow for the embedding of wire into harder or more resistant substrates without increasing the downward force. The combination of ultrasonic vibration and constant force lead to a faster embedding process.

The method of applying wire from the first, second, and/or third coils onto the antenna substrate of the smart card can incorporate various techniques, each designed to enhance the accuracy and quality of the embedding process. One technique is the pressure roller method, where precision-engineered rollers exert a constant force to press the wire into the antenna substrate. Another approach involves a heated roller method, which uses rollers heated to a controlled temperature that softens the substrate, facilitating smoother wire embedding.

Additionally, a vacuum-assisted embedding method can employ vacuum suction to precisely position the wire on the substrate, ensuring accurate placement. A pneumatic press method can also be used, applying uniform force over a larger area to embed the wire, which is particularly effective for consistent depth and adherence. Finally, a laser-assisted embedding method can utilize a laser to pre-soften the substrate along the planned wire path, allowing for easier and more precise embedding of the wire. Each of these techniques can be used alone or in combination to optimize the embedding process, depending on the specific requirements of the smart card production.

An antenna substrate can be a layer within a smart card that houses or accommodates the antenna coils i.e. the antenna coils are embedded or integrated into the antenna substrate. This substrate forms the base where wires from the antenna coils are embedded and is specifically designed for seamless integration into the smart card. After embedding the antenna coils, it can establish a strong, durable connection that remains intact over time. Preferably, the antenna substrate contains no metallic materials.

The antenna substrate may consist of materials such as PVC (Polyvinyl Chloride), PC (Polycarbonate), PET (Polyethylene Terephthalate), or PETG (Polyethylene Terephthalate Glycol-modified). Utilizing a substrate made from materials such as PVC, PC, PET, or PETG provides flexibility in the manufacturing process, as these materials are widely available and can be selected based on cost, mechanical properties, or other application-specific requirements. These materials can in particular provide the necessary mechanical support for the embedded wires while maintaining the electronic card's overall thin profile. These materials have also good durability and environmental resistance properties which can enhance the longevity and robustness of the antenna substrate in various operating conditions.

The antenna substrate can be formed by lamination of layers into a monoblock substrate without use of adhesives. Forming the antenna substrate by lamination of layers into a monoblock substrate without the use of adhesives eliminates potential points of failure associated with adhesive degradation over time, thereby increasing the structural integrity of the substrate.

The absence of adhesives in the lamination process can reduce the overall manufacturing costs and complexity.

The antenna substrate may be provided in a sheet, wherein the sheet is divided into a plurality of sections, each of which is intended for a corresponding smart card, wherein on each section the wires are embedded. On each section wires for the first coil, the second coil, the third coil and/or the capacitive element can be embedded. Providing the antenna substrate in a sheet divided into sections for individual smart cards streamlines the manufacturing process, allowing for simultaneous production of multiple units and reducing production time. This approach can reduce material waste by optimizing the layout of the wire coils on the substrate, leading to cost savings and environmental benefits.

Furthermore, the method can comprise the step of applying wire of a capacitive element to the antenna substrate of the smart card so as to embed the wire of the capacitive element onto the antenna substrate using a constant downward force throughout the laying and embedding of the capacitive element. As previously mentioned, this capacitive element is connected to the second coil, forming an LC network. The advantages of an LC network in the context of the application have been already described above. It is also beneficial that all coils, along with the capacitive element, can be applied to the antenna substrate in a single, simultaneous processing step.

Additionally, a method for manufacturing a smart card can be provided. The method comprises the method steps described above. Then, the antenna substrate can be collated with at least one card substrate by means of lamination, using heat and pressure. The lamination of the antenna substrate with one or more card substrates using heat and pressure ensures a durable bond, enhancing the structural integrity and longevity of the smart card. The use of lamination in the manufacturing process allows for the integration of various functional layers, potentially improving the card's resistance to environmental factors such as moisture and temperature variations.

The antenna substrate can be arranged between two compensation layers and form an inlay, before being laminated with the at least one card substrate. Positioning the antenna substrate between two compensation layers before lamination helps to protect the antenna coils from mechanical stresses during card use, thereby maintaining the card's functionality over time. The compensation layers can also help to maintain the structural integrity of the inlay during the lamination process, preventing warping or misalignment that could affect the performance of the antenna coils. The antenna substrate may have a thickness of 50 micrometers to 250 micrometers, preferably of 150 micrometers.

The compensation layer can comprise the same material as the antenna substrate. Accordingly, the compensation layer can comprise PVC, PC, PET, or PETG. The compensation layer may have a thickness of 20 micrometers to 200 micrometers, preferably of 105 micrometers.

The card substrate may comprise a printed layer, a PVC layer or an overlay layer, wherein the card substrate can also comprise a combination of a printed layer, PVC layer and/or an overlay layer. The ability to combine different layers such as printed, PVC and overlay layers in the card substrate provides flexibility in tailoring the physical properties of the card, such as stiffness, transparency and surface finish, to specific application requirements.

A printed layer can refer to a layer that is directly applied to the antenna substrate or to the inlay by printing technology. A printed layer can also refer to a layer that is first printed (to a sheet or layer) and then placed and laminated on the antenna substrate or inlay. The printed layer may have a thickness of 15 micrometers to 190 micrometers, preferably of 100 micrometers.

The PVC layer of the card substrate may also have a thickness of 15 micrometers to 190 micrometers, preferably of 100 micrometers.

An overlay layer in a smart card can act as a protective coating. It can be designed as a clear, durable material applied directly over the printed layer and any intermediate layers, such as PVC, to protect them from physical wear, moisture and environmental elements. The overlay layer may have a thickness of 5 micrometers to 100 micrometers, preferably of 50 micrometers.

The antenna substrate and/or the inlay and the card substrate can be provided in sheets which are divided into a plurality of sections each of which is intended for a corresponding smart card, wherein the plurality of sections are cut or punched out to form plurality of smart cards. Providing the antenna substrate and/or inlay and the card substrate in sheets that are divided into multiple sections streamlines the manufacturing process, enabling mass production and reducing waste. The pre-sectioned sheets facilitate easy handling and alignment during the punching or cutting process.

Furthermore, an engagement hole for an IC module can be formed in the card substrate indented for each smart card by way of milling. The formation of an engagement hole in the card substrate by milling provides a precise and clean recess for accommodating an IC module, ensuring a snug fit and reducing the likelihood of misalignment or movement of the module within the smart card. Milling the engagement hole allows for the customization of the hole's dimensions to match various IC module sizes, enhancing the versatility of the smart card manufacturing process to accommodate different module specifications. The milled engagement hole also allows for low profile of the smart card, as the IC module can be fully integrated into the substrate.

The IC module can comprise an IC module coil, a microchip, a module substrate and electrodes. In this respect the module substrate is preferably cladded with a copper foil. The electrodes and the IC module coil are formed on different surfaces of the substrate module by etching the copper cladded module substrate. The microchip is connected to the IC module coil by wire bonding, and the substrate module comprises through holes filled with conductive material which serve as a connection between the microchip and the electrodes. Cladding the module substrate with copper foil before etching to form the electrodes and IC module coil allows for a high degree of precision in the IC module layout, which can improve the electrical performance and reliability of the IC module. Further, the etching of electrodes and an IC module coil on different surfaces can lead to a reduction in the size of the IC module. The use of wire bonding to connect the microchip to the IC module coil ensures a robust and stable electrical connection. The inclusion of through holes filled with conductive material in the substrate module creates a secure and efficient pathway for electrical signals between the microchip and the electrodes.

The term module substrate cladded with a copper foil can refer to a process in manufacturing where a module substrate is bonded with a thin layer of copper foil. This cladding technique enhances the substrate's electrical conductivity and allows for the creation of precise and complex circuit pathways.

In this context, cladding may involve applying a layer of copper foil directly onto a module substrate, which can be a non-conductive or less conductive substrate such as fiberglass, epoxy resin, or a polymer like Polyimide. The copper serves as the conductive surface upon which electronic circuits can be etched or printed.

Various etching processes can be used, such as wet chemical etching, dry etching and laser etching.

Further, the IC module may be attached to the engagement hole. Attaching the IC module to the engagement hole integrates the electronic components with the card substrate, creating a unified structure. The attachment of the IC module within the engagement hole can provide a flush surface on the smart card, which not only improves the aesthetic appeal but also minimizes the risk of snagging or catching on wallets, card readers, or other objects. This method of attachment can also facilitate easier replacement or upgrading of the IC module, as it is clearly defined and accessible within the structure of the electronic card.

In particular the module substrate may be glued into the engagement hole by a laminating method and a hot-melt adhesive filling method. The use of a laminating method to gluc the module substrate into the engagement hole ensures a strong bond that can withstand the stresses of daily use, including bending and torsion, which contributes to the structural integrity of the smart card. Employing a hot-melt adhesive filling method provides a quick and secure means of fixing the module substrate in place, which can streamline the manufacturing process and reduce production times. The combination of laminating and hot-melt adhesive methods can seal the engagement hole, protecting the IC module from environmental factors such as moisture and dust.

The smart card may be personalized by way of embossing or by laser engraving. The utilization of embossing for personalization provides a tactile feature that can be easily verified by touch, enhancing the security against counterfeiting as the embossed details are difficult to replicate without specialized equipment. Laser engraving offers a high level of precision and permanence, ensuring that the personalized information remains legible and intact over the smart card's lifespan, even under harsh environmental conditions. Both embossing and laser engraving methods allow for customization without significantly compromising the structural integrity of the card.

The skilled person will recognize that the advantages, technical effects and preferred embodiments discussed in connection with the smart card, or the system apply analogously to the method of wire embedding for a smart card and to the method for manufacturing a smart card. Likewise, all the advantages, technical effects and preferred embodiments described in connection with the methods are transferable to the smart card or system.

In further aspects that refer to elements of the metal composition in the smart card, various advantageous effects can be seen. These elements can be combined with the other elements in the present application as described above and below.

In this context, a smart card may comprise a first coil having turns of wire defining a perimeter of a first surface area of the smart card and defining a first interior space within the first surface area surrounded by turns of wire of the first coil. Further, the smart card may comprise a second coil having turns of wire defining a perimeter of a second surface area of the smart card and defining a second interior space within the second surface area surrounded by turns of wire of the second coil. In addition, the smart card may comprise a third coil having turns of wire defining a perimeter of a third surface area of the smart card and defining a third interior space within the third surface area surrounded by turns of wire of the third coil. Also, the smart card may comprise a non-metallic substrate into which the first, second, and third coils are arranged, the non-metallic substrate being free from conductive or metallic foil or conductive or metallic layers such that a metal composition of the smart card is less than 40% by weight. The absence of conductive or metallic foil or layers ensures that the smart card remains lightweight and flexible, contributing to user convenience and reducing manufacturing costs associated with metal materials.

The smart card's metal composition being less than 40% by weight minimizes interference with the electromagnetic fields generated by the coils, thereby improving the reliability and range of communication. The electronic card's composition, with metal content below 40% of its weight, ensures that the card remains lightweight and flexible.

In total, no metal layer or component is used except of components such as a first, second and third coil. Accordingly, the product comprises some metal, but the weight of the metal is much less than 40% of the card weight. Although the product has some metal, it is not a so-called “metal card”.

The smart card is composed of several layers, each contributing to the card's overall functionality and durability. Notably, none of these layers is made entirely of metal, a design choice that helps avoid potential issues with electronic interference. Instead of using a solid metal layer, such as a metal foil, alternative materials are employed.

Generally, a layer can refer to a distinct sheet or film of material that is part of the card's assembly. Each layer can serve a specific function and can contributes to the overall properties and performance of the smart card. Layers can vary widely in composition, including non-metallic substrates like PVC, PC, PET, or PETG, which are chosen for their physical properties such as flexibility, durability, and ability to support embedded electronic components like antenna coils. These layers are strategically assembled through processes like lamination to ensure that the smart card functions correctly, meets durability standards, and maintains necessary electronic properties for communication and data security.

A non-metallic substrate may comprise or be formed as an antenna substrate and/or a card substrate. A non-metallic substrate can also comprise or be formed as a compensation layer, a printed layer, a PVC layer, or an overlay layer. In addition, the non-metallic substrate can comprise, for example, PVC, PC, PET or PETG.

Furthermore, the first, second and third coils can be laid into the non-metallic card substrate without use of laser ablation or etching. The coils being laid into the non-metallic substrate without laser ablation or etching simplifies the manufacturing process, reducing production time and costs associated with more complex fabrication techniques. Avoiding the usc of laser ablation or etching also reduces the environmental impact of the manufacturing process, as it eliminates the need for chemicals and reduces energy consumption. Some materials may be sensitive to the high temperatures and physical stresses induced by laser ablation or etching. Using a method that excludes these techniques can allow for a broader range of materials to be used effectively, potentially enhancing the functionality and durability of the smart cards.

The smart card may also comprise a microchip and a capacitive element, the second coil and the capacitive element forming the LC network, and the IC module coil being connected to the microchip. These components also advantageously do not cause the smart card to exceed a metal weight of 40% of the card weight but comprise less than 40% of the card weight.

An embodiment in which a smart card with a dual interface is provided also has a metal composition of the smart card of less than 40% by weight. This smart card can communicate wirelessly via inductive coupling while having an electronic transmission path in the form of a contact. In this context, an IC module can be provided which consists of a module substrate laminated or cladded with a copper foil. The microchip is connected to the IC module coil by wire bonding, and the substrate module has through-holes filled with conductive material that serve as a connection between the microchip and the electrodes.

In further aspects that refer to elements of the first and third coils formed from a single piece of wire, various advantageous effects can be seen. These elements can be combined with the other elements in the present application as described above and below.

In this regard, a smart card may comprise a first coil having turns of wire defining a perimeter of a first surface area of the smart card and defining a first interior space within the first surface area surrounded by turns of wire of the first coil. Additionally, the smart card may comprise a third coil having turns of wire defining a perimeter of a third surface area of the smart card and defining a third interior space within the third surface area surrounded by turns of wire of the third coil. The first and third coils are made from a single piece of wire. The single piece of wire has a winding direction that is the same for both the first and third coils. The integration of the first and third coils from a single piece of wire simplifies the manufacturing process, reducing the number of components and potentially lowering production costs. Further, the single wire piece may lead to a reduction in material. The uniform winding direction for both the first and third coils ensures consistent electromagnetic properties across the smart card, which can improve the reliability and performance of wireless communication functions.

The winding direction refers to the path and orientation that the wire takes as it is wound to form a coil. Typically, coils can be wound in a clockwise or counterclockwise direction. The direction in which a coil is wound affects the polarity of the magnetic field it generates when an electric current passes through it. Coils wound in the same direction will produce magnetic fields that align or complement each other.

The third coil can be connected to a capacitive element to enable an LC network without the use of a second coil. In this context, the capacitive element can be made from the same single wire as the first coil and the third coil.

The smart card may comprise a second coil having turns of wire defining a perimeter of a second surface area of the smart card and defining a second interior space within the second surface area surrounded by turns of wire of the second coil. The addition of a second coil increases the ability of the smart card to interact with an external reader. The smart card is preferably a component of an LC network and is configured to match the third coil with the antenna of the external reader. The advantages and details are explained above.

The smart card may comprise a plurality of layers, and wherein the first coil and the third coil are formed on a same layer of the smart card. It is also possible that the second coil is also formed on this layer. Forming all three coils on the same layer of the smart card simplifies the layer structure and manufacturing process, which can lead to reduced production costs and increased manufacturing efficiency. Placing the coils on a single layer can minimize the card's thickness, resulting in a slimmer profile that is more convenient for users to carry and handle.

The smart card may further comprise a microchip, an IC module coil and a capacitive element. The second coil and the capacitive element form a LC-network, wherein the third coil is connected to the first coil and to the second coil. In addition, the IC module coil is connected to the microchip, and the first coil is arranged with respect to the IC module coil such that a magnetic field generated by the first coil can induce a current in the IC module coil. The integration of the second coil with a capacitive element to form an LC-network enables precise tuning of the card's resonant frequency, improving communication performance with external readers. Arranging the first coil to induce a current in the IC module coil through a magnetic field enables contactless energy transfer and data communication, which enhances the card's usability in various contactless applications.

Further, a method for manufacturing a smart card is provided. The method may comprise the following steps. A first coil is formed having turns of wire defining a perimeter of a first surface area of the smart card and defining a first interior space within the first surface area surrounded by turns of wire of the first coil. A third coil is formed having turns of wire defining a perimeter of a third surface area of the smart card and defining a third interior space within the third surface area surrounded by turns of wire of the third coil. The first and third coils are made from a single piece of wire, and the single piece of wire has a winding direction that is the same for both the first and third coils. The utilization of a single piece of wire to form both the first and third coils ensures consistency in the electrical characteristics, such as resistance and inductance, across different parts of the smart card, leading to improved reliability in the card's performance. Manufacturing efficiency is enhanced as the process eliminates the need for splicing or joining separate wires, thereby reducing the complexity and potential points of failure within the smart card's coil structure. The identical winding direction for both coils simplifies the manufacturing process, potentially reducing the time and cost associated with the production of the smart card.

The skilled person will recognize that the advantages, technical effects and preferred embodiments discussed in connection with the smart card apply analogously to the method for manufacturing a smart card. Likewise, all the advantages, technical effects and preferred embodiments described in connection with the method are transferable to the smart card.

The method may further comprise forming a second coil having turns of wire defining a perimeter of a second surface area of the smart card and defining a second interior space within the second surface area surrounded by turns of wire of the second coil, wherein the second coil is also made from the same single piece of wire. Incorporating a second coil from the same single piece of wire further streamlines the manufacturing process. The use of a single wire for multiple coils reduces material waste and the need for additional inventory, contributing to more sustainable manufacturing practices and cost savings. The continuity of the wire between the coils can provide structural integrity to the smart card, enhancing its durability and lifespan.

The method may further comprise embedding the first coil, the second coil, and the third coil on the same layer within the smart card. Embedding all coils on the same layer within the smart card simplifies the lamination process and reduces the overall thickness of the card, resulting in a more streamlined and cost-effective production process. A single-layer coil structure can improve the thermal stability of the smart card by ensuring uniform heat distribution during operation and reducing the risk of delamination or warping. The integration of all coils into one layer facilitates easier inspection and quality control during manufacturing, as potential defects or inconsistencies can be more readily identified and corrected.

In further aspects that refer to elements of the second and third coils formed from a single piece of wire, various advantageous effects can be seen. These elements can be combined with the other elements in the present application as described above and below.

In this regard, a smart card may comprise a second coil having turns of wire defining a perimeter of a second surface area of the smart card and defining a second interior space within the second surface area surrounded by turns of wire of the second coil. In addition, the smart card may comprise a third coil having turns of wire defining a perimeter of a third surface area of the smart card and defining a third interior space within the third surface area surrounded by turns of wire of the third coil. The second and third coils can be made from a single piece of wire, and the single piece of wire having a winding direction that is the same for both the second and third coils. Further, the second coil is configured as a passive, non-radiating component of an LC network for matching the third coil with an external reader antenna. The integration of the second and third coils from a single piece of wire ensures manufacturing efficiency and reduces the complexity of the assembly process, potentially lowering production costs. The uniform winding direction for both the second and third coils simplifies the design and may enhance the electromagnetic compatibility of the smart card with external reader antennas. Configuring the second coil as a passive component of an LC network for impedance matching optimizes the energy transfer between the smart card and the reader, improving communication reliability and rangc.

Furthermore, the smart card may comprise a first coil having turns of wire defining a perimeter of a first surface area of the smart card and defining a first interior space within the first surface area surrounded by turns of wire of the first coil. The first coil can serve as an inductive coupling between the antenna coil, in particular the third coil, and an IC module coil which is connected to a microchip.

In this regard, the smart card may also comprise a microchip, an IC module coil, and a capacitive element. The second coil and the capacitive element can form a LC-network, and the third coil can be connected to the first coil and to the second coil. The IC module coil is connected to the microchip, and the first coil may be arranged with respect to the IC module coil such that a magnetic field generated by the first coil can induce a current in the IC module coil. This configuration results in the advantages already described in the other aspects. In particular, this leads to improved interaction between the smart card and an external reader.

The capacitive element can also be made from the single wire, from which the first coil, the second coil and/or the third coil are already made. Further, a method for manufacturing a smart card is provided. The method may comprise the step of forming a second coil with turns of wire that define a perimeter of a second surface area of the smart card and a second interior space within the second surface area. The method may also comprise the step of forming a third coil with turns of wire that define a perimeter of a third surface area of the smart card and a third interior space within the third surface area. The second and third coils are made from a single piece of wire, wherein the single piece of wire maintains the same winding direction for both coils. The second coil is configured as a passive, non-radiating component of an LC network for matching the third coil with an external reader antenna. Using a single piece of wire for both the second and third coils offers advantages, such as reduced material consumption and streamlined manufacturing processes. There is no need to change or reattach the wire the wire between method steps, which not only speeds up production but also minimizes potential errors.

The skilled person will recognize that the advantages, technical effects and preferred embodiments discussed in connection with the smart card apply analogously to the method for manufacturing a smart card. Likewise, all the advantages, technical effects and preferred embodiments described in connection with the method are transferable to the smart card.

The method may further comprise forming a first coil with turns of wire that define a perimeter of a first surface area of the smart card and a first interior space within the first surface area. This first coil can be made also from the same wire as the second and the third coil. Or alternatively, it can be made by another wire.

The second coil may be formed within the third interior space defined by the third coil. This arrangement is particularly advantageous when using just a single wire, as it minimizes the distance between the second and third coils, allowing for a more seamless and efficient coil manufacturing process. Positioning the second coil within the interior space of the third coil optimizes the use of available space within the smart card, resulting in a more compact and efficient design. This strategic placement not only simplifies the manufacturing process but also enhances the overall performance of the smart card.

Forming coils from a single piece of wire means that the manufacturing process can be conducted continuously, using an uninterrupted length of wire. This approach ensures that the wire is not cut into separate segments or pieces, which facilitates a more uniform and efficient production. By using a single, continuous wire, the overall integrity and consistency of the coils are maintained, enhancing the smart card's performance and reliability.

In further aspects that refer to elements of the first, second, and third coils having the same winding direction formed from a single piece of wire, various advantageous effects can be seen. These elements can be combined with the other elements in the present application as described above and below.

A smart card may comprise a first, a second and a third coil. The first coil has turns of wire defining a perimeter of a first surface area of the smart card and defining a first interior space within the first surface area surrounded by turns of wire of the first coil. The second coil has turns of wire defining a perimeter of a second surface area of the smart card and defining a second interior space within the second surface area surrounded by turns of wire of the second coil. The third coil has turns of wire defining a perimeter of a third surface area of the smart card and defining a third interior space within the third surface area surrounded by turns of wire of the third coil. The first, second, and third coils are made from a single piece of wire, and the single piece of wire having a winding direction that is the same for all three of coils. The integration of three coils made from a single piece of wire ensures consistency in the electromagnetic properties across the coils, which can lead to improved communication reliability when interacting with readers. The uniform winding direction for all three coils not only simplifies the manufacturing process, but also allows for more precise control over the electromagnetic field distribution within the card.

The smart card may comprise a capacitive element. This capacitive element can also be formed from a single piece of wire, as the first, second and third coils. In particular, the capacitive element can be connected to the second coil and thus also constitute a functional unit, as for example a LC network.

Furthermore, a method for manufacturing a smart card is provided. The method comprises the step of forming a first coil with turns of wire that define a perimeter of a first surface area of the smart card and a first interior space within the first surface area. Additionally, the method comprises the step of forming a second coil with turns of wire that define a perimeter of a second surface area of the smart card and a second interior space within the second surface area. Moreover, the method comprises the step of forming a third coil with turns of wire that define a perimeter of a third surface area of the smart card and a third interior space within the third surface area. The method uses a single piece of wire to form the first, second, and third coils, and maintains the same winding direction for all three coils. Maintaining the same winding direction and using a single piece of wire for all three coils during manufacturing can lead to a reduction in errors and defects, thereby improving the overall quality and yield of the smart card production process.

In further aspects that refer to elements of the first, second, and third coils formed from a single piece of wire including no welds or soldering joints, various advantageous effects can be seen. These elements can be combined with the other elements in the present application as described above and below.

In this regard, a smart card may comprise a first coil, a second coil, and a third coil. The first coil may have turns of wire defining a perimeter of a first surface area of the smart card and defining a first interior space within the first surface area surrounded by turns of wire of the first coil. The second coil may have turns of wire defining a perimeter of a second surface area of the smart card and defining a second interior space within the second surface area surrounded by turns of wire of the second coil. The third coil may have turns of wire defining a perimeter of a third surface area of the smart card and defining a third interior space within the third surface area surrounded by turns of wire of the third coil. The first, second, and third coils are made from a single piece of wire, and the single piece of wire includes no welds or soldering joints for connecting portions of the single piece of wire. The utilization of a single piece of wire to form the first, second, and third coils enhances the structural integrity of the smart card, reducing the likelihood of mechanical failure due to weak points such as welds or soldering joints. The design simplifies the manufacturing process by eliminating the need for additional steps to connect separate wire segments, thereby reducing production costs and time. The absence of welds or soldering joints may improve the reliability and longevity of the smart card by preventing potential points of electrical resistance or corrosion that could compromise the card's functionality.

The smart card may further comprise a microchip, an IC module coil, and a capacitive element. The second coil and the capacitive element may form a LC-network and the third coil can be connected to the first coil and to the second coil. Additionally, the IC module coil is connected to the microchip. The first coil is arranged with respect to the IC module coil such that a magnetic field generated by the first coil can induce a current in the IC module coil. The capacitive element can also be made from the single piece of wire mentioned above.

Furthermore, a method for manufacturing a smart card is provided. In a method step a single piece of wire is provided, wherein the single piece of wire includes no welds or soldering joints. In another method step, a first coil is formed by winding the single piece of wire to define a perimeter of a first surface area of the smart card, and a first interior space is created within the first surface area surrounded by turns of wire of the first coil. In another method step, a second coil is formed by continuing to wind the single piece of wire to define a perimeter of a second surface area of the smart card, and a second interior space is created within the second surface area surrounded by turns of wire of the second coil. In another method step, a third coil is formed by further winding the single piece of wire to define a perimeter of a third surface area of the smart card, and a third interior space is created within the third surface area surrounded by turns of wire of the third coil. Utilizing a single piece of wire with no welds or soldering joints to form the coils reduces the risk of mechanical failure at connection points, leading to a more reliable smart card. The method of winding a single wire to create multiple coils allows for a continuous electrical pathway, which can improve the card's electromagnetic properties and overall functionality.

In further aspects that refer to elements of the capacitive element, various advantageous effects can be seen. These elements can be combined with the other elements in the present application as described above and below.

In this context, a smart card may comprise a first, second and third coil as well as a capacitive element. The first coil may have turns of wire defining a perimeter of a first surface area of the smart card and defining a first interior space within the first surface area surrounded by turns of wire of the first coil. The second coil may have turns of wire defining a perimeter of a second surface area of the smart card and defining a second interior space within the second surface area surrounded by turns of wire of the second coil. The third coil may have turns of wire defining a perimeter of a third surface area of the smart card and defining a third interior space within the third surface area surrounded by turns of wire of the third coil. The capacitive element may comprise the second coil and/or a pair of conductors arranged at an end of the second coil. Integrating the capacitive element directly with the second coil, as described, can lead to a compact overall design of the smart card. In addition, such an arrangement is simple to manufacture, as the capacitive element can also be manufactured simultaneously with the second coil. The capacitive element can also be generated from the same single piece wire as the first, second and/or third coils of the smart card.

Insofar, the capacitive element can be part of the second coil and form a structural unit with the second coil. It is also understood as a wire section standing out as sore thumbs. The smart card is free from a capacitor component having electrodes associated therewith. The absence of a capacitor component with associated electrodes (conventional capacitor) can reduce the card's manufacturing complexity and cost, as it eliminates the need for additional materials and assembly processes. By omitting the capacitor, the card may become thinner and lighter, improving portability and user comfort during handling.

In further aspects that refer to elements of the first, second, and third coil are arranged on the same plane, various advantageous effects can be seen. These elements can be combined with the other elements in the present application as described above and below.

A smart card may comprise a first coil, a second coil and a third coil and an antenna substrate. The first coil may have turns of wire defining a perimeter of a first surface area of the smart card and defining a first interior space within the first surface area surrounded by turns of wire of the first coil. The second coil may have turns of wire defining a perimeter of a second surface area of the smart card and defining a second interior space within the second surface area surrounded by turns of wire of the second coil. The third coil may have turns of wire defining a perimeter of a third surface area of the smart card and defining a third interior space within the third surface area surrounded by turns of wire of the third coil. The antenna substrate may comprise a first plane in which the first, second, and third coils are arranged. The arrangement of the coils on a single plane within the smart card maximizes the use of space, contributing to a slim profile that maintains the card's compatibility with standard card slots and wallets. The proximity of the coils on one plane can enhance the card's ability to interact with external readers, potentially improving signal strength and reception. This layout also simplifies the assembly process, enabling faster production cycles and reducing manufacturing errors by consolidating all coils onto one layer.

The turns of the first, second, and third coils can be co-planar with one another. Having the turns of all three coils co-planar with one another reduces the complexity of the card's manufacturing process. The co-planar arrangement of the coils can provide a more uniform magnetic field distribution across the card, which may improve the consistency and range of communication with readers. The streamlined design minimizes interference between the coils, allowing for clearer signal transmission and reception, which can enhance the overall performance of the smart card.

The smart card may further comprise a capacitive element, wherein the capacitive element is connected to the second coil forming a LC-network, and wherein the capacitive element is arranged on the same plane as the first, second, and third coil. Placing the capacitive element on the same plane as the coils simplifies the card's internal structure, which can lead to a thinner design and more efficient use of the available space within the card. The capacitive element's proximity to the second coil can increase the energy efficiency of the card by minimizing resistive losses that occur with longer conductive paths.

The smart card may further comprise an IC module coil connected to a microchip, wherein the IC module coil is arranged on a second plane. The arrangement of the IC module coil on a second plane allows for a layered structure that can accommodate additional components or circuitry without increasing the card's footprint. The separation of the IC module coil onto a different plane can allow for specialized materials or shielding to be used around the microchip, which can further improve the card's performance and reliability.

The smart card may comprise an IC module having a module substrate with a second plane. The presence of a module substrate with a second plane provides a dedicated and stable platform for mounting the IC module, which can improve the mechanical robustness of the smart card against bending and torsional stresses. The modular design of the IC module with its own substrate allows for easier upgrades or customization of the smart card, as different IC modules can be developed and attached without altering the base design of the card.

The smart card may comprise a card substrate with an engagement hole accommodating the IC module. The inclusion of an engagement hole in the card substrate for accommodating the IC module provides a secure and stable positioning of the module within the smart card, thereby enhancing the durability and reliability of the card during usc.

The second plane is preferably parallel to the first plane. The IC module coil and the first coil may at least partially overlap. The center of the IC module coil and the first coil can be superimposed. The partial overlap between the IC module coil and the first coil can lead to enhanced inductive coupling, which may improve the energy transfer efficiency and increase the operational range of the smart card. Overlapping coils can also save space on the card substrate, allowing for a more compact design or the inclusion of additional features without increasing the card's overall size. Superimposing the centers of the IC module coil and the first coil can maximize the magnetic field overlap, which can significantly improve the card's data transmission capabilities and power reception from external readers.

The first, second, and third coils may be arranged in the first plane such that all three antenna structures comprising the first, second, and third coils are formed on the first plane with only short distances where wire crosses over another wire or where wire bridges from the first, second, or third interior space to an outer diameter of the first, second, or third coil. Forming the first, second, and third coils on the same plane with minimal wire crossovers can reduce the risk of short circuits and signal interference, leading to a more robust and reliable smart card. The design minimizes the need for complex wire routing, which can simplify the manufacturing process and reduce production costs, while also potentially allowing for thinner card designs.

In further aspects that refer to elements of the modified properties of the second coil, various advantageous effects can be seen. These elements can be combined with the other elements in the present application as described above and below.

In this respect, a smart card may comprise a first, second and third coil. The first coil has turns of wire defining a perimeter of a first surface area of the smart card and defining a first interior space within the first surface area surrounded by turns of wire of the first coil. The second coil has turns of wire defining a perimeter of a second surface area of the smart card and defining a second interior space within the second surface area surrounded by turns of wire of the second coil. The third coil has turns of wire defining a perimeter of a third surface area of the smart card and defining a third interior space within the third surface area surrounded by turns of wire of the third coil. The second coil can be arranged to include additional turns of wire and/or configured to use wire of greater width so as to increase a surface area occupied by the second coil turns of wire. Alternately, the second coil may be arranged to include additional turns of wire and/or configured to use heavier materials so as to increase a weight of the smart card. The second coil can be arranged to include additional turns of wire and/or configured to use materials with visually distinguishable color so as to increase a visibility of the smart card. The option to increase the surface area or weight of the second coil provides a means to customize the card's physical characteristics for specific applications, such as enhancing durability or providing a premium tactile feel. Utilizing materials with visually distinguishable colors for the second coil can improve the card's aesthetics and make it easier to identify and differentiate from other cards, enhancing user experience and branding opportunities.

The second coil may comprise wire made of gold, steel, or silver. The use of gold, steel, or silver wire in the construction of a second coil can provide varying levels of conductivity, durability, and corrosion resistance, allowing for customization based on the intended application and environmental conditions. Furthermore, using heavier and visually distinct materials like gold or silver not only adds to the perceived value of the card but also increases its weight, which can be a desirable feature in certain markets. Additionally, integrating a metal core in the second coil prevents energy absorption and further increases the card's heft, enhancing both its functionality and aesthetic appeal.

The smart card may comprise an antenna substrate with a first plane, wherein the first, the second and the third coil are arranged on the first plane, the third coil extending over 70% and 95% of the of the total size of the first plane. Accordingly, the smart card comprises a third coil arranged to cover a large surface area of the card so as to provide increased stability. Arranging the first, second, and third coils on a single plane with the third coil extending over a significant portion of the plane can create a more uniform magnetic field when activated, which can improve the card's communication range and reliability. This design may also allow for the use of larger coils without increasing the overall size of the card, which can enhance the card's ability to inductively couple with readers, even at greater distances or with obstructions present.

In further aspects that refer to elements of electrically connecting the ends of the second and third coils, various advantageous effects can be seen. These elements can be combined with the other elements in the present application as described above and below.

A smart card may comprise a first, second and third coil. The first coil has turns of wire defining a perimeter of a first surface area of the smart card and defining a first interior space within the first surface area surrounded by turns of wire of the first coil. The second coil has turns of wire defining a perimeter of a second surface area of the smart card and defining a second interior space within the second surface area surrounded by turns of wire of the second coil. The third coil has turns of wire defining a perimeter of a third surface area of the smart card and defining a third interior space within the third surface area surrounded by turns of wire of the third coil. An end of the third coil is electrically interconnected with an end of the second coil, and the second coil is positioned within the third interior space and encircled by windings of the third coil. The interconnection between the second and third coils can create a resonant circuit that may improve the energy transfer efficiency, potentially leading to faster data transmission rates and reduced power consumption during operation. The spatial arrangement of the coils, with the second coil positioned within the third coil's interior space, can provide a compact design that maximizes the use of the smart card's surface area while maintaining the functionality of multiple antennas.

The first coil can also be electrically connected to the third coil. This is a simple and effective way of transferring the induced current in the third coil to the first coil, which is coupled to the IC module coil.

In further aspects that refer to elements of the dual-contact chipcard module comprising a via hole with conductive material, various advantageous effects can be seen. These elements can be combined with the other elements in the present application as described above and below.

The chipcard module particularly comprises a chip and an IC module coil. The chip must be connected to both ends or poles of the coil, which poses a technical challenge. This is because the coil is applied onto a surface, and typically, one end (or pole) is located on the outer side of the coil (antenna side), while the other is on the inner side (bonding side). When the chip is positioned inside the coil, the outer side (antenna side) is difficult to access.

In this context, the application provides a method for manufacturing a dual-contact chipcard module with an RFID transmission antenna coil, wherein the chipcard module comprises a plurality of conductive antenna traces and ISO contact pads. The method includes several steps:

First, a module substrate with an antenna side and a contact side is provided. The module substrate may further comprise a bonding side.

The antenna side may refer to the surface or area or side of the module substrate that directly receives electromagnetic signals from an external RFID transmission antenna. It may be located on the bottom side of the chipcard module and may extend from the outer edge of the module inward, up to the outer boundary of the IC module coil. The IC module coil may be positioned within this area. The IC module's coil outer boundary may serve as a functional and spatial delimiter between the antenna side and the adjacent bonding side.

The bonding side may refer to the surface, area, or side of the module substrate on which the microchip is mounted and electrically connected by means of bond wires. It is typically located on the bottom side of the chipcard module, often overlapping with or adjacent to the antenna side. The bonding side may comprise a conductive foil layer-referred to as the bonding side conductive foil layer-into which conductive traces and bonding pads are patterned to enable electrical interconnection between the chip and other functional elements of the module, such as antenna structures or ISO contact pads. Bonding holes or via structures may be provided to allow bond wires or conductive material to establish vertical connections to other substrate layers. In modules comprising a loop antenna structure, the IC module coil may form a closed loop around the bonding side, such that the bonding area is positioned within the spatial boundary defined by the IC module coil.

The contact side may refer to the surface area or area or side of the module substrate that comprises the ISO contact pads intended for direct electrical interface with an external reader. It may be located on the top side of the chipcard module and serves as the primary contact interface for contact-based communication in accordance with ISO/IEC 7816 standards. The contact side may include a conductive foil layer-referred to as the contact side conductive foil layer-into which a defined pattern of conductive traces and ISO contact pads is etched or structured. These contact pads may be electrically connected to the chip via bond wires passing through bonding holes or through conductive via structures from the bonding side. The contact side may be visible from the exterior of the finished smartcard and must comply with mechanical, electrical, and positional standards to ensure proper reader compatibility and reliable signal transmission.

In a next step, a bonding side conductive foil layer is provided and attached to the bonding side of an insulating substrate layer. This attachment may optionally involve laminating the foil layer, and an adhesive may be used during this process.

Preferably, the insulating substrate layer is part of the module substrate or forms one of its layers. Typically, the antenna side and the bonding side of the module substrate are located on the bottom side of the dual-contact chip card module or the smart card into which it is later incorporated, whereas the contact side is located on the top side of the dual-contact chip card module or the smart card.

Following this, a pre-determined pattern of conductive traces and contact pads is created in the bonding side conductive foil layer. This pattern may optionally be etched into the foil layer.

A via hole is then created in the bonding side conductive foil layer and the insulating substrate layer. This step may optionally involve creating one or more via holes.

Afterward, a contact side conductive foil layer is provided and attached to the contact side of the insulating substrate layer. This step may optionally include laminating the foil layer using adhesive.

The next step involves etching a pre-determined pattern of conductive traces and contact pads into the contact side conductive foil layer. This etching process may optionally remove parts of the bonding side conductive foil layer and the adhesive beneath those parts. Additionally, this step may involve etching six or eight ISO contact pads into the contact side copper foil layer.

Optionally, a Ni/Au plating may be applied onto both the contact side conductive foil layer and the bonding side conductive foil layer.

Conductive material is then provided in the via hole to electrically connect a section of the conductive traces with a section of the contact side conductive foil layer.

Further steps in the method include mounting a chip on the antenna side of the module substrate, which may optionally involve the use of adhesive.

A first pre-determined contact pad of the chip, which may optionally be referred to as a first antenna chip pad, is connected with an antenna contact pad surface area, optionally referred to as a second antenna contact pad, on the bonding side conductive foil layer by providing a first antenna bonding wire.

A second pre-determined contact pad of the chip, which may optionally be referred to as a second antenna chip pad, is connected with a bonding side surface of the ISO contact pads by providing a bond wire through the bonding hole. This step may optionally involve connecting the second antenna chip pad with a contact pad area on the contact side conductive foil layer by providing a second bond wire.

The method may provide a dual-contact chipcard module in which the conductive material in the via hole electrically connects a section of the conductive traces with one of the ISO standard contact pads C6, C4, or C8. Additionally, the first pre-determined contact pad of the chip, optionally referred to as a first antenna chip pad, is connected with a bonding side surface of the same ISO standard contact pads C6, C4, or C8.

The method offers the advantage of improved bonding strength by utilizing a conductive material, such as conductive glue, which is cured after filling the via hole. The manufacturing process of the dual-contact chipcard module provides increased protection and durability through the encapsulation step, which covers the chip and bond wires with encapsulation material.

Furthermore, a dual-contact chipcard module is provided. The dual-contact chipcard module includes an RFID transmission antenna coil that comprises a number of conductive antenna traces and an ISO contact set with several ISO contact pads.

The module comprises the following elements:

A module substrate is provided, which has an antenna side and a contact side. A bonding side conductive foil layer is attached to the bonding side of an insulating substrate layer. Optionally, adhesive may be placed between these layers.

Conductive traces and contact pads are provided within the bonding side conductive foil layer. A via hole is created in both the bonding side conductive foil layer and the insulating substrate layer. This may optionally include one or more via holes.

A contact side conductive foil layer is attached to the contact side of the insulating substrate layer. Optionally, adhesive may be placed between these layers. Conductive traces and contact pads are then provided within the contact side conductive foil layer. The etching process may optionally remove parts of the bonding side conductive foil layer and the adhesive beneath those parts.

Additionally, a Ni/Au plating may optionally be applied to both the contact side conductive foil layer and the bonding side conductive foil layer. Conductive material is placed within the via hole to electrically connect a section of the conductive traces to a section of the contact side conductive foil layer.

The module may further include a chip placed on the bonding side of the module substrate, with adhesive optionally placed between them. A first pre-determined contact pad of the chip, which may optionally be referred to as a first antenna chip pad, is connected to an antenna contact pad surface area, optionally referred to as a second antenna contact pad, on the bonding side conductive foil layer by a first antenna bonding wire.

A second pre-determined contact pad of the chip, which may optionally be referred to as a second antenna chip pad, is connected to a bonding side surface of the ISO contact pads by a bond wire within the bonding hole. Optionally, this bond wire may electrically connect the second antenna chip pad to a contact pad area on the contact side conductive foil layer.

The conductive material in the via hole ensures an electrical connection between a section of the conductive traces and one of the ISO standard contact pads C6, C4, or C8. Furthermore, the second pre-determined contact pad of the chip, which may optionally be referred to as a second antenna chip pad, is connected to a bonding side surface of the same ISO standard contact pads C6, C4, or C8.

In a development, the method further provides a number of conductive antenna traces and with a number of ISO contact pads. The inclusion of conductive antenna traces and ISO contact pads enhances the functionality of the chipcard module by enabling dual-interface capabilities, allowing for both contact and contactless communication.

The module offers the advantage of efficient electrical connection between conductive traces and ISO standard contact pads through the use of a conductive material in the via hole. These aspects provides a simplified and reliable connection of the second pre-determined contact pad of the chip to the bonding side surface of the ISO standard contact pads.

By using one of those unused ISO contacts C6, C4, or C8 for providing an electric loop between pre-determined antenna chip pads, a simple and durable loop antenna can be provided.

In a development, the method further comprises a conductive material in one of the via holes, comprising conductive glue, and there is a step of curing the conductive glue after filling the via hole. Utilizing conductive glue as the conductive material for via hole filling provides a cost-effective solution compared to traditional metal plating or soldering techniques, potentially reducing manufacturing costs. The curing step of the conductive glue ensures a robust and durable electrical connection within the via hole, enhancing the mechanical stability and longevity of the chipcard module.

In a method of manufacturing a dual-contact chipcard module with an encapsulating step of providing encapsulation material over the chip and the bond wires at the antenna side of the module substrate, the encapsulation of the chip and bond wires on the antenna side of the module substrate protects the delicate components from environmental factors such as moisture and dust, thereby improving the durability and reliability of the module. Encapsulation can also provide mechanical support to the bond wires and chip, reducing the risk of damage duc to physical stress or handling, which is critical for maintaining the integrity of the electrical connections.

In a development, the module further comprises a conductive material in the via hole electrically connecting a section of the conductive traces and one of the ISO standard contact pads C6, C4 or C8, and wherein the second pre-determined contact pad of the chip is connected above a bonding side surface of the same ISO standard contact pads C6, C4 or C8. The conductive material in the via hole creates a direct electrical connection between the conductive traces and specific ISO standard contact pads, which can simplify the module design by reducing the number of required interconnects. By connecting the second pre-determined contact pad of the chip above the bonding side surface of the same ISO standard contact pads, the design allows for a more compact module layout, potentially enabling the creation of thinner chipcard modules.

In the present application, the term “number of conductive antenna traces” refers to a plurality of conductive antenna traces and the term “a number of ISO contact pads” refers to a plurality of ISO contact pads.

The traces applied to the bottom side, or antenna side, of the chip card module may correspond to an IC module coil. In contrast, the traces on the top side of the chip card module may correspond to the contact interface, which is used for transmitting data or power via physical contact.

In a further exemplary embodiment a smart card is disclosed. The smart card may comprise a substrate supporting a dual-interface antenna system and a chipcard module with an IC chip and an IC module coil. The chipcard module is integrated into the antenna system, which includes a first coil, an antenna coil, and a second coil. The antenna system is configured to interface with external systems for both contactless and contact-based operations. The second coil comprises wire that may be made of copper, gold, steel, or silver.

The chipcard module comprises a number of conductive traces, including those forming the IC module coil, and an ISO contact set with a number of ISO contact pads. It further includes a module substrate having an antenna side and a contact side. A bonding side conductive foil layer is provided at a bonding side of an insulating substrate layer, which forms part of the module substrate. Within this bonding side conductive foil layer, the conductive traces and contact pads are structured. A via hole is formed in both the bonding side conductive foil layer and the insulating substrate layer. In addition, a contact side conductive foil layer is arranged at the contact side of the insulating substrate layer, corresponding to the contact side of the module substrate, and contains further conductive traces and contact pads. Conductive material is introduced into the via hole to electrically connect a section of the conductive traces in the bonding side conductive foil layer to a corresponding section of the contact side conductive foil layer.

The IC chip is located above the antenna side or bonding side of the module substrate. A first predetermined contact pad of the IC chip is connected to an antenna contact pad surface area located above the bonding side conductive foil layer by means of a first antenna bonding wire. A second predetermined contact pad of the IC chip is positioned above a bonding side surface of the ISO contact pads and is connected by a bond wire passing through a bonding hole. The conductive material in the via hole establishes an electrical connection between a section of the conductive traces and one of the ISO standard contact pads C6, C4, or C8. Furthermore, the second predetermined contact pad of the IC chip is connected above a bonding side surface of the same ISO standard contact pad C6, C4, or C8.

The term “conductive material comprising conductive glue” refers to a material which is capable of providing an electrically conductive connection.

The term “dual-contact chipcard module” refers to a card module that provides a contactless data connection and a contact pads data connection.

The term “encapsulating step” refers to a step of providing encapsulation material over the chip and the bond wires at the antenna side of the module substrate.

The term “bond wires” is used herein to refer to electrically conductive wires that are connected at the antenna side of the module substrate.

The term “antenna side” is used herein to refer to the side of the module that directly receives signals from an external RFID transmission antenna, which is usually but not always the same side as the “bonding side” of the module substrate. In certain contexts, the terms antenna side and bonding side may be used interchangeably. In some embodiments, these terms may also be understood to indicate a directional orientation-such as referring to a side facing toward the bottom side of the module-rather than a distinct physical surface with a dedicated function. Where appropriate, the terms antenna side and bonding side may also be collectively referred to as the antenna-bonding side, particularly to indicate the rear or bottom side of the chipcard module on which the antenna coil i.e., the IC module coil—is arranged and on which all electrical connections are established via bonding.

The term “contact side” is used herein to refer to a side of the module substrate that carries the ISO contact pads of the module and may serve as a contact interface,

A “LA first antenna chip pad” designates a first pre-determined contact pad of the chip, which is usually connected with the antenna contact pad surface area above the bonding side conductive foil layer by providing a first antenna bonding wire.

A “LB second antenna chip pad” designates a pad of the chip which is connected to the antenna coil, via the ISO contact pad and the conductive material in the via hole.

An “insulating substrate layer” designates a layer of insulating material which is used to provide a substrate for the module.

An “adhesive” designates a material that is used to bond two surfaces together.

The term “bonding side conductive foil layer” is used herein to refer to a layer that is provided at the bonding side of the module.

A “Ni layer” designates a layer of nickel.

An “Au layer” designates a layer of gold.

A “contact side Cu layer” or “contact side conductive foil layer” designates a conductive foil layer that is provided at the contact side of the module.

A “bonding hole” designates a hole in the bonding side conductive foil layer and the insulating substrate layer.

The term “via hole” refers to a hole in the bonding side conductive foil layer and the insulating substrate layer that allows to connect a section of the conductive traces and the contact side conductive foil layer by filling the via hole with conductive material.

A “conductive paste” designates conductive material, such as conductive gluc.

The term “conductive material” is used herein to refer to a material which can be electrically conductive.

The term “chip” is used herein to refer both to a single chip and to a plurality of chips.

A “first antenna bonding wire” designates a wire that is used to connect a first pre-determined contact pad of the chip with an antenna contact pad surface area at the bonding side of the binding side conductive foil layer.

A “second antenna bonding wire” designates a wire that is used to connect a second pre-determined contact pad of the chip with the upper side or bonding side surface of one of the ISO contact pads C4, C6, or C8.

A “first antenna chip pad” and a “second antenna chip pad” designate those contact pads of the chip that provide a wireless data connection via a loop antenna that is connected to these chip pads-

A “first antenna end” designates the end of the antenna coil that is connected to the first pre-determined contact pad of the chip and a “second antenna contact pad” designates the contact pads C6, C4 or C8 that is connected to the second pre-determined contact pad of the chip.

An “upper via end” designates the end of the via hole that is located above the bonding side surface of the ISO standard contact pads C6, C4 or C8.

A “bridge” designates a section or an area that electrically connects a “lower bridge bonding contact area”, an area of one of the ISO standard contact pads C6, C4 or C8 where the second bonding wire is provided, and the area of that same ISO standard contact pads C6, C4 or C8 near the lower via end, where the conductive material is provided.

The term “conductive traces” is used herein to refer to the antenna traces and also to the contact pads, while the term “conductive antenna traces” is used herein to refer to conductive traces that form the module antenna at the bonding side of the module.

An “ISO contact pad” designates contact pads according to the ISO 7816 standard.

The term “encapsulation material” is used herein to refer to a material that can be provided over the chip and the bond wires at the antenna side of the module substrate. One example is Glob tops that are usually epoxies that are dispensed to cover a chip, for example in chip-on-board (COB) applications.

In further aspects that refer to elements of the dual-contact chipcard module comprising a bridge, various advantageous effects can be seen. These elements can be combined with the other elements in the present application as described above and below.

The same technical objective underlies these aspects as in the previously described aspects, namely the challenge of electrically connecting both ends of the coil-used in a dual-contact chipcard module—to the IC chip in a compact and reliable manner.

In this context, a dual-contact chipcard module is provided which comprises an RFID transmission antenna coil that includes a number of conductive antenna traces and an ISO contact set with a number of ISO contact pads. The module comprises a module substrate having an antenna side, a bonding side, and a contact side. The module substrate includes an insulating substrate layer disposed between a bonding side conductive foil layer and a contact side conductive foil layer, wherein both the bonding side conductive foil layer and the contact side conductive foil layer are adhered to the insulating substrate layer by means of an adhesive layer.

In this context, a dual-contact chipcard module is provided which comprises an RFID transmission antenna coil that includes a number of conductive antenna traces and an ISO contact set with a number of ISO contact pads. The module comprises a module substrate having an antenna side, a bonding side, and a contact side. The module substrate includes an insulating substrate layer disposed between a bonding side conductive foil layer and a contact side conductive foil layer, wherein both the bonding side conductive foil layer and the contact side conductive foil layer are adhered to the insulating substrate layer by means of an adhesive layer.

A chip is mounted on the bonding side of the module substrate using chip adhesive. A bridge is formed from a conductive material layer that connects the antenna side to the bonding side. This bridge is applied over an insulating layer which partially covers the conductive traces.

The bridge enables the chip to be electrically connected to one end of the transmission antenna coil, which is located on the antenna side.

In a further embodiment, ISO contact pads are formed on the contact side of the module substrate. These ISO contact pads are electrically connected to the IC chip by means of bonding wires, which pass through bonding holes extending from the bonding side to the contact side. This configuration enables reliable electrical coupling between the chip and the contact interface, while maintaining a layered module structure with clearly separated functional sides.

The conductive material layer forming the bridge may have a thickness in the range of 10 to 15 micrometers. The insulating substrate layer, which is arranged beneath the bridge and referred to as insulating substrate layer, may have a thickness between 3 and 5 micrometers and partially covers the antenna side and the bonding side. This partial coverage ensures that electrical connectivity through the bridge is maintained, while providing mechanical insulation and structural integrity in the regions not involved in the bridging connection.

A method of manufacturing the dual-contact chipcard module as described in any of the preceding embodiments comprises the following steps: First, the bonding side conductive foil layer is laminated onto the insulating substrate layer using an adhesive. Subsequently, a pre-determined pattern of conductive traces, including the RFID transmission antenna coil and ISO contact pads, is etched into the bonding side conductive foil layer. An insulating material layer having a thickness between 3 and 5 micrometers is then applied over the RFID transmission antenna coil, thereby partially covering the antenna side and the bonding side. Over this insulating material layer, a conductive material layer with a thickness of 10 to 15 micrometers is applied to form the bridge. The chip is mounted onto the bonding side of the module substrate using chip adhesive. Bonding wires are then connected between the chip and the ISO contact pads. Finally, the chip and the bonding wires are encapsulated using an encapsulation material to protect the assembly against mechanical and environmental influences.

In a further embodiment, a multi-layer structure of a smart card is provided. The smart card comprises an inlay formed by an antenna sheet that includes the antenna coil and the second coil. This antenna sheet is sandwiched between multiple PVC sheets which are arranged above and below the antenna sheet to form the card substrates. The antenna sheet has a thickness of 0.15 mm. The PVC layering includes two outer layers with a thickness of 0.05 mm each, two inner layers with a thickness of 0.15 mm each, and two additional inner layers with a thickness of 0.10 mm each. All layers are permanently bonded together by lamination to form a unified, mechanically stable, and compact smart card structure.

The overall metal composition of the smart card may not exceed 40% of the total weight of the card. This limitation ensures compatibility with standardized card thickness, mechanical flexibility, and electromagnetic properties, while still allowing for the integration of functional metallic components such as coils or contact structures.

In another exemplary embodiment, a smart card is provided which comprises a substrate supporting a dual-interface antenna system and a chipcard module with an IC chip and an IC module coil. The chipcard module is integrated into the antenna system, which comprises a first coil, an antenna coil, and a second coil. The antenna system is configured to interface with external systems for both contactless and contact-based operations. The second coil comprises wire made of copper, gold, steel, or silver.

The chipcard module comprises a number of conductive traces, including those forming the IC module coil, and a module substrate having an antenna side, a bonding side, and a contact side. The module substrate comprises an insulating substrate layer disposed between a bonding side conductive foil layer and a contact side conductive foil layer. The bonding side conductive foil layer and the contact side conductive foil layer are adhered to the insulating substrate layer by means of an adhesive layer.

The IC chip is mounted on the bonding side of the module substrate using a chip adhesive. A bridge is formed from a conductive material layer and connects the antenna side to the bonding side. This bridge is disposed over an insulating layer that partially covers the conductive traces. The bridge provides an electrical connection between the IC chip and one end of the IC module coil, wherein said coil end is located on the antenna side of the module.

In further aspects that refer to elements of the smart card having coils with specific wire diameter, wire pitch, and number of turns, various advantageous effects can be seen. These elements can be combined with the other elements in the present application as described above and below.

In this context, the smart card may comprise a substrate supporting a dual-interface antenna system and a chipcard module that includes an IC chip and an IC module coil. The chipcard module may be integrated into the antenna system, which may include a first coil, an antenna coil, and a second coil. The antenna system is preferably configured to interface with external systems for contactless and contact-based operations and may be optimized for coupling efficiency and compliance with EMV standards.

The antenna coil, the first coil, and the second coil may have turns defining a perimeter enclosing a surface area, with the surface area of the antenna coil preferably corresponding to ⅔ of the total surface area of the smart card, within a tolerance of ±10%.

The wire diameter of the antenna coil, the first coil, and the second coil may be within the range of 0.08 mm to 0.15 mm.

The wire pitch may be generally uniform, with the second coil preferably having a pitch of 0.34 mm±10%.

The number of turns may range from 8 to 11 in the first coil, 2 to 6 in the antenna coil, and 6 to 12 in the second coil.

The unique configuration of the antenna system, characterized by carefully selected parameters including the surface area of the antenna coil, the wire diameter of the first coil, the second coil and the antenna coil, as well as the pitch of the second coil, and the number of turns in the first, second, and antenna coils, plays a critical contribute significantly to achieving optimized performance. These parameters ensure effective electromagnetic coupling, compliance with standards such as EMV, and reliable operation in both contactless and contact-based modes.

In this regard, the wire diameter, wire pitch, and the number of turns in each of the antenna coil, the first coil, and the second coil may be variably adjusted within the selected parameter ranges to achieve specific performance goals. These adjustments may tune the resonant frequency of the entire smart card to approximately 13.77 MHz, preferably within a tolerance of +0.1 MHZ, thereby enhancing coupling efficiency with minimal delay. Additionally, these parameters can ensure that the Quality Factor is maintained at or below 40, which helps to limit resonance efficiency and prevent potential chip overload.

The Quality Factor (Q) is a measure of the damping or energy loss in a resonant system. It represents the ratio of the energy stored in the system to the energy lost as heat or other forms of dissipation during one oscillation period. A high quality factor indicates that the system loses only a small amount of energy and maintains its oscillation with minimal attenuation. In electrical engineering, the Q-factor also describes the ratio of the resonant frequency to the bandwidth over which the power decreases to half its maximum value. Systems with a high Q-factor are efficient and exhibit sharp resonance, which is particularly important in applications like filters, oscillators, and antennas

Particularly, the proposed refinements resulted in an antenna system configuration that successfully balances compactness, performance, and near-compliance with EMV standards, setting it apart from prior attempts and challenging conventional expectations in the field.

For example, the smart card developed according to the application demonstrates that the smart card achieves superior coupling and energy efficiency with minimal tuning, in a compact ⅔-size antenna format, outperforming larger designs such as ID1-sized antennas. This format specifically refers to the area enclosed by the antenna coil, which corresponds to approximately ⅔ of the total surface area of the smart card. In contrast, an ID1-sized antenna coil typically encloses an area that corresponds to the full surface area of the smart card, as the coil is positioned along the card's edges.

Moreover, the use of a uniform pitch particularly 0.2 mm, 0.4 mm, or 0.34 mm simplifies manufacturing processes while maintaining high performance.

The wire diameter of the first coil, the second coil and the antenna coil may for example be configured as 0.13 mm±10%. This precise diameter enhances resonance stability and improves coupling efficiency.

In a further preferred embodiment, the number of turns in the first coil is preferably 9 or 10, with 10 being particularly preferred. For the antenna coil, the preferred number of turns is between 3 and 5, with 5 being especially advantageous. In the second coil, the number of turns is ideally between 6 and 12, with 7 being particularly favorable. These configurations are optimized to achieve the desired resonance frequency and Quality Factor.

Generally, a substrate may refer to the base material or structural layer that supports the integration of components such as the semiconductor chip, contact pads, and/or antenna system. The substrate may provide mechanical support to ensure the structural integrity of the chipcard module and/or the antenna system, allowing it to withstand bending, pressure, and other physical stresses during everyday use. It also may serve as an electrical insulator, preventing short circuits by separating conductive elements, while simultaneously acting as a platform for assembling conductive pathways and integrating various components.

The substrate can be divided into different layers or types, such as an antenna substrate and/or a card substrate. The substrate may comprise a plurality of card substrates and/or antenna substrates.

An antenna substrate can be a layer within a smart card that houses or accommodates the antenna coil as well as the first and second coil i.e. the antenna, first and second coils are embedded or integrated into the antenna substrate. This substrate forms the base and is specifically designed for seamless integration into the smart card. After embedding the the antenna, first and second coils, it can establish a strong, durable connection that remains intact over time. Preferably, the antenna substrate contains no metallic materials.

The antenna substrate may comprise of materials such as PVC (Polyvinyl Chloride), PC (Polycarbonate), PET (Polyethylene Terephthalate), or PETG (Polyethylene Terephthalate Glycol-modified). Utilizing a substrate made from materials such as PVC, PC, PET, or PETG provides flexibility in the manufacturing process, as these materials are widely available and can be selected based on cost, mechanical properties, or other application-specific requirements. These materials can in particular provide the necessary mechanical support for the embedded wires while maintaining the electronic card's overall thin profile. These materials have also good durability and environmental resistance properties which can enhance the longevity and robustness of the antenna substrate in various operating conditions.

The antenna substrate can be formed by lamination of layers into a monoblock substrate without use of adhesives. Forming the antenna substrate by lamination of layers into a monoblock substrate without the use of adhesives eliminates potential points of failure associated with adhesive degradation over time, thereby increasing the structural integrity of the substrate. The absence of adhesives in the lamination process can reduce the overall manufacturing costs and complexity.

The card substrate may comprise a printed layer, a PVC layer or an overlay layer, wherein the card substrate can also comprise a combination of a printed layer, PVC layer and/or an overlay layer. The ability to combine different layers such as printed, PVC and overlay layers in the card substrate provides flexibility in tailoring the physical properties of the card, such as stiffness, transparency and surface finish, to specific application requirements.

A printed layer can refer to a layer that is directly applied to the antenna substrate or to the inlay by printing technology. A printed layer can also refer to a layer that is first printed (to a sheet or layer) and then placed and laminated on the antenna substrate or inlay. The printed layer may have a thickness of 15 micrometers to 190 micrometers, preferably of 100 micrometers.

The PVC layer of the card substrate may also have a thickness of 15 micrometers to 190 micrometers, preferably of 100 micrometers.

An overlay layer in a smart card can act as a protective coating. It can be designed as a clear, durable material applied directly over the printed layer and any intermediate layers, such as PVC, to protect them from physical wear, moisture and environmental elements. The overlay layer may have a thickness of 5 micrometers to 100 micrometers, preferably of 50 micrometers.

Furthermore, an engagement hole for a chipcard module can be formed in the card substrate indented for each smart card by way of milling. The formation of an engagement hole in the card substrate by milling provides a precise and clean recess for accommodating a chipcard module, ensuring a snug fit and reducing the likelihood of misalignment or movement of the module within the smart card. Milling the engagement hole allows for the customization of the hole's dimensions to match various chipcard module sizes, enhancing the versatility of the smart card manufacturing process to accommodate different module specifications. The milled engagement hole also allows for low profile of the smart card, as the chipcard module can be fully integrated into the substrate.

The antenna substrate can be collated with at least one card substrate by means of lamination, using heat and pressure. The lamination of the antenna substrate with one or more card substrates using heat and pressure ensures a durable bond, enhancing the structural integrity and longevity of the smart card. The use of lamination in the manufacturing process allows for the integration of various functional layers, potentially improving the card's resistance to environmental factors such as moisture and temperature variations.

As described above, a dual-interface antenna system is provided for the smart card. A dual-interface antenna system is generally a configuration within a smart card or similar device that enables seamless communication through both contact-based and contactless methods. It may include one or more antennas designed to interface with external readers for data transmission and reception. Contact-based communication is preferably facilitated through physical contact pads on the card, which provide direct electrical connections to a reader for reliable data exchange and power transfer. The contact-based communication can be supported by the chipcard module, which may include electrodes and an IC module coil. By coupling the IC module coil with the first coil of the antenna system, the chipcard module becomes an integral part of the antenna system. At the same time, the electrodes enable the smart card to facilitate contact-based communication with external systems.

One of the key advantages of the disclosed embodiments in the present application is that they meet the EMV standards with the aforementioned configurations. EMV standards are a globally recognized set of specifications designed to ensure the security and interoperability of payment transactions made using chip-based payment cards and terminals. Unlike magnetic stripe cards, which store static data, EMV cards generate unique transaction data, significantly reducing the risk of fraud. The standards support both contact-based transactions, where the card is inserted into a terminal, and contactless transactions using near-field communication (NFC). EMV technology employs advanced cryptographic methods to authenticate transactions, verify the cardholder, and securely authorize payments.

Preferably, the antenna coil, the first coil, and the second coil have turns defining a perimeter each enclosing a surface area. This surface area may refer to the two-dimensional region bounded by the path of the coil's turns. The design of these perimeters, including their size and shape, directly impacts the electromagnetic properties of the coils, such as their ability to couple effectively with external systems or resonate at specific frequencies.

In other words, these coils may be arranged in a flat, planar configuration on the smart card, such that the turns of each coil encompass an internal area. This configuration can include both the physical space occupied by each coil on the card and the inner area circumscribed by the turns of the coils.

In the proposed smart card, the antenna coil may be designed to occupy approximately ⅔ of the total card surface area, with a tolerance of ±10%, corresponding to a range between 60% (0.6) and 73.33% (0.7333) of the total surface area. This ensures a balance between compactness and performance, allowing sufficient space for other components while optimizing the antenna's ability to achieve effective electromagnetic coupling. The ±10% tolerance indicates that this proportion can vary slightly, accommodating manufacturing variations or specific performance tuning, while still maintaining the desired balance and functionality.

The surface area of the antenna coil, corresponding to approximately ⅔ of the total surface area of the smart card, may also relate to ⅔ of the surface area of an ID1 antenna coil, where the ID1 antenna coil essentially matches the size of an ID1 card, as it is positioned near the edges of the smart card.

For example, the antenna coil may be formed in the dimensions 80 mm*35 mm with a tolerance of ±10%. This means the length of the antenna coil could vary between 72 mm and 88 mm, while the width could range from 31.5 mm to 38.5 mm. Consequently, the surface area of the antenna coil may range from a minimum of 2,268 mm² (72 mm×31.5 mm) to a maximum of 3,388 mm² (88 mm×38.5 mm). In this context, the antenna coil preferably has a substantially rectangular configuration.

In a preferred embodiment, the surface area enclosed by the antenna coil may encompass the surface areas enclosed by the first coil and the second coil, wherein the surface areas enclosed by the first coil and the second coil are non-overlapping. This configuration offers several advantages.

The non-overlapping arrangement reduces electromagnetic interference, thereby enhancing the performance and reliability of the antenna system. Furthermore, by enclosing the smaller coil areas within the larger area of the antenna coil, the available space within the smart card is utilized more efficiently, enabling a compact form factor without compromising functionality. In addition, the absence of crossings between the coils may simplify the manufacturing process, as it reduces the complexity of coil placement and minimizes alignment errors,

In the context of this application, the wire diameter refers preferably to the measurement of the outer diameter of the wire used in the smart card's antenna system. This measurement may include the insulating layer that surrounds the conductive core.

For instance, the nominal diameter may be specified as 0.13 mm, the actual diameter could vary within a tolerance range, such as 0.117 mm to 0.143 mm. The wire used may be enamel-coated copper wire, also known as magnet wire, which features a conductive copper core for efficient signal and power transmission and a thin, durable insulating layer to prevent electrical shorts between adjacent turns of the coil. This insulation can be included in the diameter measurement, and wherein the insulation is important for maintaining the integrity of the tightly wound coils in the antenna system.

Larger wire diameters improve coupling and reduce resonant frequency variability but may increase energy dissipation (Q factor). Smaller diameters allow tighter turns and compact designs but can introduce performance challenges.

Preferably, the wire pitch may refer to the distance between the centers of adjacent turns of wire in a coil. A generally uniform wire pitch means that this spacing remains consistent throughout the coil.

In a preferred embodiment of the second coil, the pitch is preferably set at 0.34 mm, with an allowable variation of ±10%. This means the pitch can range between 0.306 mm and 0.374 mm to accommodate manufacturing tolerances while ensuring the coil's performance remains within the desired parameters. Maintaining a uniform pitch and adhering to the specified tolerance helps optimize the coil's electromagnetic coupling and resonant behavior. Tighter pitch increases coupling and resonant frequency tuning precision but may affect energy dissipation.

The first coil may comprise a pitch of 0.2 mm+/−10% and the antenna coil may comprises a pitch of 0.4 mm+/−10%. The specified tolerances ensure that the first coil's pitch can range from 0.18 mm to 0.22 mm, while the antenna coil's pitch may vary between 0.36 mm and 0.44 mm.

Surprisingly, the second coil, with the specified pitch values, has the most significant impact on the electromagnetic coupling and resonance behavior. However, the carefully chosen pitch values for the first coil and the antenna coil also contribute to achieving favorable electromagnetic coupling and resonance characteristics, enhancing the overall system performance.

The number of turns in a coil preferably refers to the total count of complete windings or loops of wire in a coil. In the context of a smart card antenna system, the number of turns is an important design parameter that directly influences the coil's inductance, electromagnetic coupling, and resonant frequency. A higher number of turns generally increases the inductance, improving the coil's ability to store magnetic energy and enabling better coupling with external readers. However, the number of turns must be carefully optimized to balance performance with physical constraints, such as available space within the smart card, compliance with design standards, and the intended operating frequency.

The proposed smart card preferably includes a chipcard module with a IC chip and a IC module coil. Specific module types, such as the NXP P71 and STM ST31, can be integrated into the smart card, with antenna system designs meticulously tailored to ensure optimal interaction with these modules.

In this regard, the first coil may be operatively coupled to the IC module coil which is connected to the IC chip. The first coil can serve as an inductive coupling between the antenna coil and the IC module coil.

The first coil can be used to ensure that the signal or energy received from the antenna coil is transmitted to the chipcard module, which includes the IC chip, via inductive coupling. Therefore, the first coil can be electrically connected to the antenna coil. When a current is induced in the antenna coil, it simultaneously induces a current in the first coil, which in turn generates a magnetic field. This first coil is positioned in relation to an IC module coil such that the magnetic field it generates can induce a current in the IC module coil. The IC module coil, located on the chipcard module, then supplies current to the chip. Thus, the first coil also functions as a first coupler coil and the IC module coil as a second coupler coil. Insofar, the first coil may be configured to couple to a IC module coil. By configuring the first coil to couple specifically to a IC module coil, the design ensures a dedicated and efficient energy transfer pathway for powering the smart card's microchip.

The first coil is further designed so that it does not match with the external reader or system and, as a result, does not effectively absorb any energy from it.

The chipcard module can comprise an IC module coil, a microchip or a IC chip, a module substrate and electrodes. In this respect the module substrate is preferably cladded with a copper foil. The electrodes and the IC module coil are formed on different surfaces of the substrate module by etching the copper cladded module substrate. The IC chip is connected to the IC module coil by wire bonding, and the substrate module comprises through holes filled with conductive material which serve as a connection between the microchip and the electrodes. Cladding the module substrate with copper foil before etching to form the electrodes and IC module coil allows for a high degree of precision in the chipcard module layout, which can improve the electrical performance and reliability of the chipcard module. Further, the etching of electrodes and an IC module coil on different surfaces can lead to a reduction in the size of the chipcard module. The use of wire bonding to connect the microchip to the IC module coil ensures a robust and stable electrical connection. The inclusion of through holes filled with conductive material in the substrate module creates a secure and efficient pathway for electrical signals between the microchip and the electrodes.

The term module substrate cladded with a copper foil can refer to a process in manufacturing where a module substrate is bonded with a thin layer of copper foil. This cladding technique enhances the substrate's electrical conductivity and allows for the creation of precise and complex circuit pathways.

In this context, cladding may involve applying a layer of copper foil directly onto a module substrate, which can be a non-conductive or less conductive substrate such as fiberglass, epoxy resin, or a polymer like Polyimide. The copper serves as the conductive surface upon which electronic circuits can be etched or printed.

Various etching processes can be used, such as wet chemical etching, dry etching and laser etching.

Further, the chipcard module may be attached to the engagement hole of a card substrate. Attaching the chipcard module to the engagement hole integrates the electronic components with the card substrate, creating a unified structure. The attachment of the chipcard module within the engagement hole can provide a flush surface on the smart card, which not only improves the aesthetic appeal but also minimizes the risk of snagging or catching on wallets, card readers, or other objects. This method of attachment can also facilitate easier replacement or upgrading of the chipcard module, as it is clearly defined and accessible within the structure of the electronic card.

In particular, the module substrate may be glued into the engagement hole by a laminating method and a hot-melt adhesive filling method. The use of a laminating method to glue the module substrate into the engagement hole ensures a strong bond that can withstand the stresses of daily use, including bending and torsion, which contributes to the structural integrity of the smart card. Employing a hot-melt adhesive filling method provides a quick and secure means of fixing the module substrate in place, which can streamline the manufacturing process and reduce production times. The combination of laminating and hot-melt adhesive methods can seal the engagement hole, protecting the chipcard module from environmental factors such as moisture and dust.

Further, the second coil can be configured as a passive, non-radiating component of an LC network for matching the antenna coil with an external system.

The second coil can be particularly configured to match the antenna coil with an external reader (or system) antenna. In this context, the second coil functions as a passive, non-radiating component of an LC network, which is a synonym for a resonant circuit, resonance circuit or inductor capacitor circuit. In order for the second coil to act as a component of an LC network, it can be connected to a capacitive element. This connection can be either in parallel or in series with the capacitive element. The second coil does not radiate energy (being passive) nor does it absorb substantial radiation from the external reader. This is because the second coil is not effectively matched with the external reader antenna. Instead, the energy from the reader antenna is primarily absorbed by the antenna coil, which is specifically designed to be matched with the external reader's antenna. Furthermore, the second coil is neither configured as a dipole nor as a quasi-dipole.

The antenna coil can act as an antenna for the smart card. In order to absorb as much energy as possible from the external reader or system, the antenna coil must match the resonant frequency. This can be achieved by the design of the coil and can also be influenced by an additional LC network. Since the antenna coil is tuned to the resonant frequency and the first and second coils are not close to the resonant frequency due to their design, the amount of induced current in the first and second coils is an order of magnitude lower than the current induced in the antenna coil. Accordingly, the sensitivity of reception depends greatly on characteristics of the third coil.

This allows for a compact design of the coils, particularly of the antenna coil, which maintains effective bidirectional communication capabilities. Since the antenna coil is matched to an external reader antenna by the second coil, the matching of the antenna coil to the external reader is not determined solely by the geometric design of the antenna coil. A small antenna coil can therefore be used which is still matched to the external reader by the second coil. This leads to more space on the card for personalization, e.g. by laser engraving.

The design approach ensures that the smart card can operate effectively within transmission protocols such as AM (Amplitude Modulation) and SSB (Single Side Band), maintaining clear and reliable communication.

Amplitude Modulation (AM) is generally a modulation technique used in wireless communication to transmit information through waves. In this method, the amplitude of a carrier wave, typically a sine wave, is varied in direct proportion to the amplitude of the signal being transmitted.

Single Side Band (SSB) is generally a refinement of amplitude modulation that reduces bandwidth and power usage by eliminating one of the sidebands and the carrier frequency in an AM signal. SSB transmits only one of the sidebands (either upper or lower) which contains the actual information, making it more efficient than AM.

Using the high-frequency magnetic field, information can be transmitted. In this setup, the smart card can send information back to the reader. The external reader or system emits an electromagnetic field through its antenna, which the smart card captures. Through induction, a current is generated in the smart card's antenna coil, powering the microchip. This activated microchip may decode commands from the external reader. Subsequently, the smart card can encode and modulate the response into the emitted field. This allows the smart card to transmit its serial number or other requested information. The smart card itself does not produce a field but modifies the electromagnetic transmission field of the reader. By changing the impedance via integrated switching circuits, a distinct signal can be created. This alteration in the field can be detected by the external reader and utilized for digital communication. The smart card can modulate the carrier signal, which is then received by the reader for communication.

Furthermore, the second coil can be separate from the antenna coil, the antenna coil being larger in diameter than the first and second coils. The larger diameter of the third coil compared to the first and second coils can increase the effective inductive coupling area, which may enhance the range and strength of communication with external reader antennas. The separation of the second coil from the antenna coil allows for the antenna coil to be specifically optimized for interactions with reader antennas. Additionally, the increased diameter of the third coil permits the accommodation of the other two coils within its structure, thereby supporting a compact and integrated design.

In this context, “separate” particularly refers to a spatial separation, in particular enabling each coil to generate its own magnetic field independently. However, the coils can still be interconnected, possibly configured in serial or parallel arrangements. This refers in particular to the separation of the second coil from the third coil, as well as the separation of the second coil from the first coil. However, the first coil can also be separated from the antenna coil.

Preferably, the second coil and a capacitive element form the LC network. As already indicated in the passages above, the integration of a resonance circuit comprising a second coil and a capacitive element enhances the efficiency of energy transfer between the smart card and an external reader or system, thereby improving the reliability of data transmission. Since the IC chip receives its energy from the IC module coil, which is generated by the inductive coupling with the first coil, a modular structure is possible, leading to simplified assembly. This means that the IC chip and the IC module coil can be assembled as a module in any smart card without having to be wired. In addition, the microchip can be better protected against interference from the antenna coil, as it is not directly connected to it. In the same way, the IC chip does not affect the antenna coil. The IC chip can further comprise a memory or other relevant components for data processing and transmitting.

The capacitive element and the second coil can be a structural unit, wherein the capacitive element is formed by two wire ends of the second coil. Combining the capacitive element and the second coil into a single structural unit simplifies the card's design, which can lead to a reduction in manufacturing complexity and associated costs. The capacitive element being formed by two wire ends of the second coil can provide a self-contained LC network with minimal components, which can improve the card's durability by reducing the number of potential failure points.

Furthermore, it is possible that the capacitive element and the second coil are separate elements. In this regard, the capacitive element may be connected to both wire ends of the second coil to constitute a parallel resonance circuit. A parallel resonance circuit configuration can contribute to a more stable tuning of the resonance frequency.

In an exemplary embodiment, the IC chip comprises a NXP P71 EMV 6-pin icoM chip, enabling reduced timing delays and enhanced coupling for payment applications. The NXP P71 EMV 6-pin icoM chip is a secure microcontroller developed by NXP Semiconductors, designed for use in smart card applications such as payment systems, secure identity verification, and access control. This chip is based on the advanced NXP P71 platform, which integrates robust cryptographic capabilities and high-performance processing to meet the stringent requirements of sensitive applications.

In another exemplary embodiment, a smart card may comprise a substrate that supports a dual-interface antenna system and a chipcard module with an IC chip and an IC module coil. The chipcard module can be integrated into the antenna system, which may include a first coil, an antenna coil, and a second coil.

The antenna system is preferably configured to interface with external systems for both contactless and contact-based operations and may be optimized for integration with an STM ST31P45054APB1 icoM PAY 6-pin module.

The antenna system may be further characterized by a wire diameter within the range of 0.06 mm to 0.1 mm. The wire pitch can vary, with the first coil preferably having a pitch of 0.17 mm±10%, the second coil a pitch of 0.5 mm±10%, and the antenna coil a pitch of 0.3 mm±10%. The number of turns in the first coil may range from 8 to 10, in the antenna coil from 2 to 5, and in the second coil from 10 to 13.

The advantage of the smart card described in this context lies in its highly optimized dual-interface antenna system, which supports both contactless and contact-based communication with external systems. The integration of the chipcard module, which includes a chip and an IC module coil, into the antenna system enables seamless communication in diverse use cases. By incorporating a first coil, an antenna coil, and a second coil, the system achieves efficient electromagnetic coupling and reliable data exchange.

The system's design is specifically optimized for integration with advanced chip modules, such as the STM ST31P45054APB1 icoM PAY 6-pin module. The carefully defined parameters of the antenna system-such as the wire diameter, wire pitch, and the number of turns in each coil-enhance its performance. For example, the wire diameter, ranging from 0.06 mm to 0.1 mm, ensures precise electromagnetic behavior, while the varying wire pitches for each coil allow for efficient energy transfer and coupling. The number of turns in each coil is tailored to balance inductance and resonant frequency, optimizing the system for high-speed and reliable communication.

Overall, this configuration provides a compact, high-performance solution that ensures interoperability, energy efficiency, and precision in communication, while maintaining flexibility for integration with cutting-edge chip technologies.

The functionality and interaction of the first, second, and antenna coils, as well as the chipcard module, can be understood analogously to the preceding aspect and can therefore be applied here. The second configuration differs from the previous aspect primarily in the selection of parameters, including the wire diameter, the pitch for each coil, and the number of turns in each coil.

The STM ST31P45054APB1 icoM PAY 6-pin module is a chip card module developed by STMicroelectronics, designed for use in dual-interface smart cards. It is based on a secure microcontroller from the ST31 family, and is optimized for both contact-based and contactless applications. The module supports various security features and delivers high performance for payment applications.

Variable pitch preferably refers to the intentional variation in the spacing between wire turns within a coil, also known as wire pitch. This design approach enables segment-specific tuning of the coil, allowing different parts of the coils to achieve optimal electromagnetic properties tailored to specific functional requirements. By varying the pitch across the coil, the design can enhance inductance, coupling efficiency, and resonance characteristics in critical sections, while maintaining overall performance stability. The specified values for variable pitch indicate that at least one section of the coil conforms to these values. For example, a second coil with a pitch of 0.5 mm±10% means that at least a portion of the coil adheres to this specified range.

This technique is particularly valuable in applications where smaller wire diameters or fewer turns are used, as it compensates for these limitations by strategically improving electromagnetic behavior in key areas. For instance, sections with tighter wire pitch can increase inductance and improve coupling near critical components, such as the chip module, ensuring reliable energy transfer. Conversely, wider pitch in less critical areas helps reduce energy dissipation and accommodates space or structural constraints.

The wire diameter, wire pitch, and number of turns in the antenna coil, the first coil, and the second coil may preferably be variably adjusted within the selected ranges to achieve specific performance goals. These adjustments can tune the resonant frequency of the smart card to approximately 13.8 MHz within a tolerance of ±0.5 MHz, improving coupling efficiency while minimizing delay. Additionally, such modifications may help stabilize the Quality Factor to around 34, which enhances compliance with EMV standards and ensures reliable operation in relevant applications.

By maintaining a Quality Factor of approximately 34, the smart card achieves a balance between resonance efficiency and power stability, preventing chip overload while ensuring effective data exchange. The compact design of the antenna system, occupying ⅔ of the total card area, provides additional space for features like security elements or personalization options, enhancing the card's versatility without compromising performance.

The antenna system is preferably designed to minimize response timing errors, ensuring compliance with CA144 digital timing standards. Response timing errors refer to delays or inconsistencies in the smart card's ability to process and respond to signals from an external reader. Such errors can lead to failed transactions, slower processing times, or unreliable data exchange, especially in high-speed environments like payment terminals. Compliance with CA144 digital timing standards, a benchmark for evaluating the stability and precision of digital communication between the smart card and external systems, ensures the card's ability to synchronize reliably with external readers.

This is achieved through the optimized antenna design, which includes carefully calibrated parameters such as wire diameter, pitch, and the number of turns, along with tuned resonant frequencies. These design features enhance electromagnetic coupling with the external reader, improving signal strength and stability. By minimizing delays and preventing jitter, or variations in signal timing, the antenna system ensures smooth and reliable communication. Furthermore, it enhances signal integrity by reducing interference and noise, preventing mismatched timing between transmitted and received signals.

In further aspects that refer to elements of a method for manufacturing a smart card, various advantageous effects can be seen. These elements can be combined with the other elements in the present application as described above and below.

The proposed method for manufacturing a smart card involves several steps to ensure optimal performance and compliance with industry standards. The process can preferably begin with the design of a dual-interface antenna system, which may be tailored to facilitate both contact-based and contactless communication. This antenna system might incorporate advanced features to enhance electromagnetic coupling and signal transmission. Once designed, the antenna system can be integrated with a chip selected from high-performance options such as the NXP P71 EMV 6-pin or the STM ST31P45054APB1 icoM PAY 6-pin, both of which are known for their security and reliability in smart card applications.

Following integration, the antenna system may preferably be tuned to achieve a resonant frequency of approximately 13.8 MHz with a tolerance of ±0.5 MHZ, supporting efficient operation and compatibility with external readers. The tuning process can also include stabilizing the quality factor, or Q, to fall within a range of approximately 34 to 40. This balance between resonance efficiency and stability might minimize energy loss while maintaining reliable performance. Additionally, the wire diameter, pitch, and the number of turns in the antenna coils may be adjusted as needed to optimize coupling efficiency with external systems and reduce energy dissipation during data transmission.

Finally, the smart card can undergo rigorous testing to confirm compliance with EMV standards. This may include evaluations for analog interference using the CAB111 test and assessments of digital timing precision through the CA144 standard. These tests preferably ensure that the smart card meets the stringent requirements for secure, reliable, and efficient operation in payment and related applications.

This method for manufacturing a smart card provides several significant advantages, making it highly effective for modern applications. First, the tuning of the antenna system to a resonant frequency of 13.8 MHz±0.5 MHz, combined with optimizing the quality factor to fall within a range of 34 to 40, ensures highly efficient electromagnetic coupling. This results in enhanced performance and reliability during both contact-based and contactless operations, allowing for consistent communication with external readers in a variety of environments. Additionally, the method incorporates rigorous testing to ensure compliance with EMV standards, including evaluations for analog interference through the CAB111 test and digital timing precision via the CA144 standard. Meeting these global benchmarks guarantees universal compatibility with a wide range of devices and systems, reducing operational issues and improving the user experience. Furthermore, the precise adjustment of wire diameter, pitch, and turns in the antenna system optimizes energy efficiency and coupling performance, minimizing energy dissipation. This approach also supports a more compact design, leaving space for additional features such as security elements or personalization options without compromising functionality.

The skilled person will recognize that the advantages, technical effects, and preferred embodiments discussed in connection with the smart card may analogously apply to the method for manufacturing a smart card. Similarly, all advantages, technical effects, and preferred embodiments described in connection with the method may be transferable to the smart card.

A further embodiment combines one or more elements of the aspect relating to the configuration of three coils for a smart card described above with one or more elements of the aspect relating to the embedding of coils in an antenna substrate described above.

A further embodiment combines one or more elements of the aspect relating to the configuration of three coils for a smart card described above with one or more elements of the aspect relating to the metal composition in the smart card described above.

A further embodiment combines one or more elements of the aspect relating to the configuration of three coils for a smart card described above with one or more elements of the aspect relating to the first and third coils formed from a single piece of wire described above.

A further embodiment combines one or more elements of the aspect relating to the configuration of three coils for a smart card described above with one or more elements of the aspect relating to the second and third coils formed from a single piece of wire described above.

A further embodiment combines one or more elements of the aspect relating to the configuration of three coils for a smart card described above with one or more elements of the aspect relating to the first, second, and third coils having the same winding direction formed from a single piece of wire described above.

A further embodiment combines one or more elements of the aspect relating to the configuration of three coils for a smart card described above with one or more elements of the aspect relating to the first, second, and third coils formed from a single piece of wire including no welds or soldering joints described above.

A further embodiment combines one or more elements of the aspect relating to the configuration of three coils for a smart card described above with one or more elements of the aspect relating to the capacitive element described above.

A further embodiment combines one or more elements of the aspect relating to the configuration of three coils for a smart card described above with one or more elements of the aspect relating to the first, second, and third coil are arranged on the same plane described above.

A further embodiment combines one or more elements of the aspect relating to the configuration of three coils for a smart card described above with one or more elements of the aspect relating to the modified properties of the second coil described above.

A further embodiment combines one or more elements of the aspect relating to the configuration of three coils for a smart card described above with one or more elements of the aspect relating to the electrically connecting the ends of the second and third coils described above.

A further embodiment combines one or more elements of the aspect relating to the configuration of three coils for a smart card described above with one or more elements of the aspect relating to the dual-contact chipcard module comprising a via hole with conductive material described above.

A further embodiment combines one or more elements of the aspect relating to the configuration of three coils for a smart card described above with one or more elements of the aspect relating to the dual-contact chipcard module comprising a bridge described above.

A further embodiment combines one or more elements of the aspect relating to the configuration of three coils for a smart card described above with one or more elements of the aspect relating to the smart card having coils with specific wire diameter, wire pitch, and number of turns described above.

A further embodiment combines one or more elements of the aspect relating to the embedding of coils in an antenna substrate described above with one or more elements of the aspect relating to the metal composition in the smart card described above.

A further embodiment combines one or more elements of the aspect relating to the embedding of coils in an antenna substrate described above with one or more elements of the aspect relating to the first and third coils formed from a single piece of wire described above.

A further embodiment combines one or more elements of the aspect relating to the embedding of coils in an antenna substrate described above with one or more elements of the aspect relating to the second and third coils formed from a single piece of wire described above.

A further embodiment combines one or more elements of the aspect relating to the embedding of coils in an antenna substrate described above with one or more elements of the aspect relating to the first, second, and third coils having the same winding direction formed from a single piece of wire described above.

A further embodiment combines one or more elements of the aspect relating to the embedding of coils in an antenna substrate described above with one or more elements of the aspect relating to the first, second, and third coils formed from a single piece of wire including no welds or soldering joints described above.

A further embodiment combines one or more elements of the aspect relating to the embedding of coils in an antenna substrate described above with one or more elements of the aspect relating to the capacitive element described above.

A further embodiment combines one or more elements of the aspect relating to the embedding of coils in an antenna substrate described above with one or more elements of the aspect relating to the first, second, and third coil are arranged on the same plane described above.

A further embodiment combines one or more elements of the aspect relating to the embedding of coils in an antenna substrate described above with one or more elements of the aspect relating to the modified properties of the second coil described above.

A further embodiment combines one or more elements of the aspect relating to the embedding of coils in an antenna substrate described above with one or more elements of the aspect relating to the electrically connecting the ends of the second and third coils described above.

A further embodiment combines one or more elements of the aspect relating to the embedding of coils in an antenna substrate described above with one or more elements of the aspect relating to the dual-contact chipcard module comprising a via hole with conductive material described above.

A further embodiment combines one or more elements of the aspect relating to the embedding of coils in an antenna substrate described above with one or more elements of the aspect relating to the dual-contact chipcard module comprising a bridge described above.

A further embodiment combines one or more elements of the aspect relating to the embedding of coils in an antenna substrate described above with one or more elements of the aspect relating to the smart card having coils with specific wire diameter, wire pitch, and number of turns described above.

A further embodiment combines one or more elements of the aspect relating to the metal composition in the smart card described above with one or more elements of the aspect relating to the first and third coils formed from a single piece of wire described above.

A further embodiment combines one or more elements of the aspect relating to the metal composition in the smart card described above with one or more elements of the aspect relating to the second and third coils formed from a single piece of wire described above.

A further embodiment combines one or more elements of the aspect relating to the metal composition in the smart card described above with one or more elements of the aspect relating to the first, second, and third coils having the same winding direction formed from a single piece of wire described above.

A further embodiment combines one or more elements of the aspect relating to the metal composition in the smart card described above with one or more elements of the aspect relating to the first, second, and third coils formed from a single piece of wire including no welds or soldering joints described above.

A further embodiment combines one or more elements of the aspect relating to the metal composition in the smart card described above with one or more elements of the aspect relating to the capacitive element described above.

A further embodiment combines one or more elements of the aspect relating to the metal composition in the smart card described above with one or more elements of the aspect relating to the first, second, and third coil are arranged on the same plane described above.

A further embodiment combines one or more elements of the aspect relating to the metal composition in the smart card described above with one or more elements of the aspect relating to the modified properties of the second coil described above.

A further embodiment combines one or more elements of the aspect relating to the metal composition in the smart card described above with one or more elements of the aspect relating to the electrically connecting the ends of the second and third coils described above.

A further embodiment combines one or more elements of the aspect relating to the metal composition in the smart card described above with one or more elements of the aspect relating to the dual-contact chipcard module comprising a via hole with conductive material described above.

A further embodiment combines one or more elements of the aspect relating to the metal composition in the smart card described above with one or more elements of the aspect relating to the dual-contact chipcard module comprising a bridge described above.

A further embodiment combines one or more elements of the aspect relating to the metal composition in the smart card described above with one or more elements of the aspect relating to the smart card having coils with specific wire diameter, wire pitch, and number of turns described above.

A further embodiment combines one or more elements of the aspect relating to the first and third coils formed from a single piece of wire described above with one or more elements of the aspect relating to the second and third coils formed from a single piece of wire described above.

A further embodiment combines one or more elements of the aspect relating to the first and third coils formed from a single piece of wire described above with one or more elements of the aspect relating to the first, second, and third coils having the same winding direction formed from a single piece of wire described above.

A further embodiment combines one or more elements of the aspect relating to the first and third coils formed from a single piece of wire described above with one or more elements of the aspect relating to the first, second, and third coils formed from a single piece of wire including no welds or soldering joints described above.

A further embodiment combines one or more elements of the aspect relating to the first and third coils formed from a single piece of wire described above with one or more elements of the aspect relating to the capacitive element described above.

A further embodiment combines one or more elements of the aspect relating to the first and third coils formed from a single piece of wire described above with one or more elements of the aspect relating to the first, second, and third coil are arranged on the same plane described above.

A further embodiment combines one or more elements of the aspect relating to the first and third coils formed from a single piece of wire described above with one or more elements of the aspect relating to the modified properties of the second coil described above.

A further embodiment combines one or more elements of the aspect relating to the first and third coils formed from a single piece of wire described above with one or more elements of the aspect relating to the electrically connecting the ends of the second and third coils described above.

A further embodiment combines one or more elements of the aspect relating to the first and third coils formed from a single piece of wire described above with one or more elements of the aspect relating to the dual-contact chipcard module comprising a via hole with conductive material described above.

A further embodiment combines one or more elements of the aspect relating to the first and third coils formed from a single piece of wire described above with one or more elements of the aspect relating to the dual-contact chipcard module comprising a bridge described above.

A further embodiment combines one or more elements of the aspect relating to the first and third coils formed from a single piece of wire described above with one or more elements of the aspect relating to the smart card having coils with specific wire diameter, wire pitch, and number of turns described above.

A further embodiment combines one or more elements of the aspect relating to the second and third coils formed from a single piece of wire described above with one or more elements of the aspect relating to the first, second, and third coils having the same winding direction formed from a single piece of wire described above.

A further embodiment combines one or more elements of the aspect relating to the second and third coils formed from a single piece of wire described above with one or more elements of the aspect relating to the first, second, and third coils formed from a single piece of wire including no welds or soldering joints described above.

A further embodiment combines one or more elements of the aspect relating to the second and third coils formed from a single piece of wire described above with one or more elements of the aspect relating to the capacitive element described above.

A further embodiment combines one or more elements of the aspect relating to the second and third coils formed from a single piece of wire described above with one or more elements of the aspect relating to the first, second, and third coil are arranged on the same plane described above.

A further embodiment combines one or more elements of the aspect relating to the second and third coils formed from a single piece of wire described above with one or more elements of the aspect relating to the modified properties of the second coil described above.

A further embodiment combines one or more elements of the aspect relating to the second and third coils formed from a single piece of wire described above with one or more elements of the aspect relating to the electrically connecting the ends of the second and third coils described above.

A further embodiment combines one or more elements of the aspect relating to the second and third coils formed from a single piece of wire described above with one or more elements of the aspect relating to the dual-contact chipcard module comprising a via hole with conductive material described above.

A further embodiment combines one or more elements of the aspect relating to the second and third coils formed from a single piece of wire described above with one or more elements of the aspect relating to the dual-contact chipcard module comprising a bridge described above.

A further embodiment combines one or more elements of the aspect relating to the second and third coils formed from a single piece of wire described above with one or more elements of the aspect relating to the smart card having coils with specific wire diameter, wire pitch, and number of turns described above.

A further embodiment combines one or more elements of the aspect relating to the first, second, and third coils having the same winding direction formed from a single piece of wire described above with one or more elements of the aspect relating to the first, second, and third coils formed from a single piece of wire including no welds or soldering joints described above.

A further embodiment combines one or more elements of the aspect relating to the first, second, and third coils having the same winding direction formed from a single piece of wire described above with one or more elements of the aspect relating to the capacitive element described above.

A further embodiment combines one or more elements of the aspect relating to the first, second, and third coils having the same winding direction formed from a single piece of wire described above with one or more elements of the aspect relating to the first, second, and third coil are arranged on the same plane described above.

A further embodiment combines one or more elements of the aspect relating to the first, second, and third coils having the same winding direction formed from a single piece of wire described above with one or more elements of the aspect relating to the modified properties of the second coil described above.

A further embodiment combines one or more elements of the aspect relating to the first, second, and third coils having the same winding direction formed from a single piece of wire described above with one or more elements of the aspect relating to the electrically connecting the ends of the second and third coils described above.

A further embodiment combines one or more elements of the aspect relating to the first, second, and third coils having the same winding direction formed from a single piece of wire described above with one or more elements of the aspect relating to the dual-contact chipcard module comprising a via hole with conductive material described above.

A further embodiment combines one or more elements of the aspect relating to the first, second, and third coils having the same winding direction formed from a single piece of wire described above with one or more elements of the aspect relating to the dual-contact chipcard module comprising a bridge described above.

A further embodiment combines one or more elements of the aspect relating to the first, second, and third coils having the same winding direction formed from a single piece of wire described above with one or more elements of the aspect relating to the smart card having coils with specific wire diameter, wire pitch, and number of turns described above.

A further embodiment combines one or more elements of the aspect relating to the first, second, and third coils formed from a single piece of wire including no welds or soldering joints described above with one or more elements of the aspect relating to the capacitive element described above.

A further embodiment combines one or more elements of the aspect relating to the first, second, and third coils formed from a single piece of wire including no welds or soldering joints described above with one or more elements of the aspect relating to the first, second, and third coil are arranged on the same plane described above.

A further embodiment combines one or more elements of the aspect relating to the first, second, and third coils formed from a single piece of wire including no welds or soldering joints described above with one or more elements of the aspect relating to the modified properties of the second coil described above.

A further embodiment combines one or more elements of the aspect relating to the first, second, and third coils formed from a single piece of wire including no welds or soldering joints described above with one or more elements of the aspect relating to the electrically connecting the ends of the second and third coils described above.

A further embodiment combines one or more elements of the aspect relating to the first, second, and third coils formed from a single piece of wire including no welds or soldering joints described above with one or more elements of the aspect relating to the dual-contact chipcard module comprising a via hole with conductive material described above.

A further embodiment combines one or more elements of the aspect relating to the first, second, and third coils formed from a single piece of wire including no welds or soldering joints described above with one or more elements of the aspect relating to the dual-contact chipcard module comprising a bridge described above.

A further embodiment combines one or more elements of the aspect relating to the first, second, and third coils formed from a single piece of wire including no welds or soldering joints described above with one or more elements of the aspect relating to the smart card having coils with specific wire diameter, wire pitch, and number of turns described above.

A further embodiment combines one or more elements of the aspect relating to the capacitive element described above with one or more elements of the aspect relating to the first, second, and third coil are arranged on the same plane described above.

A further embodiment combines one or more elements of the aspect relating to the capacitive element described above with one or more elements of the aspect relating to the modified properties of the second coil described above.

A further embodiment combines one or more elements of the aspect relating to the capacitive element described above with one or more elements of the aspect relating to the electrically connecting the ends of the second and third coils described above.

A further embodiment combines one or more elements of the aspect relating to the capacitive element described above with one or more elements of the aspect relating to the dual-contact chipcard module comprising a via hole with conductive material described above.

A further embodiment combines one or more elements of the aspect relating to the capacitive element described above with one or more elements of the aspect relating to the dual-contact chipcard module comprising a bridge described above.

A further embodiment combines one or more elements of the aspect relating to the capacitive element described above with one or more elements of the aspect relating to the smart card having coils with specific wire diameter, wire pitch, and number of turns described above.

A further embodiment combines one or more elements of the aspect relating to the first, second, and third coil are arranged on the same plane described above with one or more elements of the aspect relating to the modified properties of the second coil described above.

A further embodiment combines one or more elements of the aspect relating to the first, second, and third coil are arranged on the same plane described above with one or more elements of the aspect relating to the electrically connecting the ends of the second and third coils described above.

A further embodiment combines one or more elements of the aspect relating to the first, second, and third coil are arranged on the same plane described above with one or more elements of the aspect relating to the dual-contact chipcard module comprising a via hole with conductive material described above.

A further embodiment combines one or more elements of the aspect relating to the first, second, and third coil are arranged on the same plane described above with one or more elements of the aspect relating to the dual-contact chipcard module comprising a bridge described above.

A further embodiment combines one or more elements of the aspect relating to the first, second, and third coil are arranged on the same plane described above with one or more elements of the aspect relating to the smart card having coils with specific wire diameter, wire pitch, and number of turns described above.

A further embodiment combines one or more elements of the aspect relating to the modified properties of the second coil described above with one or more elements of the aspect relating to the electrically connecting the ends of the second and third coils described above.

A further embodiment combines one or more elements of the aspect relating to the modified properties of the second coil described above with one or more elements of the aspect relating to the dual-contact chipcard module comprising a via hole with conductive material described above.

A further embodiment combines one or more elements of the aspect relating to the modified properties of the second coil described above with one or more elements of the aspect relating to the dual-contact chipcard module comprising a bridge described above.

A further embodiment combines one or more elements of the aspect relating to the modified properties of the second coil described above with one or more elements of the aspect relating to the smart card having coils with specific wire diameter, wire pitch, and number of turns described above.

A further embodiment combines one or more elements of the aspect relating to the electrically connecting the ends of the second and third coils described above with one or more elements of the aspect relating to the dual-contact chipcard module comprising a via hole with conductive material described above.

A further embodiment combines one or more elements of the aspect relating to the electrically connecting the ends of the second and third coils described above with one or more elements of the aspect relating to the dual-contact chipcard module comprising a bridge described above.

A further embodiment combines one or more elements of the aspect relating to the electrically connecting the ends of the second and third coils described above with one or more elements of the aspect relating to the smart card having coils with specific wire diameter, wire pitch, and number of turns described above.

A further embodiment combines one or more elements of the aspect relating to the dual-contact chipcard module comprising a via hole with conductive material described above with one or more elements of the aspect relating to the dual-contact chipcard module comprising a bridge described above.

A further embodiment combines one or more elements of the aspect relating to the dual-contact chipcard module comprising a via hole with conductive material described above with one or more elements of the aspect relating to the smart card having coils with specific wire diameter, wire pitch, and number of turns described above.

A further embodiment combines one or more elements of the aspect relating to the dual-contact chipcard module comprising a bridge described above with one or more elements of the aspect relating to the smart card having coils with specific wire diameter, wire pitch, and number of turns described above.

### BRIEF DESCRIPTION OF THE FIGURES

The present disclosure is illustrated by way of example and not limited in the accompanying figures in which like reference numerals indicate similar elements. Embodiments of the application will now be described with reference to the attached drawings:

FIG. 1 shows a smart card in an exploded perspective view,

FIG. 2 shows a longitudinal sectional view of a smart card, with an antenna substrate shown in top view,

FIG. 3 shows a smart card comprising a half size third coil in top view,

FIG. 4 shows a smart card comprising a ⅔ size third coil in top view,

FIG. 5 shows a smart card in an exploded perspective view,

FIG. 6 shows a cross-sectional view of a smart card,

FIG. 7 shows a cross-sectional view of the IC module,

FIG. 8 shows a cross-sectional view of a smart card comprising an inlay,

FIG. 9 shows a sheet of an inlay comprising an antenna substrate.

FIG. 10 shows a cross-section through a chipcard module according to the application.

FIG. 11 shows a top view of the chipcard module of FIG. 10.

FIG. 12 shows a top view of a further chipcard module according to the disclosure.

FIG. 13 shows external connecting terminals of a further chipcard module according to the disclosure.

FIG. 14 shows external connecting terminals of a further chipcard module according to the disclosure.

FIG. 15 shows external connecting terminals of a further chipcard module according to the disclosure.

FIG. 16 shows external connecting terminals of a further chipcard module according to the disclosure.

FIG. 17 shows external connecting terminals of a further chipcard module according to the disclosure.

FIG. 18 shows external connecting terminals of a further chipcard module according to the disclosure.

FIG. 19 shows 16 examples of external connecting terminals of further chipcard modules according to the disclosure.

FIG. 20 shows an exploded perspective view of a smart card.

FIG. 21 shows a cross-section through a chipcard module according to the application.

FIG. 22 shows a bottom view of the chipcard module.

FIG. 23 shows an antenna configuration for a smart card.

FIG. 24 shows a further antenna configuration for a smart card.

FIG. 25 shows a further antenna configuration for a smart card.

FIG. 26 shows a cross-sectional view of a smart card, illustrating the arrangement and thickness of its various layers.

FIG. 27 shows a flowchart illustrating a method for forming a smart card.

### DETAILED DESCRIPTION

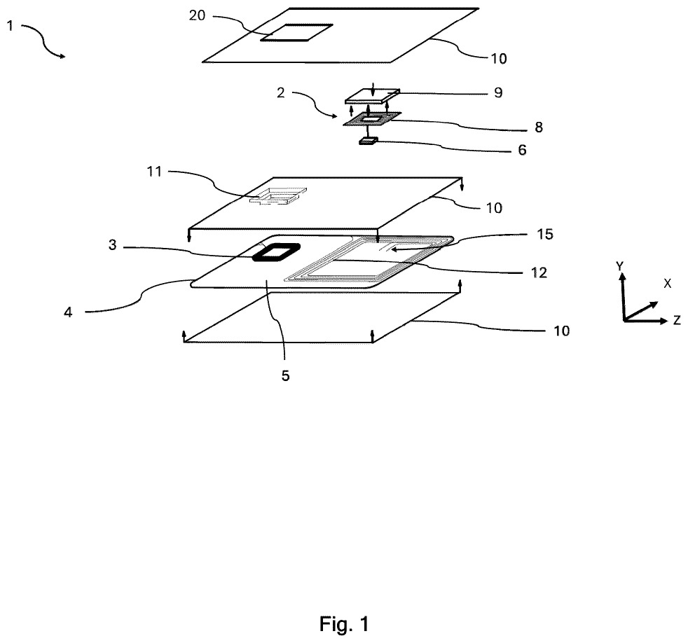

FIG. 1 shows a smart card 1 in an exploded perspective view. The smart card 1 comprises a first coil 3, a second coil 12, a third coil 4, an IC module coil 8, a microchip 6, and a capacitive element 15.

The third coil 4 is electrically connected to the second coil 12 and to the first coil 3. The second coil 12 and the capacitive element 15 form a resonance circuit and are configured to match the third coil 4 with the external reader for optimized signal reception and transmission.

In addition, the IC module coil 8 is electrically connected to the microchip 6. This IC module coil 8 is positioned in relation to the first coil 3 in such way that a magnetic field generated by the first coil 3 can induce a current in the IC module coil 8.

The smart card 1 comprises multiple layers. The third coil 4, the first coil 3, the second coil 12 and the capacitive element 15 are embedded in the same layer, in particular in an antenna substrate 5. After embedding the coils, the antenna substrate 5 is laminated with card substrates 10 to form a sandwich structure.

Further, the first coil 3 is designed with turns that define the perimeter of a first surface area of the smart card 1 and define a first interior space surrounded by turns of the first coil 3. Similarly, the second coil 12 has turns defining a perimeter of a second surface area and a second interior space within it. The third coil 4 with turns defines the perimeter of a third surface area and a third interior space.

Moreover, the third coil 4 has a larger diameter than the first coil 3 and the second coil 12. Accordingly, the third surface area is larger than the first and second surface areas. In this regard, the second coil 12 and the first coil 3 are arranged in the third interior space within the third surface area, wherein the first and second surface areas do not overlap one another.

Additionally, the capacitive element 15 is constructed as an integral part of the second coil 12, formed by extending wire ends from the second coil 12.

Further, the IC module coil 8 is situated on a different layer than the first coil 3, the third coil 4, the second coil 12, and the capacitive element 15. It is mounted on an IC module 2 which includes a module substrate 9. The microchip 6 is also mounted on this IC module 2. For assembly of the IC module 2, an engagement hole 11 and an alternative engagement hole 20 are provided in the card substrate 10 through a milling process.

For data transfer between the smart card 1 and the external reader, a high-frequency magnetic field is generated by the external reader. When the smart card 1 is situated within this high-frequency magnetic field, a current is induced in the third coil 4.

The third coil 4 is specifically tuned to the resonant frequency of the external device's antenna by connecting a resonance circuit comprising a second coil 12 with a capacitive element 15 to the third coil 4.

The second coil 12, while being a passive component, does not actively radiate or significantly absorb radiation from the external reader due to its design, which does not match it with the external device's antenna. Instead, its main function is to optimize the efficiency of the energy transfer by matching the third coil 4 with the external reader, helping to enhance the overall performance of the system without directly participating in the active communication process. This configuration ensures that the primary absorption of the emitted energy is performed by the third coil 4.

Additionally, the induced current is substantially higher in the third coil 4 compared to the IC module coil 8, which is directly connected to the microchip 6. As a result, the received signal's sensitivity of the smart card 1 is greatly influenced by the characteristics of the third coil 4.

The received signal or induced current in the third coil 4 is then transferred to the first coil 3. Due to the close coupling and efficient placement of the first and IC module coils 3, 8, the signal is effectively transmitted to the microchip 6.

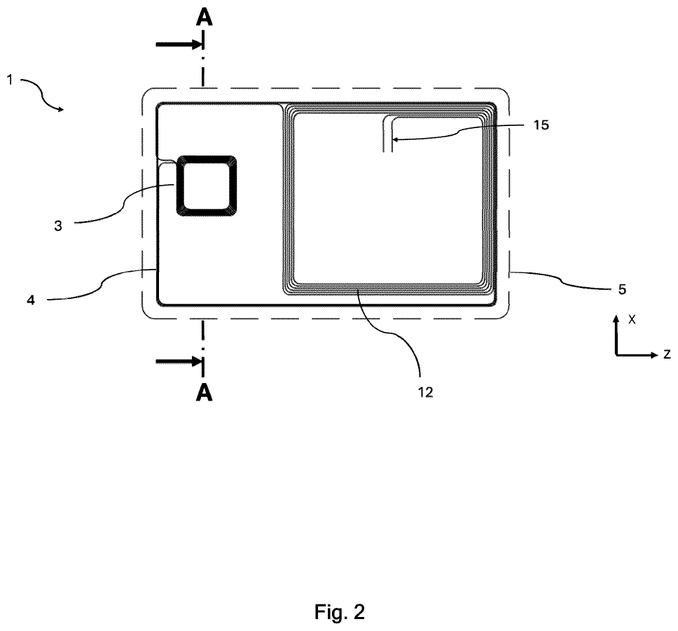

FIG. 2 shows a longitudinal sectional view of a smart card 1, with an antenna substrate 5 shown in top view. The antenna substrate 5 comprises a first coil 3, a third coil 4, a second coil 12, and a capacitive element 15. The third coil 4, which has the largest diameter, surrounds the second coil 12, the first coil 3 and the capacitive element 15. The capacitive element 15 is formed by two wire ends of the second coil 12.

The first coil 3, the third coil 4, the second coil 12, and the capacitive element 15 are embedded into the antenna substrate 5 with a constant force. Several embedding methods are conceivable. But, the embedding is preferably done without the use of any conductive foil, conductive layer, laser ablation, or etching.

The method step of applying wire of the first, second, and third coils may include ultrasonic vibration along with the constant downward force for embedding the wire into the antenna substrate.

Embedding can be carried out, for example, by laying the first coil 3, the third coil 4, the second coil 12 and the capacitive element 15 in the antenna substrate 5 by using ultrasonic vibration along with the constant downward force.

Furthermore, the third coil 4, the first coil 3 and the second coil 12, and preferably also the capacitive element 15, can be made from a single piece of wire. The single piece of wire provides the same winding direction for the third coil 4, the first coil 3 and the second coil 12. In addition, no welding or soldering is required to connect sections of the wire.

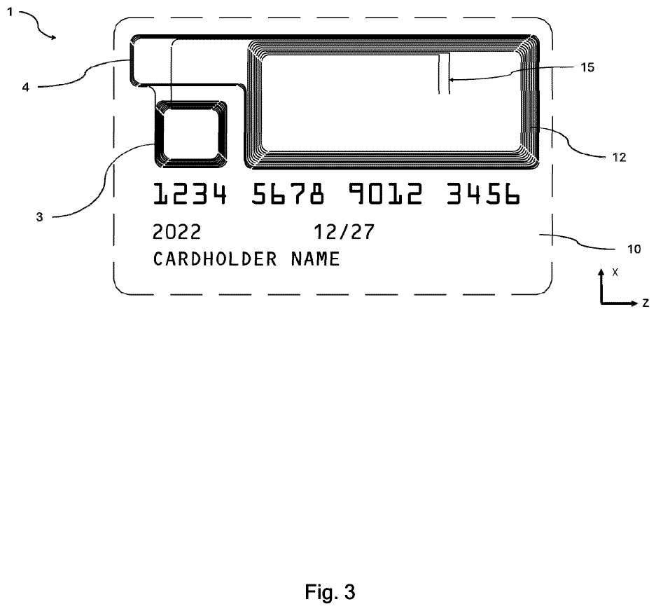

FIG. 3 shows a smart card 1 in top view. Although the top layer of the smart card 1, in particular a card substrate 10, is visible, FIG. 3 also schematically depicts a third coil 4, a first coil 3, a second coil 12, and a capacitive element 15. The third coil 4 is of half the size compared to the embodiment shown in FIGS. 1 and 2.

The half-size third coil 4 may have the following dimensions: 80 mm×26 mm. Furthermore, the first coil 3 and the second coil 12 have 9 turns, while the half-size antenna has 6 turns. The term “turns” refers to the number of times the wire is wound around the core of the coil.

Under these conditions, the inductance of the third coil 4 is around 4uH, with a capacitance of around 5 pF, yielding a resonant frequency of 32.5 MHz. To tune the third coil 4 to a resonant frequency of 13.56 MHz, the second coil 12 matches by providing an additional resonance circuit, i.e. a LC network, with a capacitance of 30 pF. The resulting resonant frequency is approximately 13.5 MHz.

The third coil 4 has a larger diameter than the first coil 3 and the second coil 12. Accordingly, the third surface area is larger than the first and second surface areas. In this regard, the second coil 12 is arranged in the third interior space within the third surface area. In contrast, the first coil 3 is not enclosed by the third coil 4.

The third coil 4 is electrically connected to both the second coil 12 and the first coil 3. Additionally, the capacitive element 15 is constructed as an integral part of the second coil 12, formed by extending wire ends from the second coil 12. The smart card I can be further personalized through embossing or laser engraving.

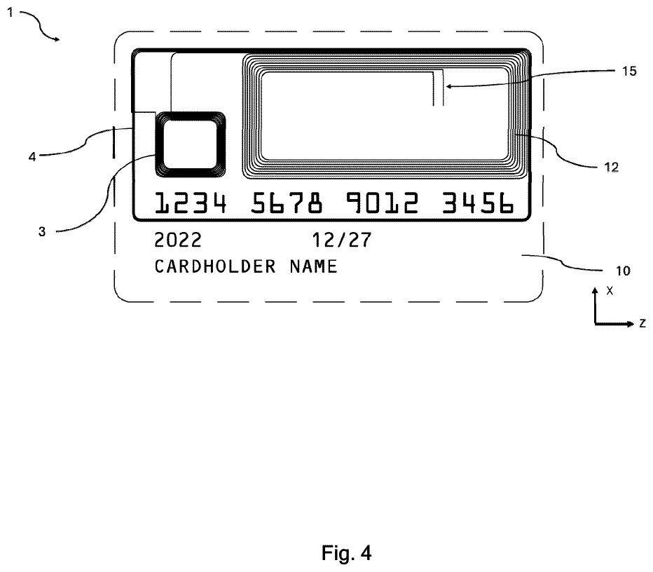

FIG. 4 shows a smart card 1 in top view. Although the top layer of the smart card 1, in particular a card substrate 10, is visible, FIG. 4 also schematically depicts a third coil 4, a first coil 3, a second coil 12, and a capacitive element 15. The third coil 4 is of ⅔ the size compared to the embodiment shown in FIGS. 1 and 2.

The ⅔ third coil 4 may have the following dimensions: 80 mm×35 mm. While the first coil 3 comprises 9 turns, the second coil comprises 11 turns. On the other hand, the ⅔ antenna has 3 turns.

To enhance the coupling between the third coil 4 and the external device's antenna, the ⅔ size third coil 4 can used instead of the half-size third coil 4. The number of turns in the third coil 4 can be reduced in order, for example, to run the third coil 4 wire between embossing data on a banking card. Consequently, the capacitance of the third coil 4 is decreased. To achieve a resonant frequency of 13.56 MHz, the number of turns in the inner coil is increased.

The third coil 4 has a larger diameter than the first coil 3 and the second coil 12. Accordingly, the third surface area is larger than the first and second surface areas. In this regard, the second coil 12 and the first coil 3 are arranged in the third interior space within the third surface area, wherein the first and second surface areas do not overlap one another.

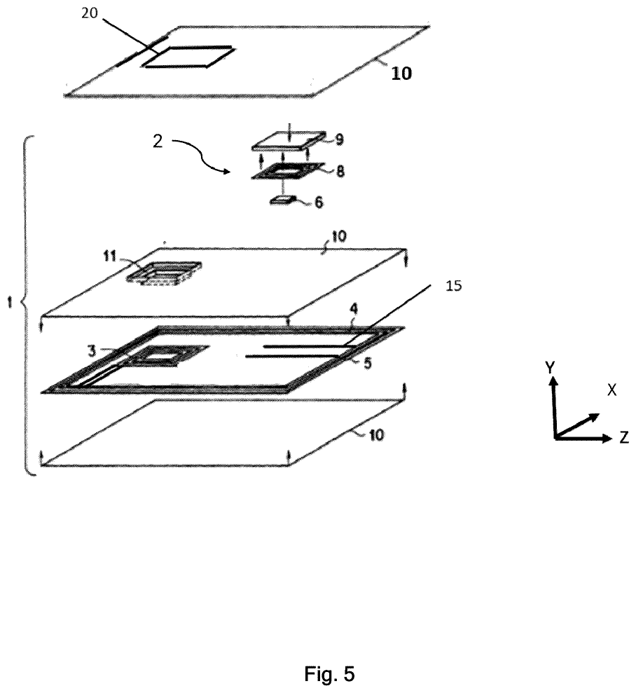

FIG. 5 shows a smart card 1 in an exploded perspective view. The smart card 1 comprises a third coil 4 which serves both to receive energy and to exchange information with the external device. The third coil 4 can be electromagnetically coupled with the external reader.

The first coil 3 has turns of wire defining a perimeter of a first surface area of the smart card 1 and defining a first interior space within the first surface area surrounded by turns of wire of the first coil 3. The third coil 4 has turns of wire defining a perimeter of a third surface area of the smart card and defining a third interior space within the third surface area surrounded by turns of wire of the third coil 4.

A capacitive element 15 is connected to the ends of the third coil 4 forming a parallel resonance circuit that enhances the smart card's 1 efficiency in data transfer. Additionally, a first coil 3 is connected to the third coil 4.

A microchip 6, incorporated within an IC module 2, is connected to an IC module coil 8. The proximity of the first coil 3 to the IC module coil 8 allows for signal transmission through inductive coupling, which occurs without a direct electrical connection. The IC module 2 also includes a module substrate 9 and is mounted in the engagement holes 11, 20 created in a card substrate 10.

The first coil 3, the third coil 4 and the capacitive element 15 can be applied to an antenna substrate 5 using a wire embedding process which use ultrasonic vibration and which uses a constant downward force throughout the wire embedding process rather than applying different downward forces during the embedding process.

Further, the first coil 3, the third coil 4 and the capacitive element 15 can be laid into a non-metallic antenna substrate 5 without use of any conductive foil, conductive layer, laser ablation, or etching. The smart card 1 is, additionally, free from metal layers. Also, the metal composition of the smart card 1 is less than 40% of the smart card 1 weight.

Moreover, the first coil 3, the third coil 4 are made from a single piece of wire, the single piece of wire having the same winding direction for both the first coil 3 and the third coil 4. Alternatively, also the capacitive element 15 can be made from this single piece of wire.

The process of coupling data transfer involves a high-frequency magnetic field from an external reader inducing currents in the resonance circuit, which comprise the third coil 4 and capacitive element 15. These currents are then transferred to the first coil 3 and IC module coils 8, with the latter transmitting power to the microchip 6.

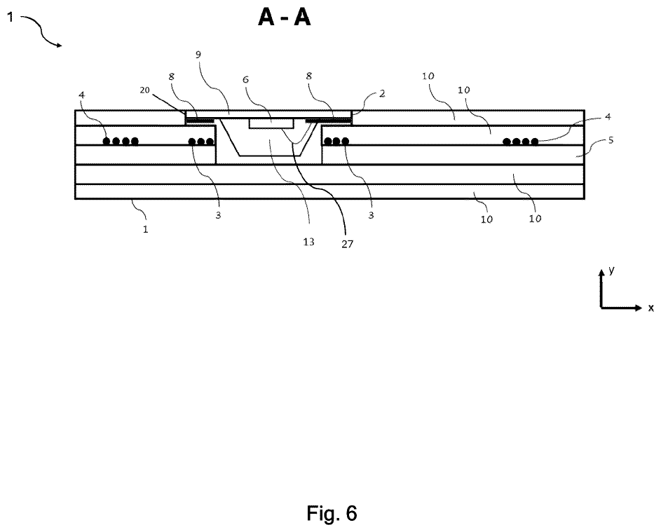

FIG. 6 shows a cross-sectional view of a smart card 1. The smart card 1 is composed of multiple layers, each of which is formed as an antenna substrate 5 or a card substrate 10. None of these layers consists entirely of metal, and the overall metal composition of the smart card 1 does not exceed 40% of the smart card's 1 weight.

A third coil 4 and a first coil 3 are embedded in the antenna substrate 5. Also, a second coil 12 can be embedded in the antenna substrate 5. The antenna substrate 5 is disposed between layers of a card substrate 10, wherein two layers of the card substrate 10 are each disposed above and below the antenna substrate 5. The respective layers are bonded together.

Preferably, the antenna substrate 5 consists of materials such as PVC, polyimide, polycarbonate, or PET, while the card substrate 10 comprises PVC or a printed layer.

Moreover, an engagement hole 20 is provided in the card substrate 10 which can extend through all layers, including the antenna substrate 5. An IC module 2 is mounted within this engagement hole 20. The IC module 2 comprises a module substrate 9, an attached microchip 6 and an IC module coil 8. The microchip 6 is connected to the IC module coil 8 by wire bonding 27. Both the wire bonding 27 and the microchip 6 are encapsulated by dam-and-fill encapsulation material 13. In addition, the IC module coil 8 is aligned so that its center lies over the center of the first coil 3. The individual windings of the first coil 3 and the IC module coil 8 are also positioned on top of each other.

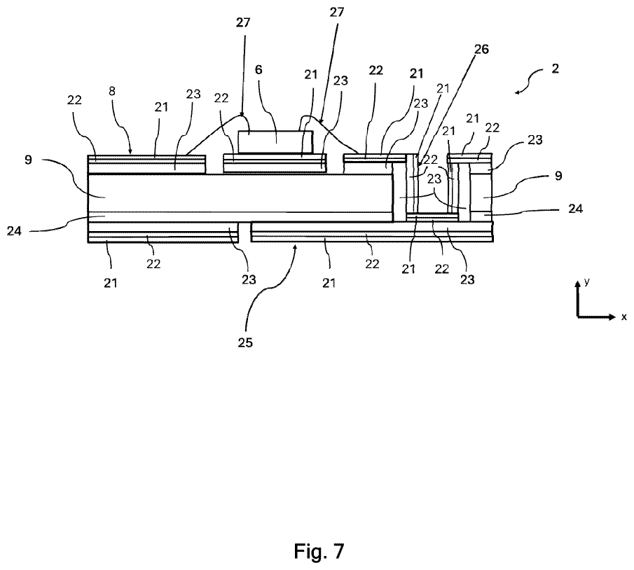

FIG. 7 illustrates a cross-sectional view of the IC module 2, which includes a module substrate 9. The module substrate 9 is clad with copper foil 23 on both sides and partially connected by an adhesive layer 24. The IC module coil 8 is formed directly on a first side of the module substrate 9 by etching the copper-clad substrate 9. Additionally, gold plating 21 and nickel plating 22 can be applied to the copper foil 23 through a deposition process. A microchip 6 is wire-bonded 27 to the first coil 3.

Further, the IC module comprises terminal electrodes 25 which act as a contact-type transmission section. These electrodes 25 are formed on a second side of the module substrate 9 by the etching the copper foil 23. The electrodes 25 and the microchip 6 are connected through via structures 26 which a through holes that are filled with a conductive material. Contrary, the IC module coil 8 constitutes a non-contact-type transmission section.

The arrangement allows dual interface operations with the smart card 1, i.e. contact and non-contact transmission.

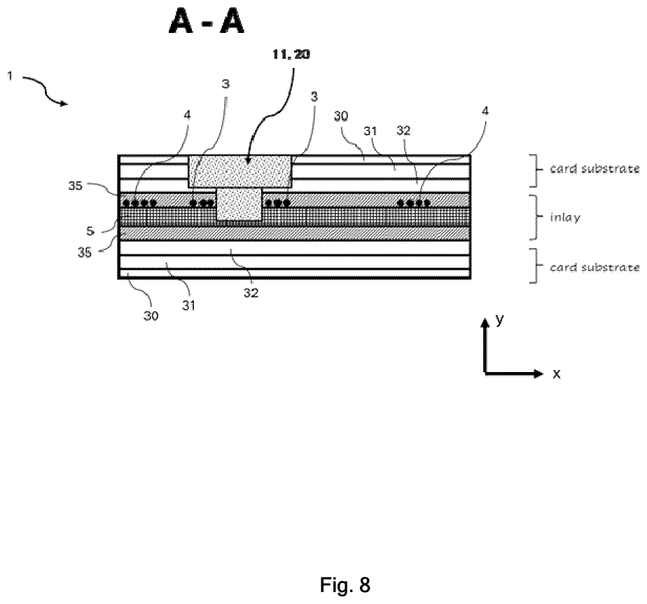

FIG. 8 shows a cross-sectional view of a smart card 1. The smart card 1 comprises multiple layers, which include both an inlay and card substrates 10. The inlay is arranged between two card substrates 10 and is permanently connected to them by lamination.

The inlay comprises an antenna substrate 5 on which at least one third coil 4 and a first coil 3 are embedded. Als, a second coil 12 can be embedded in the antenna substrate 5. In addition, the inlay comprises two compensation layers 35 located respectively above and below the antenna substrate 5. The card substrates 10 consist of a printed layer 32, a PVC layer 31 or an overlay layer 30, all of which are permanently bonded or laminated to the inlay.

The individual layers of the smart card I have specific thicknesses. For example, the antenna substrate 5 may have a thickness of 150 micrometers, the compensation layers 35 each may have a thickness of 105 micrometers, the printed layer 32 can have a thickness of 100 micrometers, the PVC layer 31 may also have a thickness of 100 micrometers, and the overlay layer 30 may have a thickness of 50 micrometers.

Furthermore, an engagement hole 11, 20, is milled into the card substrate 10 and/or the inlay to accommodate an IC module 2.

The smart card 1 may be supplied solely as an inlay or as an inlay plus a printed layer 32 and a PVC layer 31, allowing a customer the option to provide their own overlay layers 30.

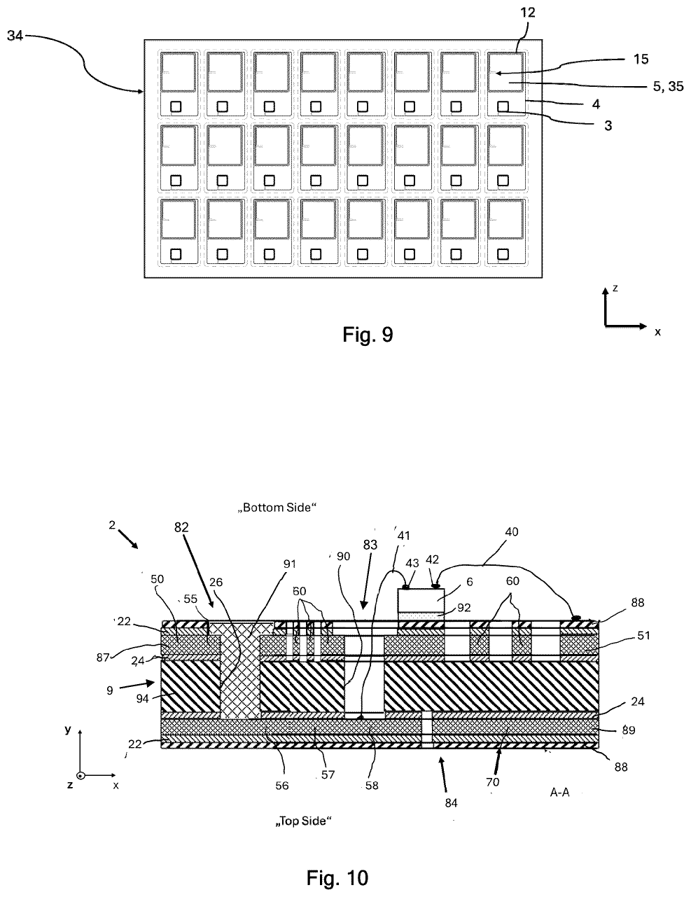

FIG. 9 shows a sheet 34 of an inlay with an antenna substrate 5. The sheet 34 is segmented into different sections, each of which is associated with a particular smart card 1. Within each section, wires are embedded to form a first coil 3, a third coil 4, a second coil 12 and a capacitive element 15.

The antenna substrate 5 is placed between two compensation layers 35, thus forming an inlay.

The next stage is to assemble the printing layers 32 and the PVC layers 31 and the overlay 30, and to laminate these and the inlay sheet together using heat, pressure and waiting time to form a so-called mono-block.

After that, in individual cards are extracted from the sheet monoblock. A cavity for the IC module 2 is then milled into each card. After milling, the IC module 2 is embedded into each single card, thereby forming the smart card 1.

FIG. 10 shows a cross-section through a chipcard module 2 according to the application.

The depicted FIG. 10 is a detailed cross-sectional view of a dual-contact chipcard module 2, where one can see the arrangement and connection of the different components. There is a module substrate 9 comprising an antenna side 82, a bonding side 83 and a contact side 84. The antenna side 82 and the bonding side 83 are both located on the bottom side of the chipcard module 2, whereas the contact side 84 is located on the top side, which corresponds to the opposite outer surface of the chipcard module 2.

The figure is oriented by coordinate axes, where the z-axis points out of the page, the y-axis points upwards, and the X-axis extends horizontally to the right, indicating the depth and layering of the module.

The module substrate 9 comprises an insulating substrate layer 94 sandwiched between two conductive foil layers 87, 89. Above the insulating substrate layer 94, there is provided an adhesive 24 layers that attaches the conductive foil layer 87 to the insulating substrate 94.

FIG. 10 shows a via hole 26 filled with conductive material 91, creating an electrical connection between the conductive traces 60 on the bonding side 83 or antenna side 84 and the contact side conductive foil layer 89.

The chip 6, located at the bonding side 83 of the module substrate 9, is attached by a chip adhesive 92. Two bonding wires are shown, the first antenna bonding wire 40 extends upwards from the first antenna chip pad 42, while the second antenna bonding wire 41 is provided at the second antenna chip pad 43, creating electrical connections from the chip 6 to their respective contact pads.

At the contact side 84, there are provided ISO contact pads 70 which are connected to the internal circuitry and would interface with an external reader or device that is not shown here.

An encapsulation material 80, which would cover the chip 6 and bond wires, is there but it is not illustrated in FIG. 10. Furthermore, the RFID antenna and its connections are not explicitly shown in FIG. 10 but they are part of the conductive traces 60 at the antenna side 82.

Elements such as the first antenna end 50, second antenna end 51, upper via end 55, lower via end 56, bridge 57, and lower bridge bonding contact area 58 are also labeled, helping to understand the assembly and routing of electrical connectivity within the chipcard module 2.

The first antenna end 50 is the terminal end of the antenna coil, or in other word IC module coil 8, located on the bonding side conductive foil layer 87. This end connects to the first pre-determined contact pad of the chip 6 through the antenna structure and through the first antenna bonding wire 40. The connection provided by the first antenna end 50 enables the transmission of signals within the module by linking the antenna and the chip 6.

The second antenna end 51 is another terminal end of the antenna coil, which connects to the second pre-determined contact pad 43 of the chip 6, through the antenna structure and through the second antenna bonding wire 41 which passes through the bonding hole 20. The second antenna end 51 completes the antenna loop, facilitating RFID transmission.

The upper via end 55 is located at the upper end of the via hole 26, where the conductive material 91 begins to fill the hole. This end is situated above the bonding side surface of the ISO standard contact pads 70 and serves as the entry point for the conductive material, which forms an electrical connection between the bonding side conductive foil layer 87 and the contact side conductive foil layer 89.

The lower via end 56 is found at the lower end of the via hole 26, where the conductive material 91 forms an electrical connection with the contact side conductive foil layer 89. The lower via end 56 provides electrical connectivity from the bonding side 83 to the contact side 84 through the via hole 26.

The bridge 57 is a section that creates an electrical connection between the lower bridge bonding contact area 58 and another area on the same ISO standard contact pad 70. The bridge 57 plays a role in conducting electrical signals between the first antenna chip pad 42 and the second antenna chip pad 43 of the chip 6, supporting the operation of the antenna.

The lower bridge bonding contact area 58 is a contact point on the ISO standard contact pad 70 that provides the bridge 57, contributing to the proper functioning of the antenna and the chip 6.

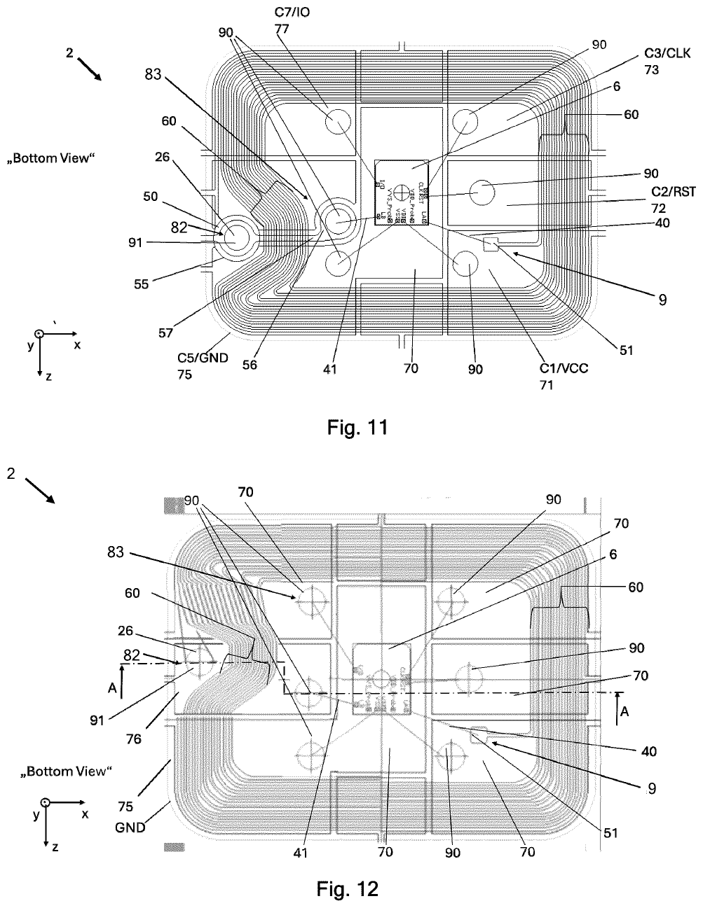

FIG. 10 shows that on the contact side 84 of the insulating substrate 94, a contact side Cu foil layer 89 is laminated using adhesive 24. Similar to the bonding side 83, a pre-determined pattern of conductive traces and contact pads is etched into the contact side Cu foil layer 89. The outlines of the contact pads are provided with thin lines in FIG. 11, although they cannot be seen from the top side of the chipcard module 2 because they are hidden behind the other components and elements of the chipcard module 2.

Whenever the application mentions a conductive foil, this may be provided in the form of a Cu (Copper) foil 23, 89, 89 or an Ag (Silver) foil or an Al (Aluminum) foil. In the following, the term “Cu foil” is used to explain this by way of using one possible synonym of materials that can be used interchangeably.

The outer surfaces of both the contact side Cu foil layer 89 and the bonding side Cu foil layer 87 are plated with Ni/Au 22, 88. The figures further depict the chip 6 on the bonding side 83 of the module substrate 9, using adhesive 92. The chip contact pads 42,43 are connected to the contact side surfaces of the ISO contact pads 70 through bond wires 27, 40, 41 passing through the via holes 26, as can be seen in FIG. 11. Additionally, a first antenna chip pad 42 is connected to an antenna contact pad 51 the bonding side Cu foil layer 87 using a bond wire 40, while a second antenna chip pad 43 is connected to an antenna contact pad surface on the contact side Cu foil layer 89, by way of a bond wire 41 passing through the bonding hole 90, thereby forming a bridge 57 for a loop antenna.

The closed-loop antenna of the device in FIGS. 10 and 11 comprises a first antenna chip pad LA, a first bonding wire 40, antenna conductive traces going counterclockwise in circular direction, a first antenna end pad, an upper via end, a conductive paste, a lower via end, a bridge, a lower bridge bonding contact area, a second antenna bonding wire, and a second antenna chip pad LB.

FIG. 11 shows a top view of the chipcard module of FIG. 10. As one can see in FIG. 11, a pre-determined pattern of conductive traces 60 forming the closed-loop antenna 8 and contact pads 51 for contacting one end of the antenna loop 8 is etched into the bonding side Cu foil layer 87. The figure also shows the presence of one via hole 26 and six bonding holes 90 in the bonding side Cu foil layer 87, the insulating substrate 94, and the adhesive. The via hole 26 is filled with conductive material 91.

As one can see in FIG. 11, the antenna side 82 or bonding side 83 of the module 2 comprises various conductive antenna traces 60 forming part of an RFID antenna coil, which can serve as an IC module coil 8, around the module substrate 9. The chip 6 is centrally mounted on the module 9 with bonding wires 40 and 41 connecting to one antenna contact pad 51 and one ISO contact pad 70. The antenna side 82 comprises a primary antenna end 50 and a secondary end 51, both of which are connected to individual contact pads on the chip 6.

The via hole 26, filled with conductive material 91, provides electrical connectivity between the bonding side conductive foil layer 87 and the contact side conductive foil layer 89 through the insulating substrate layer 94. This via hole 26 links the conductive antenna traces 60 to a specific ISO standard contact pad C4.

Additionally, there is a bonding hole 90, which is used for connecting the bonding wire 40 to that ISO contact pad C4. The other ISO contact pads 70 themselves are labeled according to their standard designations, such as C1/VCC, C2/RST, C3/CLK, C5/GND, and C7/IO. The conductive traces 60 are laid out to form the RFID antenna, and both the traces 60 and contact pads 70 are integral to the dual-contact functionality of the chipcard module 1.

FIGS. 10 and 11 illustrate the result of the following measures:
Laminating a bonding side Cu foil layer 87 to the bonding side 83 of an insulating substrate layer 94, using an adhesive,

Etching a pre-determined pattern of conductive antenna traces 60, a first antenna end 50 and a second antenna contact pad 51 into the bonding side Cu foil layer 87,
Providing at least one via hole 26 and a bonding hole 90 in the bonding side Cu foil layer 87, insulating substrate 94, and adhesive,
Laminating a contact side Cu foil layer 89 to the contact side of the insulating substrate 94, using adhesive,
etching six or eight ISO contact pads 70 into contact side Cu foil layer 89,
Providing a Ni/Au plating 22, 88 onto the contact side Cu foil layer 89 and the bonding side Cu foil layer 87,
Filling the via hole 26 with conductive material 91, thereby contacting the first antenna end with a first section of the contact side surface of the contact side Cu foil layer 89, and especially with one of the ISO contact pads 70,
Mounting a chip 6 onto the bonding side 83 of the module substrate 9, using an adhesive 92,
Contacting a first pre-determined chip contact pad 43 with a second section of the contact side surface of the contact side Cu foil layer 89, and especially with the same one of the ISO contact pads 70, by providing a bond wire 41 through the bonding hole 90,
Connecting a pre-determined chip contact pad 42 with a first antenna contact pad 51 on the bonding side Cu foil layer 87, by providing a bond wire 40,
contacting one or more chip contact pads with further sections of the contact side surface of the contact side Cu foil layer 89, and especially with one of the ISO contact pads 70, by providing bond wires into further via holes.

The above order of the measures does not necessarily mean that this is a preferred order of steps, other sequences also work. Providing a Ni/Au plating and/or adhesive is optional, other methods can be applied to achieve the same function.

While FIG. 11 shows a bridge area in the ISO contact pad C6 that is structured with gaps between conductive traces, the FIG. 12 shows the same ISO contact pad C6 without that structure, providing the same bridge function.

FIG. 12 shows a top view of a further chipcard module 2 according to the disclosure. The chipcard module 2 of FIG. 12 is in large parts identical to the chipcard module 2 of FIG. 11, except for the shape of the Pin #6 ISO contact pad VPP/NC/Not Connected 76. FIG. 10 shows the cross-section view of the line A-A in FIG. 12.

The module substrate 9, which is the base of the chipcard module 2, is visible from the antenna side 82 and bonding side 83. Conductive antenna traces 60 form an RFID transmission loop antenna patterned on the bonding side conductive foil layer 87 of the insulating substrate layer 94.

Conductive material 91 fills via hole 26 providing electrical connection through the insulating substrate layer 94 to the contact side conductive foil layer 89. This connection is shown with reference to Pin #6 ISO contact pad VPP/NC/Not Connected 76, which is one of the ISO contact pads 70. The chip 6 is mounted at the bonding side 83 and connected to the RF antenna and the contact pads. The first antenna bonding wire 40 connects a first predetermined contact pad of the chip 6 with an antenna contact pad surface area above the bonding side conductive foil layer 87. The view also includes a ground indication GND and a coordinate system, showing the orientation of the x, y, and z-axes. FIG. 12 also shows the paths for the first antenna bonding wire 40 and the second antenna bonding wire 41, highlighting their connection points to the chip 6 and conductive traces 60.

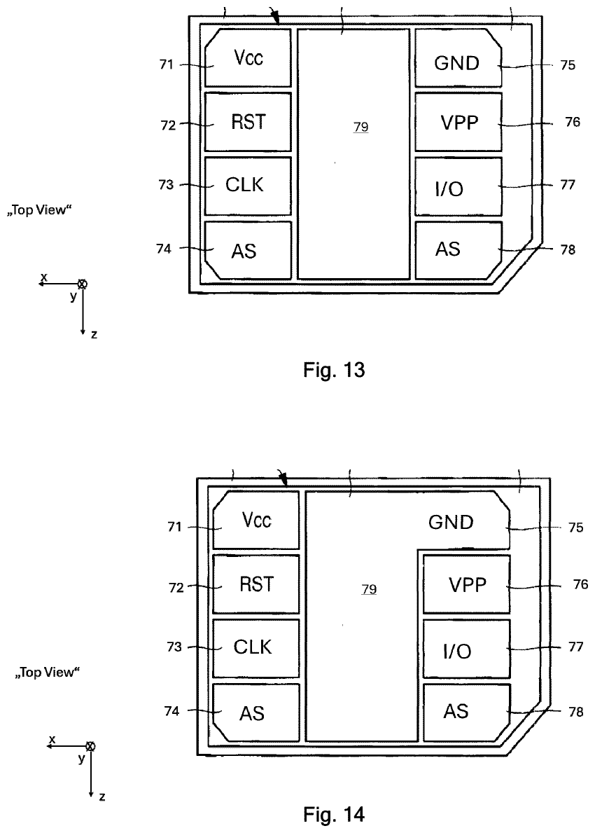

FIG. 13 shows external connecting terminals of a further chipcard module 2 according to the disclosure, illustrating the layout of the ISO contact pads 70 in a standard configuration on a contact side 84 of a chipcard module substrate 9, which is part of the overall dual-contact chipcard module 2 design.

The ISO contact set 81 comprises several distinct pads labeled for their respective purposes. Pin #1 72 labeled as “VCC” indicates the power supply voltage contact. Pin #2 72 labeled as “RST” is for reset. Pin #3 73 labeled as “CLK” is the clock input. Pin #4 74 and Pin #8 78 are labeled as “AS”, indicating application-specific use. Pin #5 75 labeled as “GND” is the ground contact. Pin #6 76 labeled as “VPP” is typically for programming voltage and is not connected to anything in some applications so that it can be used as a bridge 57 in the modules of the disclosure. Alternatively, Pin #4 74 and Pin #8 78 can be used as a bridge 57 in the modules of the disclosure. Pin #7 is labeled as “I/O” is the input/output contact.

A large center pad 79 is not connected to anything and serves as a mechanical re-inforcement element of the module. The layout is enclosed within the boundaries of the module substrate 9, and spacing between the contact pads is consistent with ISO standards for chipcard modules 2. The figure is annotated with “Top View” and includes a coordinate system indicating the orientation with axes labeled x, y, and z.

In other words, FIG. 13 shows an example of the external connecting terminals of the card chip. The eight external connecting terminals shown in FIG. 13 conform to ISO/IEC7816-2.

ISO/IEC 7816-2 pinout:

| Pin # | Name | Description |
|---|---|---|
| Pin #1 | VCC | +5 V or 3.3 V DC |
| Pin #2 | Reset Card Reset | (Optional) |
| Pin #3 | CLOCK | Card Clock |
| Pin #4 | AS | Application Specific |
| Pin #5 | GND | Ground |
| Pin #6 | VPP | +21 V DC [Programming], or NC |
| Pin #7 | I/O | In/out [Data] |
| Pin #8 | AS | Application Specific |

FIG. 14 shows external connecting terminals of a further chipcard module 2 according to the disclosure. The ISO contact set 81 of FIG. 14 is in large parts identical to the the ISO contact set 81 of FIG. 13, except that the GND contact pad 75 is integral with the center pad 79. Pin #6 labeled as “VPP” is typically for programming voltage and is not connected to anything in some applications so that it can be used as a bridge 57 in the modules of the disclosure. Alternatively, Pin #4 74 and Pin #8 78 can be used as a bridge 57 in the modules of the disclosure. The orientation of the diagram is indicated by the “Top View” label and the axes designation, meaning that one is looking down at the contact side 84 of the card module substrate 9.

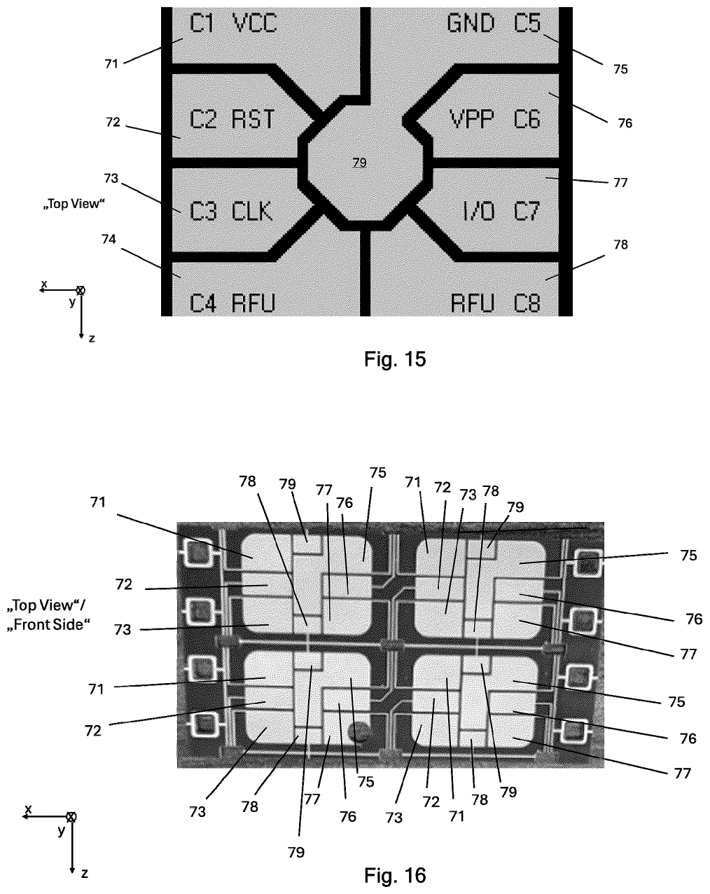

FIG. 15 shows external connecting terminals of a further chipcard module 2 according to the disclosure,

The figure illustrates a series of eight ISO contact pads 70 arranged in two columns on a module substrate 9. Each pad is assigned a label indicating its function “C1 VCC” for power supply, “C2 RST” for reset, “C3 CLK” for clock, “C4 RFU” reserved for future use, “GND C5” for ground, “VPP C6” for programming voltage or not connected, “I/O C7” for input/output communication, and “RFU C8” also reserved for future use. The layout is symmetric with a central area 79 potentially for the chip 6 or antenna placement. The contact pads are part of the external interface of a smart card 1, allowing it to connect to a card reader. The GND contact pad 75 is integral with the center pad 79. Pin #6 labeled as “VPP” is typically for programming voltage and is not connected to anything in some applications so that it can be used as a bridge 57 in the modules of the disclosure. Alternatively, Pin #4 74 and Pin #8 78 can be used as a bridge 57 in the modules of the disclosure. The figure also includes a coordinate system indicating the x, y, and z-axes, which suggests that the view is from above the contact side 84 of the chipcard module, looking directly down onto the contact pads.

FIG. 16 shows external connecting terminals of four further chipcard modules 2 according to the disclosure that are arranged as a transport tape. The components include the module substrates 9 which underlic all the visible elements but are not directly labeled in this view. One can see the ISO contact pads 70 that are labeled with numbers corresponding to their function as per ISO standards, such as 71 for the Pin #1 VCC contact pad and 72 for the Pin #2 Reset contact pad, and so on. The image marks the individual ISO contact pads 70 with their respective reference numerals, including 71, 72, 73, 74 and 78, 75, 76, and 77. The conductive material 91 that would fill the via hole 26 is not visible in this view but is there for linking the conductive traces 60 with the contact pads. The directional axes are shown to provide orientation to the viewer. The bonding side 83, chip adhesive 92, and chip 6, as well as the bonding wires and encapsulation material 80, are not seen in this top view but are part of the encapsulated modules. Pin #6 76 is typically for programming voltage and is not connected to anything in some applications so that it can be used as a bridge 57 in the modules of the disclosure.

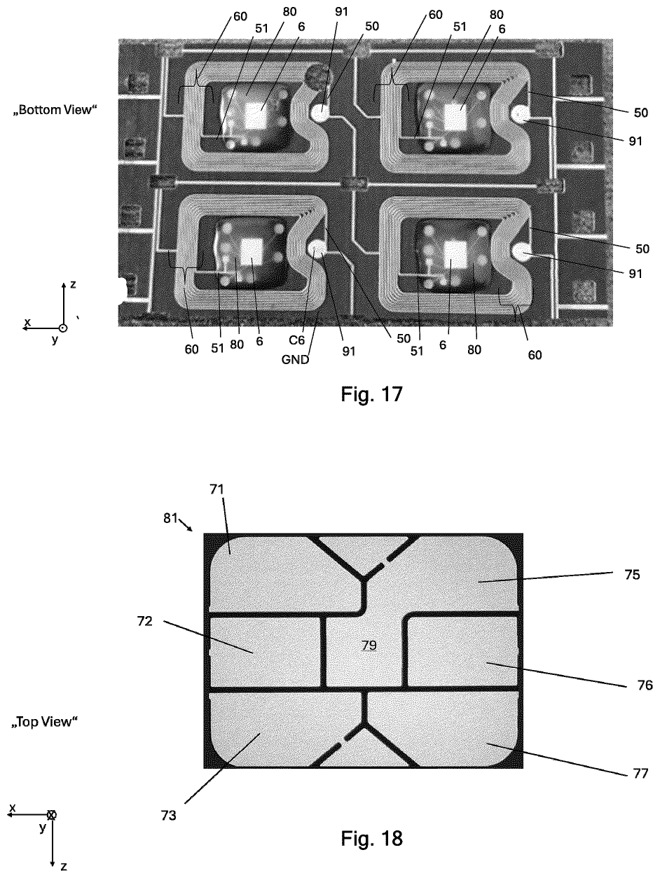

FIG. 17 shows the bottom view of the chipcard modules of FIG. 16.

Each module includes a module substrate 9, though not labeled in this view, which forms the base for the various elements depicted. The conductive antenna traces 60 are shown as spiraling patterns around the periphery of each module and are part of the RFID transmission antenna coil. At the center of each trace arrangement is a chip 6 mounted at the antenna side 82 of the module substrate 9. The encapsulation material 80 is visible as a transparent or translucent dome-shaped covering over the chips, serving to protect the chips and associated components from environmental factors. The conductive material 91 is filled in the via holes 26 to provide electrical connections between the conductive traces 60 and the contact side conductive foil layer 89—not marked here but is part of the structure that would be on the opposite side of the substrate. These connections provide the functionality of the chip 6 and its ability to communicate with other devices. The first antenna end 50, which corresponds to one end of the conductive traces 60, and the second antenna end 51 can be seen at opposite ends of the conductive trace loops. These serve as the start and termination points of the antenna coil.

While FIGS. 10 to 16 do not show an encapsulating step that follows in a further step, the encapsulation material covering the bond wires with the corresponding via holes, and the chip is seen in FIG. 17.

In the coordinate system in the figures, “y” is pointing into the card, the “x” represents the feather of the arrow. The dot “.” represents the point of the arrow. The “x” is often the longer side directed from the Ground pad to the rest of the contact set. The “z” is directed from the Ground pad to outside of the set.

For locating the Ground pad, this one is often provided integral with the center pad or contacted with it, and it is often as large as possible. After one turns the contact set such that one looks on the face of it and such that it is on the top right of the contact set, then the contact pad C6 is the one immediately under the Ground contact pad.

Providing one or more via holes and one or more, preferably five bonding holes in the bonding side conductive foil layer, in the insulating substrate, and in the adhesive can be provided by punching through from the contact side to the bonding side.

Conductive material can be provided in the form of conductive paste, solder, Ag, carbon, etc., for example by using a dispensing system from the bonding side.

FIG. 18 shows external connecting terminals of a further chipcard module 2 according to the disclosure.

The figure presents a top view of the ISO contact set 81 of a dual-contact chipcard module 2. The ISO contact set 81 comprises several ISO contact pads 70 labeled as follows Pin #1 ISO contact pad VCC 71, Pin #2 ISO contact pad Reset 72, Pin #3 ISO contact pad CLOCK 73, Pin #5 ISO contact pad GND/Ground 75, Pin #6 ISO contact pad VPP/NC/Not Connected 76, Pin #7 ISO contact pad I/O, In/out 77. The GND contact pad 75 is integral with the center pad 79. Pin #6 labeled as “VPP” is typically for programming voltage and is not connected to anything in some applications so that it can be used as a bridge 57 in the modules of the disclosure. These pads are situated in a standard layout for chipcards, where they are positioned to interface with external card readers. The axes are shown to indicate the orientation of the top view relative to the chipcard module. The figure provides a visual representation of the ISO contact pad 70 configuration, which ensures proper electrical contact between the chipcard and card readers or other interface devices.

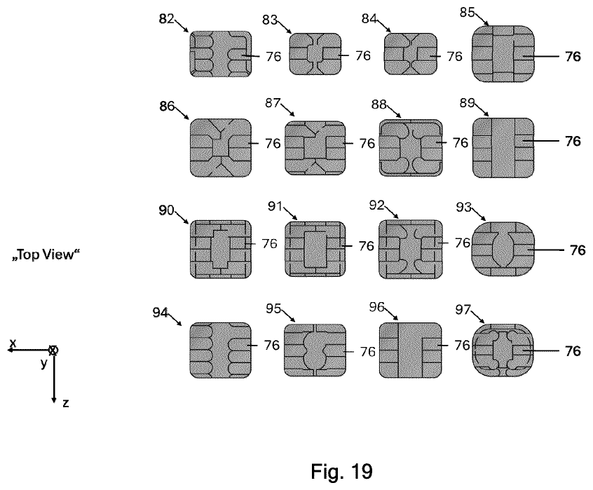

FIG. 19 shows external connecting terminals of 16 further chipcard modules 2 according to the disclosure. FIG. 19 provides a top view of different configurations of conductive antenna traces 60 and the array of ISO contact pads 70 for the dual-contact chipcard module 2. Each of the depicted modules 2 showcases a unique arrangement of these elements, illustrating the versatility in the design and how various chip 6 configurations can be accommodated without altering the fundamental structure.

The contact pads are discernible within each illustration and are designated by the number 76, referring to “Pin #6 ISO contact pad VPP/NC/Not Connected 76” in the provided list of reference numerals. Each variant still maintains compatibility with ISO standards, as the contact positions are consistent with the requirements for contact-based chipcard communication. The different designs align with the scope of the disclosure by demonstrating possible variations in module structuring while preserving the electrical functionality required for dual-contact interoperability. Pin #6 labeled as “VPP” is typically for programming voltage and is not connected to anything in some applications so that it can be used as a bridge 57 in the modules of the disclosure.

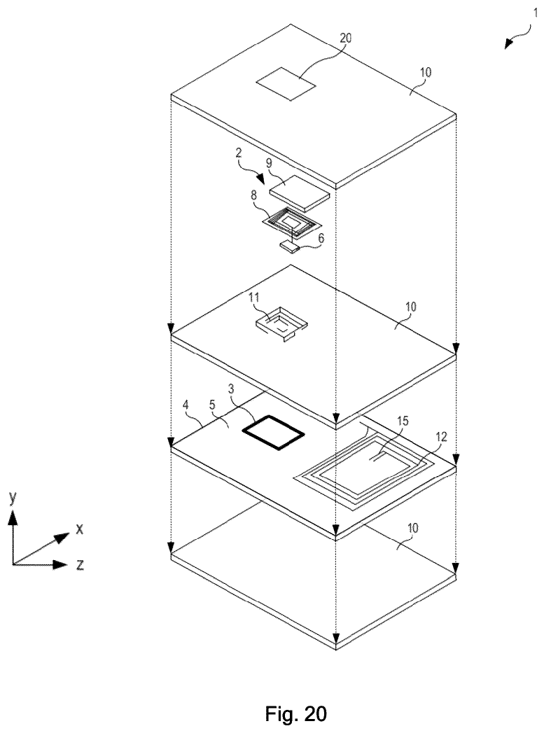

FIG. 20 illustrates an exploded perspective view of a smart card I und is equivalent to FIG. 1, showing that the disclosed chipcard module 2 can be incorporated in the embodiments of the smart card I mentioned above.

The smart card 1 comprises multiple integrated components and layers to facilitate data transfer and energy efficiency in communication with external devices.

The smart card 1 comprises a chipcard module 2 with a module substrate 9, an IC chip 6, and an IC module coil 8. The module substrate 9 serves for structural support for the IC chip 6, and the IC module coil 8. The IC module coil 8 is electrically connected to the IC chip 6 and is designed to interact with the first coil 3 by utilizing magnetic field induction.

The antenna coil 4, first coil 3, and second coil 12 are arranged to create an efficient resonance circuit for signal transfer and energy matching with external readers 200. The antenna coil 4 is electrically connected to the first coil 3 and the second coil 12, with the second coil 12 further integrating a capacitive element 15. This resonance circuit is designed to optimize the antenna coil's 4 performance by matching it with the external reader's antenna for improved signal reception and transmission.

The capacitive element 15 is an integral part of the second coil 12, formed by extending the wire ends of the coil itself. Together, the second coil 12 and capacitive element 15 enable tuning of the antenna coil 4 to the resonant frequency of the external reader's antenna.

The design incorporates a multi-layer structure. The antenna substrate 5, which houses the first coil 3, second coil 12, third coil 4, and capacitive element 15, is laminated between card substrates 10 to create a durable sandwich structure. Engagement holes 11 and 20 are milled into the card substrates 10 to facilitate alignment and assembly of the IC module 2 with the smart card layers.

The antenna coil 4 is designed with a larger diameter compared to the first coil 3 and second coil 12, resulting in a larger third surface area. This allows the first coil 3 and second coil 12 to be arranged entirely within the interior space defined by the turns of the antenna coil 4, without overlapping their respective surface areas.

The IC module coil 8, positioned on a separate layer from the antenna substrate 5, is configured to couple magnetically with the first coil 3. This ensures efficient signal transmission from the antenna coil 4 to the IC chip 6. The magnetic field generated by the first coil 3 induces a current in the IC module coil 8, which is then transmitted to the IC chip 6 for processing.

During operation, a high-frequency magnetic field generated by an external reader 200 induces a current in the antenna coil 4. The antenna coil 4, tuned to the external reader's frequency, transfers this energy efficiently to the first coil 3. The first coil 3 then closely couples with the IC module coil 8 to transmit the signal to the IC chip 6.

This configuration ensures optimal energy transfer and signal sensitivity. The third coil 4 primarily absorbs energy from the external reader 200, while the second coil 12, as a passive component, enhances the efficiency of the resonance circuit without actively radiating or absorbing significant radiation.

The close coupling of the coils and the strategic placement of components enables the smart card 1 to demonstrate high performance in contactless communication with external devices.

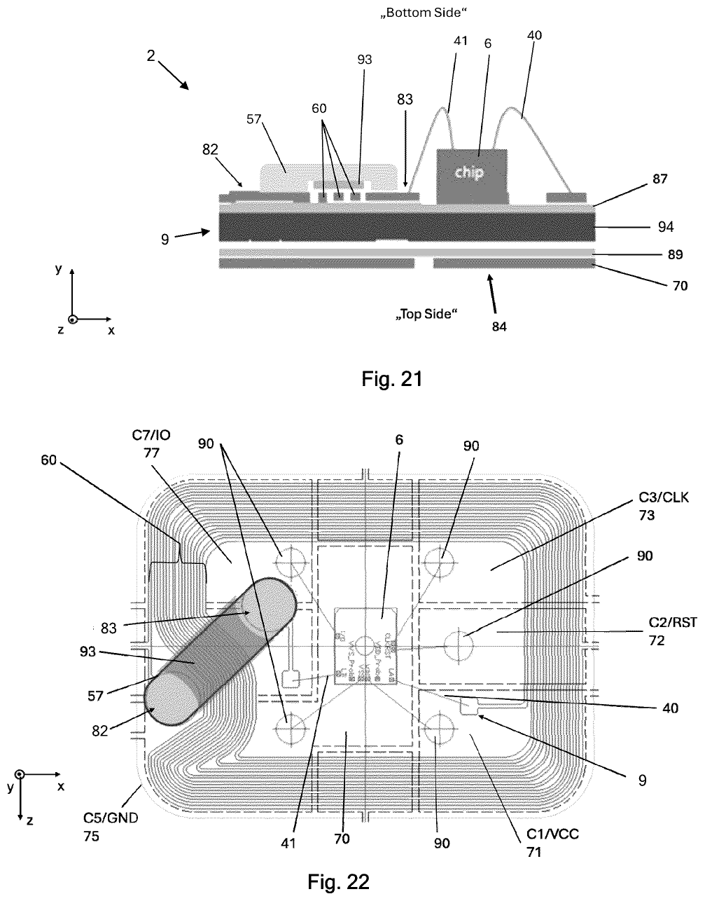

FIG. 21 shows a cross-section through a chipcard module 2 according to the application. The depicted FIG. 21 is a detailed cross-sectional view of a dual-contact chipcard module 2, illustrating the arrangement and connection of its components. At the bottom, there is a module substrate 9 characterized by an antenna side 82 and a bonding side 83.

FIG. 21 shows a cross-section of a chipcard module 2 designed with dual-contact functionality and a closed-loop antenna. The module substrate 9 comprises an insulating substrate layer 94 that is positioned between a bonding side conductive foil layer 87 and a contact side conductive foil layer 89. The bonding side conductive foil layer 87 is adhered to the insulating substrate layer 94 using an adhesive layer 24.

Conductive traces 60 may serve as a functional boundary between the antenna side and the bonding side. These traces are covered by an insulating material 93 having a thickness of 3 to 5 micrometers. The insulating material 93 is applied in such a way that it does not, or only partially, cover the regions around the antenna side 82 and the bonding side 83, thereby ensuring that these areas remain at least partially exposed to allow for electrical connectivity via the bridge 57.

On top of the insulating substrate layer 93 covering the conductive antenna traces 60, a conductive material layer, which can be in the form of ink, solder, or copper, is applied over the insulator material. This conductive material layer forms the bridge 57, electrically connecting the antenna side 82 to the bonding side 83. The thickness of this conductive material layer is between 10 to 15 micrometers to ensure robust connectivity while maintaining structural stability.

The chip 6 is attached to the bond pad located on the bonding side 83 using chip adhesive 92. The chip 6 is connected to the internal circuitry through bonding wires. The first antenna bonding wire 40 connects the first antenna chip pad 42 of the chip 6 to the bonding side conductive foil layer 87. The second antenna bonding wire 41 connects the second antenna chip pad 43 of the chip 6 to the ISO contact pads 70 located on the contact side 84, passing through a bonding hole 90. The ISO contact pads 70 are designed to interface with external readers 200 and are part of the electrical system for communication and power transfer.

The chip 6 and the bonding wires are encapsulated using epoxy material to protect the components from environmental and mechanical stress. This encapsulation step ensures durability and reliability of the module. After encapsulation, the module undergoes electrical testing to verify the integrity of the connections and functionality of the system.

This detailed cross-section highlights the precise layering and interconnections in the chipcard module, which ensure efficient performance, robust signal transmission, and reliable dual-contact functionality.

FIG. 22 illustrates a bottom view of the chipcard module 2, showing the arrangement of the conductive traces 60, ISO contact pads 70, and the bridge 57 that connects the antenna side 82 to the bonding side 83. The bonding side conductive foil layer 87 contains a pre-determined pattern of conductive antenna traces 60, which form a closed-loop antenna system. These traces are partially covered by an insulating material 93, applied with a thickness of 3 to 5 micrometers. The insulating material 93 is carefully applied to the antenna side 82 and bonding side 83 to ensure that these areas are not completely covered, allowing for electrical connectivity through the bridge 57.

The bridge 57 is formed by applying a conductive material layer over the insulating layer. This conductive material, which can take the form of ink, solder, or copper, has a thickness of 10 to 15 micrometers and electrically connects the antenna side 82 to the bonding side 83. The bridge 57 ensures robust signal transmission by linking these areas without disrupting the integrity of the loop antenna design.

The ISO contact pads 70, including C1/VCC 71, C2/RST 72, C3/CLK 73, C5/GND 75, and C7/I/O 77, are etched into the contact side conductive foil layer 89. These pads are visible as dotted outlines in FIG. 22 because they are located on the contact side 84 and are hidden from direct view by the insulating substrate layer 94. The dotted outlines highlight the precise alignment of the pads with the bonding side 83.

The chip 6 is mounted on the bonding side 83 of the module substrate 9 and is connected to the internal circuitry through bonding wires. These wires extend from the chip 6 and pass through bonding holes 90 to connect with the contact side conductive foil layer 89.

The conductive traces 60 are laid out in a counterclockwise pattern, forming the RFID antenna coil or IC module coil 8, which serves as the primary communication interface between the module and an external coil that may, for example, be implemented within a smart card 1. The bridge 57 plays an important role in electrically connecting the two main antenna regions while preserving the structural and functional integrity of the overall antenna system.

This bottom view of the chipcard module highlights the integration of the chip 6, the conductive traces 60, and the bridge 57, demonstrating the advanced design and manufacturing processes that ensure reliable operation and efficient data transfer.

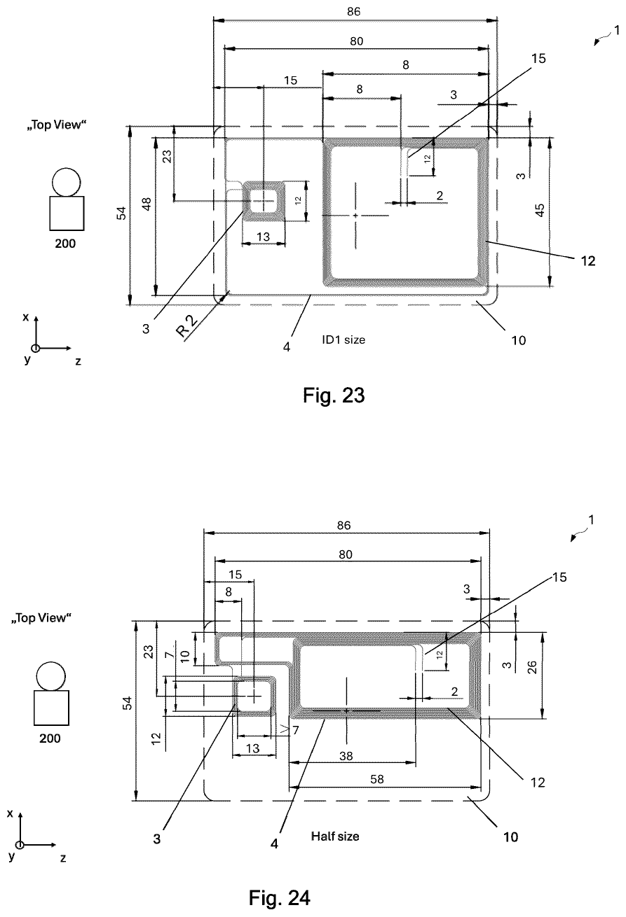

FIGS. 23, 24, and 25 illustrate different antenna configurations for a smart card 1, demonstrating variations in antenna size and structure to optimize reliability in data transmission with an external reader 200.

These three antenna configurations, shown in FIGS. 23, 24, and 25, illustrate the adaptability of the smart card 1 design. Each configuration is optimized for specific operational requirements, ensuring reliable data transmission and compatibility with external reader 200 systems. The integration of coils into the antenna substrate 5 through ultrasonic embedding simplifies the manufacturing process while maintaining structural integrity and performance.

In FIG. 23, the antenna substrate 5 is shown in a top view, incorporating a first coil 3, an antenna coil 4, a second coil 12, and a capacitive element 15. This type of antenna is commonly noted as ID1 size antenna wherein the coils occupy the full area of the substrate. The antenna coil 4, which has the largest diameter among the coils, encloses the second coil 12, the first coil 3, and the capacitive element 15. The capacitive element 15 is formed by the extended wire ends of the second coil 12, creating an integral resonance circuit with the coil. All components, including the first coil 3, the antenna coil 4, the second coil 12, and the capacitive element 15, are embedded into the antenna substrate 5 using a constant downward force. This embedding process involves ultrasonic vibration, which securely lays the wire within the substrate without the need for additional conductive foil, laser ablation, or etching.

The antenna coil 4, the first coil 3, and the second coil 12 are formed from a single continuous wire, ensuring uniform winding direction and eliminating the need for welding or soldering between wire sections. The uniformity of the wire simplifies manufacturing and ensures reliable electrical connections.

FIG. 24 presents a smart card 1 with a half-size antenna coil 4. This configuration is depicted in a top view, showing the antenna coil 4 along with the first coil 3, the second coil 12, and the capacitive element 15 embedded in the antenna substrate 5. The half-size antenna coil 4 has dimensions of approximately 80 mm by 26 mm. In this design, the second coil 12 is enclosed within the third interior space defined by the antenna coil 4, while the first coil 3 is located outside the area enclosed by the antenna coil 4. The antenna coil 4 is electrically connected to both the second coil 12 and the first coil 3.

To achieve a specific resonant frequency for reliable data transmission, the second coil 12 provides a resonance circuit by forming an LC network. The capacitive element 15, integrated into the second coil 12, enhances the tuning of the antenna coil 4. The reduced size of the antenna coil 4 requires precise adjustments to the number of wire turns in the first coil 3 and the second coil 12 to maintain efficient communication with the external reader 200.

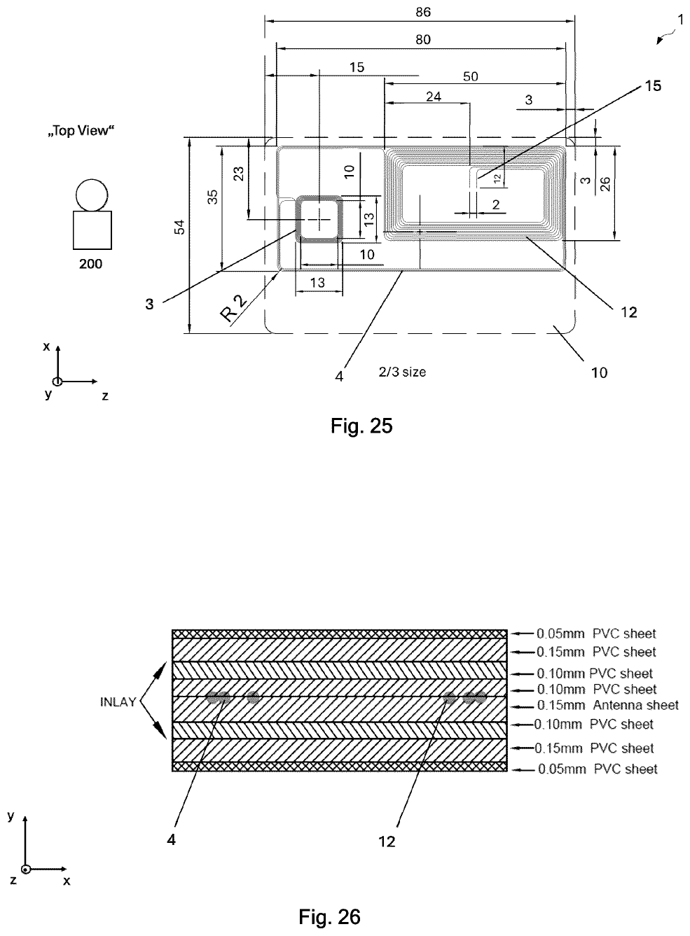

FIG. 25 illustrates a smart card 1 with a two-thirds (⅔) size antenna coil 4 in a top view. This antenna coil 4 has dimensions of approximately 80 mm by 35 mm, striking a balance between the ID1 size and half-size configurations. Testing with different chip types revealed optimized configurations for coupling the antenna coil 4 with the external reader 200. For a chip card with STM chip, the ideal configuration includes 9 turns for the first coil 3, 11 turns for the second coil 12, and 3 turns for the antenna coil 4. For a chip card with NXP chip, the first coil 3 comprises 10 turns, the second coil 12 has 7 turns, and the antenna coil 4 has 5 turns.

The two-thirds size antenna coil 4 enhances the coupling efficiency with the external reader 200's antenna. This design can reduce the number of wire turns in the antenna coil 4 to accommodate features such as embossing on banking cards. Reducing the number of turns decreases the capacitance of the antenna coil 4, necessitating adjustments to the inner coils to achieve a target resonant frequency, such as 13.77 MHz for the NXP chip. Both the first coil 3 and the second coil 12 are located within the third interior space defined by the antenna coil 4, with the first and second surface areas remaining distinct from one another.

FIG. 26 shows a cross-sectional view of a smart card 1, illustrating the arrangement and thickness of its various layers. The smart card I comprises multiple layers, including PVC sheets and an antenna sheet, which are bonded together to form a compact and functional structure. The layers are arranged symmetrically around an inlay, ensuring consistent thickness and alignment.

The inlay contains the antenna sheet, which incorporates the antenna coil 4 and the second coil 12. These coils are embedded directly into the antenna substrate 5 during manufacturing. The embedding process involves laying the coils within the antenna substrate 5 using constant downward force and ultrasonic vibration. This method eliminates the need for conductive foil, laser ablation, or etching. The antenna coil 4 and the second coil 12 are designed to form part of a closed-loop antenna system, facilitating reliable signal transmission with the external reader 200.

The layers of the smart card I include the antenna sheet with a thickness of 0.15 mm and multiple PVC sheets that provide structural support and protection. The PVC sheets are layered above and below the antenna sheet, with each PVC sheet having specific thicknesses. The layers include two outermost PVC sheets with a thickness of 0.05 mm each, two inner PVC sheets with a thickness of 0.15 mm each, and two additional inner PVC sheets with a thickness of 0.10 mm each. Together, these layers form the card substrates 10, which enclose the antenna substrate 5.

The smart card 1 does not contain any layer made entirely of metal, and the total metal composition does not exceed 40% of the card's overall weight. This ensures compatibility with external readers 200 and maintains the flexibility and durability of the card. All layers arc permanently bonded through lamination, creating a unified structure that ensures reliability during usage. The dimensions and materials used in the construction of the smart card 1 contribute to its robustness and functionality while meeting industry standards for contactless communication.

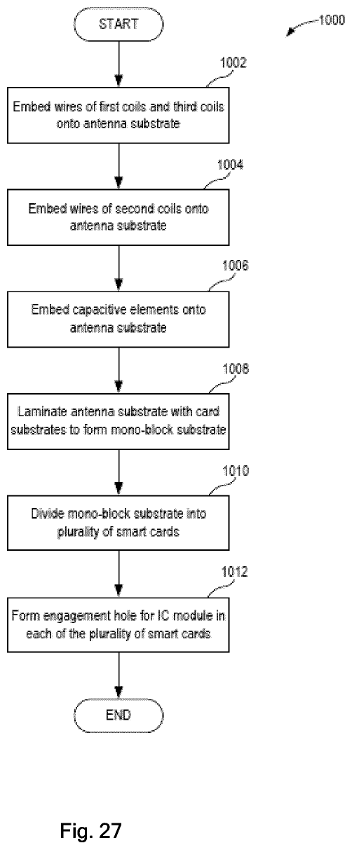

FIG. 27 shows a flowchart illustrating a method 1000 for forming a smart card 1. The smart card 1 as described herein may be the smart card 1 described with respect to FIGS. 1-9. In some examples, the smart card 1 may have coils with a first size configuration, as shown in FIG. 2, a second size configuration, as shown in FIG. 3, or a third size configuration, as shown in FIG. 4.

At 1002, method 1000 includes embedding wires of first coils 3 and third coils 4 onto an antenna substrate 5. As described with respect to FIG. 9, the antenna substrate 5 may be formed as part of a sheet 34 that comprises multiple sections, each section corresponding to a smart card 1. Each first coil 3 may be a coupler coil and may comprise turns of wire that define a perimeter of a first surface area of the smart card 1, thereby defining a first interior space within the first surface area surrounded by the wire of the first coil 3. Similarly each third coil 4 may be an antenna coil and may comprise turns of wire that define a perimeter of a third surface area, thereby defining a third interior space within the third surface area surrounded by the wire of the third coil 4.

At 1004, method 1000 includes embedding wires of second coils 12 onto the antenna substrate 5. The second coils 12 may be separate from both the first 3 and third coils 4 in each respective card 1. The second coil 12 may have turns of wire defining a perimeter of a second surface area, thereby defining a second interior space within the second surface area surrounded by the wire of the second coil 12. The first 3 and/or second coils 12 may be embedded onto the antenna substrate 5 within the third interior space of the respective third coil 4, in some examples. For example, in the first and third size configurations of the second 12 and third coils 4, the first 3 and second coils 12 may be positioned within the interior space of the third coil 4. In other examples, such as in the second size configuration of the second 12 and third coils 4, the second coil 12 may be positioned within the interior space of the third coil 4 while the first coil 3 may be positioned outside the interior space of the third coil 4. Thus, the third surface area may be larger than the first and second surface areas and in some examples, the third surface area may include the first and/or second surface areas.

The first 3, second 12, and third coils 4 of each of the smart cards I may be embedded in the antenna substrate 5 via constant downward force and/or ultrasonic vibration. Thus, the coils may be embedded into the non-metallic substrate (e.g., the antenna substrate 5) without variable downward force or use of conductive foil, a conductive layer, laser ablation, or etching. Avoiding the use of laser ablation or etching also reduces the environmental impact of the manufacturing process, as it eliminates the need for chemicals and reduces energy consumption. Some materials may be sensitive to the high temperatures and physical stresses induced by laser ablation or etching. Using a method that excludes these techniques can allow for a broader range of materials to be used effectively, potentially enhancing the functionality and durability of the smart cards.

At 1006, method 1000 comprises embedding capacitive elements 15 onto the antenna substrate 5 for each of the smart cards 1. In some examples, the capacitive element 15 may be configured as an extension of the second coil 12. The second coil 12 and the capacitive element 15 together may form an LC network. The capacitive elements 15 may similarly be embedded via ultrasonic vibration and/or constant downward force.

At 1008, method 1000 comprises laminating the antenna substrate 5 with card substrates 10 to form a mono-block substrate. As is described above, multiple card substrates 10 may be disposed about the antenna substrate 5 as layers of the smart card 1. The antenna substrate 5, when configured as a sheet 34 with a plurality of sections each intended for a corresponding smart card 1 of a plurality of smart cards 1, may be laminated with the card substrate 10 layers. Lamination of the layers may thus form the mono-block substrate. The mono-block substrate may also be a sheet with a plurality of sections corresponding to the plurality of smart cards 1.

At 1010, method 1000 includes dividing the mono-block substrate into the plurality of smart cards 1. As described with respect to FIG. 9, the plurality of sections of the sheet may be divided via cutting (e.g., via a laser) in order to separate the plurality of sections from one another.

At 1012, method 1000 includes forming an engagement hole 11, 20 for an IC module 2 in each of the plurality of smart cards 1. As is described above, the IC module 2 may comprise an IC module coil 8, a microchip 6, and a module substrate 9 with electrodes 25. The module substrate 9 may be cladded with copper foil 23 and the electrodes 25 and the IC module coil 8 may be formed on different surfaces of the substrate module 9 by etching the copper cladded module substrate. The microchip 6 may be connected to the IC module coil 8 by wire bonding. The IC module 2 may be attached to the engagement hole 11, 20 that is formed through the smart card 1.

The above embodiments in the application can also be described using the following Itemized lists.

The first itemized list refers to the aspect relating to the embedding of coils in an antenna substrate. The items of the first itemized list can be combined with one or more items of all other itemized lists in this document as well as with one or more features of the claims.

### First Itemized List:

1. A method of wire embedding for a smart card, the method comprising:
   applying wire of a first coil and a third coil to an antenna substrate of the smart card so as to embed the wire of the first and third coils onto the antenna substrate using a constant downward force throughout the laying and embedding of the two coils,
   the first coil having turns of wire defining a perimeter of a first surface area of the smart card and defining a first interior space within the first surface area surrounded by turns of wire of the first coil,
   the third coil having turns of wire defining a perimeter of a third surface area of the smart card and defining a third interior space within the third surface area surrounded by turns of the third coil.
2. The method according to item 1, the method further comprising:
   applying wire of a second coil to the antenna substrate of the smart card so as to embed the wire of the second coil onto the antenna substrate using a constant downward force throughout the laying and embedding of the second coil,
   the second coil having turns of wire defining a perimeter of a second surface area of the smart card and defining a second interior space within in the second surface area surrounded by turns of wire of the second coil.
3. The method according to item 2, wherein applying wire of the first, second, and third coils includes ultrasonic vibration along with the constant downward force for embedding the wire into the antenna substrate.
4. The method according to item 2 or item 3, wherein the second coil is arranged within the third interior space.
5. The method according to any of the preceding items 2-4, wherein the second coil is separate from the first coil.
6. The method according to any of the preceding items 2-5, wherein the second coil is separate from the third coil, the third coil being larger in diameter than the first and second coils.
7. The method according to any of the preceding items 2-6, wherein the third surface area is larger than the first and second surface areas.
8. The method according to any of the preceding items 2-7, wherein the third surface area includes the first and second surface areas.
9. The method according to any of the preceding items 2-8, wherein the first and second surface areas do not overlap one another.
10. The method according to any of the preceding items, wherein the antenna substrate comprises a PVC or PC or PET or PETG substrate.
11. The method according to any of the preceding items, wherein the antenna substrate is formed by lamination of layers into a monoblock substrate without use of adhesives.
12. The method according to any of the preceding items, wherein the antenna substrate is provided in a sheet, wherein the sheet is divided into a plurality of sections, each of which is intended for a corresponding smart card.
13. The method according to any of the preceding items, the method further comprising:
   applying wire of a capacitive element to the antenna substrate of the smart card so as to embed the wire of the capacitive element onto the antenna substrate using a constant downward force throughout the laying and embedding of the capacitive element.
14. A method for manufacturing a smart card comprising:
   a method according to any of the preceding items, and
   collating the antenna substrate with at least one card substrate by means of lamination, using heat and pressure.
15. The method according to item 14, wherein the antenna substrate is arranged between two compensation layers and form an inlay, before being laminated with the at least one card substrate.
16. The method according to item 14 or item 15, wherein the card substrate comprises a printed layer, a PVC layer or an overlay layer, wherein the card substrate can also comprise a combination of a printed layer, PVC layer and/or an overlay layer.
17. The method according to items 14-16, wherein the antenna substrate and/or the inlay and the card substrate are provided in sheets which are divided into a plurality of sections each of which is intended for a corresponding smart card, wherein the plurality of sections are cut or punched out to form plurality of smart cards.
18. The method according to items 14-17, wherein an engagement hole for an IC module is formed in the card substrate indented for each smart card by way of milling.
19. The method according to item 18, wherein the IC module comprises an IC module coil, a microchip, a module substrate and electrodes,
   wherein the module substrate is cladded with a copper foil, and
   wherein the electrodes and the IC module coil are formed on different surfaces of the substrate module by etching the copper cladded module substrate, and
   wherein the microchip is connected to the IC module coil by wire bonding, and the substrate module comprises through holes filled with conductive material which serve as a connection between the microchip and the electrodes.
20. The method according to item 18 or 19, wherein the IC module is attached to the engagement hole.
21. The method according to item 20, wherein the IC module is glued into the engagement hole by a laminating method and a hot-melt adhesive filling method.
22 The method according to items 19-21, wherein the wire bonding and/or the microchip are encapsuled by glob-top or dam-and-fill material.
23. The method according to any of the preceding items 14-22, wherein the smart card is personalized by way of embossing or by laser engraving.
24. A method for wire embedding for a smart card, the method comprising:
   embedding wires of a first coil and a third coil onto an antenna substrate of the smart card using a constant downward force, wherein the first coil has turns of wire defining a first interior space within a first surface area and the third coil has turns of wire defining a third interior space within a third surface area.
25. The method according to item 24, further comprising, embedding a wire of a second coil to the antenna substrate using constant downward force, wherein the second coil has turns defining a second interior space within a second surface area.
26. The method according to item 25, wherein embedding the first, second, and third coils (3, 4, 12) comprises applying ultrasonic vibration along with the constant downward force.
27. The method according to item 25, wherein the second coil (12) is arranged within the third interior space, wherein the third coil (4) is larger in diameter than the first and second coils (3, 12).
28. The method according to any of the preceding items 24-27, further comprising laminating the antenna substrate with a plurality of card substrates to form a mono-block substrate, wherein laminating does not include use of adhesives.
29. The method according to any of the preceding items 24-28, wherein the first coil is a coupler coil, the third coil is an antenna coil, and the second coil is a passive component.
30. The method according to any of the preceding items 24-29, wherein the antenna substrate is provided in a sheet divided into a plurality of sections, wherein each of the plurality of sections is intended for a corresponding smart card.
31. The method according to any of the preceding items 24-30, further comprising embedding wire of a capacitive element to the antenna substrate using constant downward force.

The second itemized list refers to the aspect relating to the metal composition in the smart card. The items of the second itemized list can be combined with one or more items of all other itemized lists in this document as well as with one or more features of the claims.

### Second Itemized List:

1. A smart card comprising:
   a first coil having turns of wire defining a perimeter of a first surface area of the smart card and defining a first interior space within the first surface area surrounded by turns of wire of the first coil; and
   a second coil having turns of wire defining a perimeter of a second surface area of the smart card and defining a second interior space within the second surface area surrounded by turns of wire of the second coil; and
   a third coil having turns of wire defining a perimeter of a third surface area of the smart card and defining a third interior space within the third surface area surrounded by turns of wire of the third coil; and
   a non-metallic substrate of the smart card into which the first, second, and third coils are arranged, the non-metallic substrate being free from conductive or metallic foil or conductive or metallic layers such that a metal composition of the smart card is less than 40% by weight.
2. The smart card according to item 1, wherein the first, second, and third coils are laid into the non-metallic card substrate without use of laser ablation or etching.
3. The smart card according to any of the preceding items, wherein the second coil is arranged within the third interior space.
4. The smart card according to any of the preceding items, wherein the second coil is separate from the first coil.
5. The smart card according to any of the preceding items, wherein the second coil is separate from the third coil, the third coil being larger in diameter than the first and second coils.
6. The smart card according to any of the preceding items, wherein the third surface area is larger than the first and second surface areas.
7. The smart card according to any of the preceding items, wherein the third surface area includes the first and second surface areas.
8. The smart card according to any of the preceding items, wherein the first and second surface areas do not overlap one another.
9. The smart card according to any of the preceding items, wherein the second coil is configured as a passive, non-radiating component of an LC network for matching the third coil with an external reader antenna.
10. The smart card according to item 9, comprising a microchip and a capacitive element, wherein the second coil and the capacitive element form the LC network, and wherein the IC module coil is connected to the microchip.
11. The smart card according to item 10, wherein an IC module comprises the IC module coil, the microchip, a module substrate and electrodes,
   wherein the module substrate is cladded with a copper foil, and
   wherein the electrodes and the IC module coil are formed on different surfaces of the substrate module by etching the copper cladded module substrate, and
   wherein the microchip is connected to the IC module coil by wire bonding, and the substrate module comprises through holes filled with conductive material which serve as a connection between the microchip and the electrodes.

The third itemized list refers to the aspect relating of the first and third coils formed from a single piece of wire. The items of the third itemized list can be combined with one or more items of all other itemized lists in this document as well as with one or more features of the claims.

### Third Itemized List:

1. A smart card comprising:
   a first coil having turns of wire defining a perimeter of a first surface area of the smart card and defining a first interior space within the first surface area surrounded by turns of wire of the first coil;
   a third coil having turns of wire defining a perimeter of a third surface area of the smart card and defining a third interior space within the third surface area surrounded by turns of wire of the third coil, the first and third coils made from a single piece of wire, and the single piece of wire having a winding direction that is the same for both the first and third coils.
2. The smart card according to item 1, comprising a second coil having turns of wire defining a perimeter of a second surface area of the smart card and defining a second interior space within the second surface area surrounded by turns of wire of the second coil.
3. The smart card according to item 2, wherein the second coil is arranged within the third interior space.
4. The smart card according to item 2 or 3, wherein the second coil is separate from the first coil.
5. The smart card according to any of the preceding items 2-4, wherein the second coil is separate from the third coil, the third coil being larger in diameter than the first and second coils.
6. The smart card according to any of the preceding items 2-5, wherein the third surface area is larger than the first and second surface areas.
7. The smart card according to any of the preceding items 2-6, wherein the third surface area includes the first and second surface areas.
8. The smart card according to any of the preceding items 2-7, wherein the first and second surface areas do not overlap one another.
9. The smart card according to any of the preceding items 2-8, wherein the smart card comprises a plurality of layers, and wherein the first coil, the second coil and the third coil are formed on a same layer of the smart card.
10. The smart card according to any of the preceding items 2-9, comprising a microchip, an IC module coil and a capacitive element,
   wherein the second coil and the capacitive element form a LC-network, and
   wherein the third coil is connected to the first coil and to the second coil, and
   wherein the IC module coil is connected to the microchip, and
   wherein the first coil is arranged with respect to the IC module coil such that a magnetic field generated by the first coil can induce a current in the IC module coil.
11. A method for manufacturing a smart card, the method comprising:
   Forming a first coil having turns of wire defining a perimeter of a first surface area of the smart card and defining a first interior space within the first surface area surrounded by turns of wire of the first coil;
   Forming a third coil having turns of wire defining a perimeter of a third surface area of the smart card and defining a third interior space within the third surface area surrounded by turns of wire of the third coil, wherein the first and third coils are made from a single piece of wire, and the single piece of wire has a winding direction that is the same for both the first and third coils.
12. The method according to item 11, further comprising forming a second coil having turns of wire defining a perimeter of a second surface area of the smart card and defining a second interior space within the second surface area surrounded by turns of wire of the second coil, wherein the second coil is also made from the same single piece of wire.
13. The method according to item 12, wherein the second coil is formed within the third interior space defined by the third coil.
14. The method according to item 12 or item 13, further comprising embedding the first coil, the second coil, and the third coil on the same layer within the smart card.

The fourth itemized list refers to the aspect relating of the second and third coils formed from a single piece of wire. The items of the fourth itemized list can be combined with one or more items of all other itemized lists in this document as well as with one or more features of the claims.

### Fourth Itemized List:

1. A smart card comprising:
   a second coil having turns of wire defining a perimeter of a second surface area of the smart card and defining a second interior space within the second surface area surrounded by turns of wire of the second coil, and
   a third coil having turns of wire defining a perimeter of a third surface area of the smart card and defining a third interior space within the third surface area surrounded by turns of wire of the third coil, the second and third coils made from a single piece of wire, and the single piece of wire having a winding direction that is the same for both the second and third coils, and
   wherein the second coil is configured as a passive, non-radiating component of an LC network for matching the third coil with an external reader antenna.
2. The smart card according to item 1, further comprising a first coil having turns of wire defining a perimeter of a first surface area of the smart card and defining a first interior space within the first surface area surrounded by turns of wire of the first coil.
3. The smart card according to item 1 or 2, wherein the second coil is arranged within the third interior space.
4. The smart card according to item 2, wherein the second coil is separate from the first coil.
5. The smart card according to item 2 or item 4, wherein the second coil is separate from the third coil, the third coil being larger in diameter than the first and second coils.
6. The smart card according to item 2 or items 4-5, wherein the third surface area is larger than the first and second surface areas.
7. The smart card according to item 2 or items 4-6, wherein the third surface area includes the first and second surface areas.
8. The smart card according to item 2 or items 4-7, wherein the first and second surface areas do not overlap one another.
9. The smart card according to item 2 or items 4-8, wherein the smart card comprises a plurality of layers, and wherein the first coil, the second coil and the third coil are formed on a same layer of the smart card.
10. The smart card according to item 2 or items 4-9, comprising a microchip, a IC module coil and a capacitive element,
   wherein the second coil and the capacitive element form a LC-network, and
   wherein the third coil is connected to the first coil and to the second coil, and
   wherein the IC module coil is connected to the microchip, and
   wherein the first coil is arranged with respect to the IC module coil such that a magnetic field generated by the first coil can induce a current in the IC module coil.
11. A method for manufacturing a smart card, the method comprising:
   Forming a second coil with turns of wire that define a perimeter of a second surface area of the smart card and a second interior space within the second surface area,
   Forming a third coil with turns of wire that define a perimeter of a third surface area of the smart card and a third interior space within the third surface area, and
   wherein the second and third coils are made from a single piece of wire, and the single piece of wire maintains the same winding direction for both coils, and
   wherein the second coil is configured as a passive, non-radiating component of an LC network for matching the third coil with an external reader antenna.
12 The method according to item 11, further comprising forming a first coil with turns of wire that define a perimeter of a first surface area of the smart card and a first interior space within the first surface area.
13. The method according to item 11 or item 12, wherein the second coil is formed within the third interior space defined by the third coil.
14. The method according to item 12 or item 13, further comprising embedding the first coil, the second coil, and the third coil on the same layer within the smart card.

The fifth itemized list refers to the aspect relating of the first, second, and third coils having the same winding direction formed from a single piece of wire. The items of the fifth itemized list can be combined with one or more items of all other itemized lists in this document as well as with one or more features of the claims.

### Fifth Itemized List:

1. A smart card comprising:
   a first coil having turns of wire defining a perimeter of a first surface area of the smart card and defining a first interior space within the first surface area surrounded by turns of wire of the first coil, and
   a second coil having turns of wire defining a perimeter of a second surface area of the smart card and defining a second interior space within the second surface area surrounded by turns of wire of the second coil, and
   a third coil having turns of wire defining a perimeter of a third surface area of the smart card and defining a third interior space within the third surface area surrounded by turns of wire of the third coil, the first, second, and third coils made from a single piece of wire, and the single piece of wire having a winding direction that is the same for all three of coils.
2. The smart card according to item 1, wherein the second coil is arranged within the third interior space.
3. The smart card according to item 1 or item 2, wherein the second coil is separate from the first coil.
4. The smart card according to any of the preceding items, wherein the second coil is separate from the third coil, the third coil being larger in diameter than the first and second coils.
5. The smart card according to any of the preceding items, wherein the third surface area is larger than the first and second surface areas.
6. The smart card according to any of the preceding items, wherein the third surface area includes the first and second surface areas.
7. The smart card according to any of the preceding items, wherein the first and second surface areas do not overlap one another.
9. The smart card according to any of the preceding items, wherein the smart card comprises a plurality of layers, and wherein the first coil, the second coil and the third coil are formed on a same layer of the smart card.
10. The smart card according to any of the preceding items, comprising a microchip, an IC module coil and a capacitive element,
   wherein the second coil and the capacitive element form a LC-network, and
   wherein the third coil is connected to the first coil and to the second coil, and
   wherein the IC module coil is connected to the microchip, and
   wherein the first coil is arranged with respect to the IC module coil such that a magnetic field generated by the first coil can induce a current in the IC module coil.
11. A method for manufacturing a smart card, comprising the steps of:
   Forming a first coil with turns of wire that define a perimeter of a first surface area of the smart card and a first interior space within the first surface area, and
   Forming a second coil with turns of wire that define a perimeter of a second surface area of the smart card and a second interior space within the second surface area, and
   Forming a third coil with turns of wire that define a perimeter of a third surface area of the smart card and a third interior space within the third surface area, and
   Using a single piece of wire to form the first, second, and third coils, and maintaining the same winding direction for all three coils.

The sixth itemized list refers to the aspect relating of the first, second, and third coils formed from a single piece of wire including no welds or soldering joints. The items of the sixth itemized list can be combined with one or more items of all other itemized lists in this document as well as with one or more features of the claims.

### Sixth Itemized List:

1. A smart card comprising:
   a first coil having turns of wire defining a perimeter of a first surface area of the smart card and defining a first interior space within the first surface area surrounded by turns of wire of the first coil, and
   a second coil having turns of wire defining a perimeter of a second surface area of the smart card and defining a second interior space within the second surface area surrounded by turns of wire of the second coil, and
   a third coil having turns of wire defining a perimeter of a third surface area of the smart card and defining a third interior space within the third surface area surrounded by turns of wire of the third coil, the first, second, and third coils made from a single piece of wire, and the single piece of wire including no welds or soldering joints for connecting portions of the single piece of wire.
2. The smart card according to item 1, wherein the second coil is arranged within the third interior space.
3. The smart card according to item 1 or item 2, wherein the second coil is separate from the first coil.
4. The smart card according to any of the items 1-3, wherein the second coil is separate from the third coil, the third coil being larger in diameter than the first and second coils.
5. The smart card according to any of the items 1-4, wherein the third surface area is larger than the first and second surface areas.
6. The smart card according to any of the items 1-5, wherein the third surface area includes the first and second surface areas.
7. The smart card according to any of the items 1-6, wherein the first and second surface areas do not overlap one another.
8. The smart card according to any of the preceding items, wherein the smart card comprises a plurality of layers, and wherein the first coil, the second coil and the third coil are formed on a same layer of the smart card.
9. The smart card according to any of the preceding items, comprising a microchip, an IC module coil and a capacitive element,
   wherein the second coil and the capacitive element form a LC-network, and
   wherein the third coil is connected to the first coil and to the second coil, and
   wherein the IC module coil is connected to the microchip, and
   wherein the first coil is arranged with respect to the IC module coil such that a magnetic field generated by the first coil can induce a current in the IC module coil.
10. A method for manufacturing a smart card, comprising the steps of:
   Providing a single piece of wire, wherein the single piece of wire includes no welds or soldering joints,
   Forming a first coil by winding the single piece of wire to define a perimeter of a first surface area of the smart card, and creating a first interior space within the first surface area surrounded by turns of wire of the first coil,
   Forming a second coil by continuing to wind the single piece of wire to define a perimeter of a second surface area of the smart card, and creating a second interior space within the second surface area surrounded by turns of wire of the second coil,
   Forming a third coil by further winding the single piece of wire to define a perimeter of a third surface area of the smart card, and creating a third interior space within the third surface area surrounded by turns of wire of the third coil.

The seventh itemized list refers to the aspect relating of the capacitive element. The items of the seventh itemized list can be combined with one or more items of all other itemized lists in this document as well as with one or more features of the claims.

### Seventh Itemized List:

1. A smart card comprising:
   a first coil having turns of wire defining a perimeter of a first surface area of the smart card and defining a first interior space within the first surface area surrounded by turns of wire of the first coil, and
   a second coil having turns of wire defining a perimeter of a second surface area of the smart card and defining a second interior space within the second surface area surrounded by turns of wire of the second coil, and
   a third coil having turns of wire defining a perimeter of a third surface area of the smart card and defining a third interior space within the third surface area surrounded by turns of wire of the third coil, and
   a capacitive element comprising the second coil and/or a pair of conductors arranged at an end of the second coil.
2. The smart card according to item 1, wherein the second coil is arranged within the third interior space.
3. The smart card according to item 1 or item 2, wherein the second coil is separate from the first coil, the first coil configured to couple to an IC module coil.
4. The smart card according to any of the preceding items, wherein the second coil is separate from the third coil, the third coil being larger in diameter than the first and second coils.
5. The smart card according to any of the preceding items, wherein the third surface area is larger than the first and second surface areas.
6. The smart card according to any of the preceding items, wherein the third surface area includes the first and second surface areas.
7. The smart card according to any of the preceding items, wherein the first and second surface areas do not overlap one another.
8. The smart card according to any of the preceding items, wherein the smart card is free from a capacitor component having electrodes associated therewith.
10. The smart card according to any of the preceding items, comprising a microchip and an IC module coil,
   wherein the second coil and the capacitive element form a LC-network, and
   wherein the third coil is connected to the first coil and to the second coil, and
   wherein the IC module coil is connected to the microchip, and
   wherein the first coil is arranged with respect to the IC module coil such that a magnetic field generated by the first coil can induce a current in the IC module coil.

The eighth itemized list refers to the aspect relating of the first, second, and third coil are arranged on the same plane. The items of the eighth itemized list can be combined with one or more items of all other itemized lists in this document as well as with one or more features of the claims.

### Eighth Itemized List:

1. A smart card comprising:
   a first coil having turns of wire defining a perimeter of a first surface area of the smart card and defining a first interior space within the first surface area surrounded by turns of wire of the first coil, and
   a second coil having turns of wire defining a perimeter of a second surface area of the smart card and defining a second interior space within the second surface area surrounded by turns of wire of the second coil, and
   a third coil having turns of wire defining a perimeter of a third surface area of the smart card and defining a third interior space within the third surface area surrounded by turns of wire of the third coil, and
   an antenna substrate, the antenna substrate having a first plane in which the first, second, and third coils are arranged.
2. The smart card according to item 1, wherein turns of the first, second, and third coils are co-planar with one another.
3. The smart card according to item 1 or item 2, further comprising a capacitive element, wherein the capacitive element is connected to the second coil forming a LC-network, and wherein the capacitive element is arranged on the same plane as the first, second, and third coil.
4. The smart card according to any of the preceding items, further comprising an IC module coil connected to a microchip, wherein the IC module coil is arranged on a second plane.
5. The smart card according to any of the preceding items, comprising an IC module having a module substrate with a second plane.
6. The smart card according to item 5 comprising a card substrate with an engagement hole accommodating the IC module.
7. The smart card according to any of the preceding items 4-6, wherein the second plane is parallel to the first plane.
8. The smart card according to any of the preceding items 4-7, wherein the IC module coil and the first coil at least partially overlap.
9. The smart card according to any of the preceding items 4-8, wherein the center of the IC module coil and the first coil are superimposed.
10. The smart card according to any of the preceding items, wherein the first, second, and third coils are arranged in the first plane such that all three antenna structures comprising the first, second, and third coils are formed on the first plane with only short distances where wire crosses over another wire or where wire bridges from the first, second, or third interior space to an outer diameter of the first, second, or third coil.
11. The smart card according to any of the preceding items, wherein the second coil is arranged within the third interior space.
12. The smart card according to any of the preceding items, wherein the second coil is separate from the first coil.
13. The smart card according to any of the preceding items, wherein the second coil is separate from the third coil, the third coil being larger in diameter than the first and second coils.
14. The smart card according to any of the preceding items, wherein the third surface area is larger than the first and second surface areas.
15. The smart card according to any of the preceding items, wherein the third surface area includes the first and second surface areas.
16. The smart card according to any of the preceding items, wherein the first and second surface areas do not overlap one another.
17. The smart card according to any of the preceding items, wherein the antenna substrate is arranged between two compensation layers forming an inlay.
18. The smart card according to any of the preceding items, comprising a card substrate,
   wherein the card substrate can be formed as a printed layer, a PVC layer or an overlay layer, and
   wherein the card substrate can also be a combination of a printed layer, PVC layer and/or an overlay layer.
19. The smart card according to item 18, wherein the antenna substrate bonded to at least one card substrate by means of lamination, using heat and pressure.
20. The smart card according to any of the preceding items, wherein the antenna substrate comprises a PVC or PC or PET or PETG substrate.

The nineth itemized list refers to the aspect relating of the modified properties of the second coil. The items of the nineth itemized list can be combined with one or more items of all other itemized lists in this document as well as with one or more features of the claims.

### Nineth Itemized List:

1. A smart card comprising:
   a first coil having turns of wire defining a perimeter of a first surface area of the smart card and defining a first interior space within the first surface area surrounded by turns of wire of the first coil, and
   a second coil having turns of wire defining a perimeter of a second surface area of the smart card and defining a second interior space within the second surface area surrounded by turns of wire of the second coil, and
   a third coil having turns of wire defining a perimeter of a third surface area of the smart card and defining a third interior space within the third surface area surrounded by turns of wire of the third coil,
   the second coil arranged to include additional turns of wire and/or configured to use wire of greater width so as to increase a surface area occupied by the second coil turns of wire, or
   the second coil arranged to include additional turns of wire and/or configured to use heavier materials so as to increase a weight of the smart card, or
   the second coil arranged to include additional turns of wire and/or configured to use materials with visually distinguishable color so as to increase a visibility of the smart card.
2. The smart card according to item 1, wherein the second coil is arranged within the third interior space.
3. The smart card according to item 1 or item 2, wherein the second coil is separate from the first coil, the first coil configured to couple to an IC module coil.
4. The smart card according to any of the preceding items, wherein the second coil is separate from the third coil, the third coil being larger in diameter than the first and second coils.
5. The smart according to any of the preceding items, wherein the third surface area is larger than the first and second surface areas.
6. The smart card according to any of the preceding items, wherein the third surface area includes the first and second surface areas.
7. The smart card according to any of the preceding items, wherein the first and second surface areas do not overlap one another.
8. The smart card according to any of the preceding items, wherein the second coil comprises wire made of gold, steel, or silver.
9. The smart card according to any of the preceding items, comprising an antenna substrate with a first plane, wherein the first, the second and the third coil are arranged on the first plane, the third coil extending over 70% and 95% of the of the total size of the first plane.

The tenth itemized list refers to the aspect relating of electrically connecting the ends of the second and third coils. The items of the tenth itemized list can be combined with one or more items of all other itemized lists in this document as well as with one or more features of the claims.

### Tenth Itemized List:

1. A smart card comprising:
   a first coil having turns of wire defining a perimeter of a first surface area of the smart card and defining a first interior space within the first surface area surrounded by turns of wire of the first coil, and
   a second coil having turns of wire defining a perimeter of a second surface area of the smart card and defining a second interior space within the second surface area surrounded by turns of wire of the second coil, and
   a third coil having turns of wire defining a perimeter of a third surface area of the smart card and defining a third interior space within the third surface area surrounded by turns of wire of the third coil, an end of the third coil electrically interconnected with an end of the second coil, and the second coil positioned within the third interior space and encircled by windings of the third coil.
2. The smart card according to item 1, wherein the second coil is separate from the first coil, the first coil configured to couple to an IC module coil.
3. The smart card according to item 1 or item 2, wherein the second coil is separate from the third coil, the third coil being larger in diameter than the first and second coils.
4. The smart card according to any of the preceding items, wherein the third surface area is larger than the first and second surface areas.
5. The smart card according to any of the preceding items, wherein the third surface area includes the first and second surface areas.
6. The smart card according to any of the preceding items, wherein the first and second surface areas do not overlap one another.
7. The smart card according to any of the preceding items, wherein the second coil comprises wire made of gold, steel, or silver.
8. The smart card according to any of the preceding items, wherein the first coil is electrically connected to the third coil.

The eleventh itemized list refers to the aspect relating of the configuration of three coils for a smart card. The items of the eleventh itemized list can be combined with one or more items of all other itemized lists in this document as well as with one or more features of the claims.

### Eleventh Itemized List:

1. A smart card comprising:
   a first coil having turns defining a perimeter of a first surface area of the smart card and defining a first interior space within the first surface area surrounded by turns of the first coil, and
   a second coil having turns defining a perimeter of a second surface area of the smart card and defining a second interior space within the second surface area surrounded by turns of the second coil, and
   a third coil having turns defining a perimeter of a third surface area of the smart card and defining a third interior space within the third surface area surrounded by turns of the third coil, the second coil arranged within the third interior space and configured as a passive, non-radiating component of an LC network for matching the third coil with an external reader antenna.
2. The smart card according to item 1, wherein the second coil is separate from the first coil, the first coil configured to couple to an IC module coil.
3. The smart card according to item 1 or 2, wherein the second coil is separate from the third coil, the third coil being larger in diameter than the first and second coils.
4. The smart card according to any of the preceding items, wherein the third surface area is larger than the first and second surface areas.
5. The smart card according to any of the preceding items, wherein the third surface area includes the first and second surface areas.
6. The smart card according to any of the preceding items, wherein the first and second surface areas do not overlap one another.
7. The smart card according to any of the preceding items, wherein the second coil is configured as a non-energy capturing and non-energy absorbing component that is not involved with signal transmission between the smart card and the external reader.
8. The smart card according to any of the preceding items, wherein the second coil is configured so as to reduce or avoid being a load to a send coil of the external reader.
9. The smart card according to any of the preceding items, comprising a microchip and a capacitive element, wherein the second coil and the capacitive element form the LC network, and wherein the IC module coil is connected to the microchip.
10. The smart card according to item 9, wherein the capacitive element and the second coil are a structural unit, wherein the capacitive element is formed by two wire ends of the second coil.
11. The smart card according to item 9 or item 10, wherein the microchip is mounted on an IC module.
12. The smart card according to item 11, wherein the IC module comprises a module substrate having terminal electrodes serving as a contact-type transmission section, and wherein the IC module comprises the IC module coil which serves as a non-contact-type transmission section.
13. The smart card according to item 12, wherein the terminal electrodes and the IC module coil are formed on different surfaces by etching the double-sided cladded module substrate.
14. The smart card according to item 12 or item 13, wherein the microchip is connected to the terminal electrodes of the module substrate via through-holes that are filled with a conductive material.
15. The smart card according to any of the preceding items, wherein the first coil, the second coil and the third coil are connected in parallel to each other.
16. The smart card according to any of the preceding items, wherein the first coil, the second coil, the third coil comprise a wire having a thickness of 0.08 mm.
17. The smart card according to any of the preceding items, wherein the first coil, the second coil, the third coil are formed by winding insulation-coated conductor wires.
18. The smart card according to any of the preceding items, wherein the first coil, the second coil and the third coil have different pitches.
19. A system comprising a smart card according to any of the preceding items and an external reader, wherein the external reader is configured to emit a high-frequency magnetic field which can induce a current in the third coil.
20. A method for communication between a smart card according to any of the preceding items and an external reader with a transceiver coil, comprising the following method steps:
   emitting a high-frequency magnetic field from the transceiver coil, and
   providing the smart card in the high-frequency magnetic field so that a current is induced in the third coil.

The twelfth itemized list refers to the aspect relating to the dual-contact chipcard module comprising a via hole with conductive material. The items of the twelfth itemized list can be combined with one or more items of all other itemized lists in this document as well as with one or more features of the claims.

### Twelfth Itemized List:

1. Method of manufacturing a dual-contact chipcard module 2 with an RFID transmission antenna coil comprising a number of conductive antenna traces 60 and with a number of ISO contact pads 70, comprising
   providing a module substrate 9 with an antenna side 82 and a contact side 84,
   providing a bonding side conductive foil layer 87 to a bonding side 83 of an insulating substrate layer 94,
   providing a pre-determined pattern of conductive traces 60 and contact pads in the bonding side conductive foil layer 87,
   providing a via hole 26 in the bonding side conductive foil layer 87 and the insulating substrate layer 94,
   providing a contact side conductive foil layer 89 to the contact side 84 of the insulating substrate layer 94,
   etching a pre-determined pattern of conductive traces 60 and contact pads into the contact side conductive foil layer 89,
   providing conductive material 91 in the via hole 26, electrically connecting a section of the conductive traces 60 in the bonding side conductive foil layer 87 and a section of the contact side conductive foil layer 89, further comprising
   mounting a chip 6 above [on] the antenna side 82 of the module substrate 9,
   connecting a first pre-determined contact pad 42 of the chip 6 with an antenna contact pad surface area above the bonding side conductive foil layer 87 by providing a first antenna bonding wire 40,
   contacting a second pre-determined contact pad 43 of the chip 6 above a bonding side 83 surface of the ISO contact pads 70, by providing a bond wire through the bonding hole 90, and
   wherein the method provides the dual-contact chipcard module 2 such that the conductive material 91 in the via hole 26 electrically connects a section of the conductive traces 60 and one of the ISO standard contact pads C6, C4 or C8, and wherein the second pre-determined contact pad 43 of the chip 6 is connected above a bonding side 83 surface of the same ISO standard contact pads C6, C4 or C8.
2. Method of manufacturing a dual-contact chipcard module 2 according to item 1, wherein the conductive material 91 comprises conductive glue and wherein there is a step of curing the conductive glue after filling the via hole 26.
3. Method of manufacturing a dual-contact chipcard module 2 according to item 1 or item 2, with an encapsulating step of providing encapsulation material 80 over the chip 6 and the bond wires 41, 42 at the antenna side 82 of the module substrate 9.
4. Dual-contact chipcard module 2 with an RFID transmission antenna coil that comprises a number of conductive antenna traces 60 and with an ISO contact set 81 with a number of ISO contact pads 70, with
   a module substrate 9 with an antenna side 82 and a contact side 84,
   a bonding side conductive foil layer 87 at a bonding side 83 of an insulating substrate layer 94 which is part of the module substrate 9,
   the conductive traces 60 and contact pads being provided in the bonding side conductive foil layer 87,
   a via hole 26 in the bonding side conductive foil layer 87 and in the insulating substrate layer 94,
   a contact side conductive foil layer 89 at a contact side 84 of the insulating substrate layer 94 which corresponds to the contact side 84 of the module substrate 9, wherein the contact-side conductive foil layer 89 includes conductive traces 60 and contact pads,
   conductive material 91 in the via hole 26, electrically connecting a section of the conductive traces 60 in the bonding side conductive foil layer 87 and a section of the contact side conductive foil layer 89, further comprising
   a chip 6 above the antenna side 82 of the module substrate 9,
   a first pre-determined contact pad of the chip 6 [a first antenna chip pad 42] being connected with an antenna contact pad surface area above the bonding side conductive foil layer 87 by a first antenna bonding wire 40,
   a second pre-determined contact pad 43 of the chip 6 above a bonding side 83 surface of the ISO contact pads 70, with a bond wire in the bonding hole 90, and
   wherein the conductive material 91 in the via hole 26 electrically connects a section of the conductive traces 60 and one of the ISO standard contact pads C6, C4 or C8, and wherein the second pre-determined contact pad of the chip 6 is connected above a bonding side 83 surface of the same ISO standard contact pads C6, C4 or C8.
5. The dual-contact chipcard module 2 according to item 4, wherein ISO contact pads 70 formed on the contact side 84, wherein the ISO contact pads 70 are electrically connected to the chip 6 through bonding wires passing through bonding holes 90.
6. A smart card 1 comprising:
   a. a substrate 5, 10 supporting a dial-interface antenna system and a chipcard module 2 with an IC chip 6 and an IC module coil 8,
   b. the chipcard module 2 integrated into the antenna system, the antenna system comprising a first coil 3, an antenna coil 4 and a second coil 12, wherein the antenna system is configured to interface with external systems 200 for contactless and contact-based operations, the second coil comprises wire which comprise copper, gold, steel, or silver.
   c. wherein the chipcard module 2 comprises:
      a number of conductive traces 60, including those forming the IC module coil 8,
      an ISO contact set 81 with a number of ISO contact pads 70,
      a module substrate 9 having an antenna side 82 and a contact side 84,
      a bonding side conductive foil layer 87 at a bonding side 83 of an insulating substrate layer 94 which is part of the module substrate 9,
      the conductive traces 60 and contact pads being provided in the bonding side conductive foil layer 87,
      a via hole 26 in the bonding side conductive foil layer 87 and in the insulating substrate layer 94,
      a contact side conductive foil layer 89 at a contact side 84 of the insulating substrate layer 94 which corresponds to the contact side 84 of the module substrate 9, wherein the contact-side conductive foil layer 89 includes conductive traces 60 and contact pads,
      conductive material 91 in the via hole 26, electrically connecting a section of the conductive traces 60 in the bonding side conductive foil layer 87 and a section of the contact side conductive foil layer 89,
   d, wherein the IC chip 6 is located above the bonding side 83 of the module substrate 9,
      a first predetermined contact pad 42 of the IC chip 6 is connected to an antenna contact pad surface area above the bonding side conductive foil layer 87 by a first antenna bonding wire 40,
      a second predetermined contact pad 43 of the IC chip 6 is located above a bonding side 83 surface of the ISO contact pads 70 and is connected by a bond wire passing through a bonding hole 90,
      wherein the conductive material 91 in the via hole 26 electrically connects a section of the conductive traces 60 to one of the ISO standard contact pads C6, C4, or C8, and the second predetermined contact pad (43) of the IC chip (6) is connected above a bonding side 83 surface of the same ISO standard contact pad C6, C4, or C8.

The thirteenth itemized list refers to the dual-contact chipcard module comprising a bridge. The items of the thirteenth itemized list can be combined with one or more items of all other itemized lists in this document as well as with one or more features of the claims and any other embodiments described in the application.

### Thirteenth Itemized List:

1. A dual-contact chipcard module 2 with an RFID transmission antenna coil that comprises a number of conductive antenna traces 60 and with an ISO contact set 81 with a number of ISO contact pads 70 comprising:
   a module substrate 9 having an antenna side 82, a bonding side and a contact side 84, the module substrate 9 comprising an insulating substrate layer 94 disposed between a bonding side conductive foil layer 87 and a contact side conductive foil layer 89, wherein the bonding side conductive foil layer 87 and the contact side conductive foil layer 89 are adhered to the insulating substrate layer 94 by means of an adhesive layer 24;
   a chip 6 mounted on the bonding side 83 of the module substrate 9 using chip adhesive 92;
   a bridge 57 formed from a conductive material layer that connects the antenna side 82 to the bonding side 83, the bridge 57 being applied over an insulating layer 93 partially covering the conductive traces 60.
2. The dual-contact chipcard module 2 according to item 1, wherein the bridge 57 enables the chip 6 to be electrically connected to one end of the transmission antenna coil, which is located on the antenna side 82.
3. The dual-contact chipcard module 2 according to item 1 or item 2, wherein ISO contact pads 70 formed on the contact side 84, wherein the ISO contact pads 70 are electrically connected to the chip 6 through bonding wires passing through bonding holes 90.
4. he dual-contact chipcard module 2 according to any of the preceding items 1-3, wherein:
   the conductive material layer of the bridge 57 has a thickness between 10 and 15 micrometers;
   the insulating substrate layer 93 has a thickness between 3 and 5 micrometers and partially covers the antenna side 82 and the bonding side 83 to ensure connectivity through the bridge 57.
5. A method of manufacturing the dual-contact chipcard module 2 of any of the preceding items, comprising:
   Laminating the bonding side conductive foil layer 87 to the insulating substrate layer 93 using adhesive 24;
   Etching a pre-determined pattern of conductive traces 60, including the RFID transmission antenna coil and ISO contact pads 70, into the bonding side conductive foil layer 87;
   Applying an insulating material layer 93 with a thickness of 3 to 5 micrometers over the RFID transmission antenna coil and partially covering the antenna side 82 and the bonding side 83;
   Applying a conductive material layer with a thickness of 10 to 15 micrometers over the insulating material layer to form the bridge 57;
   Mounting the chip 6 onto the bonding side 83 using chip adhesive 92;
   Connecting bonding wires between the chip 6 and the ISO contact pads 70; and
   Encapsulating the chip 6 and bonding wires with an encapsulation material 80.
6. A smart card comprising a dual-contact chipcard module 2 of items 1-4, a first coil 3, a second coil 12, an antenna coil 4 embedded within an antenna substrate 5, and:
   An ID1 size antenna as shown in FIG. 23, wherein the antenna coil 4 surrounds the first coil 3 and the second coil 12 completely; or
   A half-size antenna as shown in FIG. 24, wherein the antenna coil 4 partially surrounds the second coil 12 while the first coil 3 remains outside the perimeter of the antenna coil 4; or
   A two-thirds size antenna as shown in FIG. 25, wherein the antenna coil 4 surrounds both the first coil 3 and the second coil 12 within its interior space.
7. The smart card of item 6, wherein the size of the antenna coil 4 is adjusted to optimize coupling efficiency with an external reader 200, and the number of wire turns in the antenna coil 4, first coil 3, and second coil 12 are modified to achieve a desired resonant frequency.
8. A multi-layer structure of a smart card 1 comprising:
   An inlay formed by an antenna sheet containing the antenna coil 4 and the second coil 12;
   PVC sheets layered above and below the antenna sheet to form card substrates 10;
   The antenna sheet having a thickness of 0.15 mm, and the PVC sheets including two outer layers of 0.05 mm thickness each, two inner layers of 0.15 mm thickness each, and two additional inner layers of 0.10 mm thickness each;
   All layers being permanently bonded together through lamination to form a unified smart card 1.
9. The smart card 1 of item 8, wherein the overall metal composition of the card does not exceed 40% of the smart card's total weight.
10. A smart card 1 comprising:
   a. a substrate 5, 10 supporting a dual-interface antenna system and a chipcard module 2 with an IC chip 6 and an IC module coil 8,
   b. the chipcard module 2 integrated into the antenna system, the antenna system comprising a first coil 3, an antenna coil 4 and a second coil 12, wherein the antenna system is configured to interface with external systems 200 for contactless and contact-based operations, the second coil comprises wire which comprise copper, gold, steel, or silver.
   c. wherein the chipcard module 2 comprises:
      a number of conductive traces 60, including those forming the IC module coil 8,
      a module substrate 9 having an antenna side 82, a bonding side 83 and a contact side 84, the module substrate 9 comprising an insulating substrate layer 94 disposed between a bonding side conductive foil layer 87 and a contact side conductive foil layer 89, wherein the bonding side conductive foil layer 87 and the contact side conductive foil layer 89 are adhered to the insulating substrate layer 94 by means of an adhesive layer 24;
      wherein the IC chip 6 is mounted on the bonding side 83 of a module substrate 9 using a chip adhesive 92;
      a bridge 57 formed from a conductive material layer, connecting the antenna side 82 to the bonding side 83, the bridge 57 being disposed over an insulating layer 93 that partially covers the conductive traces 60, such that the bridge 57 provides an electrical connection between the IC chip 6 and one end of the IC module coil 8, which is located on the antenna side 82.

The fourteenth itemized list refers to the smart card having coils with specific wire diameter, wire pitch, and number of turns. The items of the fourteenth itemized list can be combined with one or more items of all other itemized lists in this document as well as with one or more features of the claims and any other embodiments described in the application.

### Fourteenth Itemized List:

1. A smart card 1 comprising:
   a. a substrate 5, 10 supporting a dual-interface antenna system and a chipcard module 2 with an IC chip 6 and an IC module coil 8,
   b. the chipcard module 2 integrated into the antenna system, the antenna system comprising a first coil 3, an antenna coil 4 and a second coil 12, wherein the antenna system is configured to interface with external systems 200 for contactless and contact-based operations, wherein the antenna system is optimized for coupling efficiency and compliance with EMV standards,
   characterized in that
   c. the antenna coil 4, the first coil 3, and the second coil 12 have turns defining a perimeter enclosing a surface area, the surface area of the antenna coil 4 corresponding to ⅔ of the total surface area of the smart card 1, with a tolerance of ±10%,
   d. the wire diameter of the antenna coil 4, the first coil 3, and the second coil 12 is within the range of 0.08 mm to 0.15 mm,
   e. the wire pitch is generally uniform, with the second coil 12 having a pitch of 0.34 mm±10%,
   f. the number of turns is 8 to 11 in the first coil 3, 2 to 6 in the antenna coil 4, and 6 to 12 in the second coil 12.
2. The smart card 1 according to item 1, wherein the wire diameter, wire pitch, and number of turns in each of the antenna coil 4, the first coil 3, and the second coil 12 are variably adjusted to:
   tune the resonant frequency of the entire smart card 1 to 13.77 MHz±0.1 MHZ, thereby improving coupling efficiency with minimal delay, and
   ensure the Quality Factor is less than or equal to 40, limiting resonance efficiency to prevent chip overload.
3. The smart card 1 according to item 1 or item 2, wherein the surface area of the antenna coil 4 is formed in the dimensions 80 mm*35 mm with a tolerance of ±10%.
4. The smart card 1 according to any of the preceding items, wherein
the first coil 3 comprises a pitch of 0.2 mm+/−10% and the antenna coil 4 comprises a pitch of 0.4 mm+/−10%
5. The smart card 1 according to any of the preceding items, wherein the surface area enclosed by the antenna coil 4 encompasses the surface areas enclosed by the first coil 3 and the second coil 12, wherein the surface areas enclosed by the first coil 3 and the second coil 12 are non-overlapping.
6. The smart card 1 according to any of the preceding items, wherein the first coil 3 is operatively coupled to the IC module coil 8 which is connected to the chip 6.
7. The smart card 1 according to any of the preceding items, wherein the second coil 12 is configured as a passive, non-radiating component of an LC network for matching the antenna coil 4 with an external system 200.
8. The smart card 1 according to item 7, comprising a capacitive element 15, wherein the second coil 142 and the capacitive element 145 form the LC network.
9. The smart card 1 according to item 6, wherein the chip 6 comprises a NXP P71 EMV 6-pin icoM chip, enabling reduced timing delays and enhanced coupling for payment applications.
10. A smart card 1 comprising:
   a. a substrate 5, 10 supporting a dual-interface antenna system and a chipcard module 2 with an IC chip 6 and an IC module coil 8,
   b. the chipcard module 2 integrated into the antenna system, the antenna system comprising a first coil 3, an antenna coil 4 and a second coil 12,
   c. wherein the antenna system is configured to interface with external systems 200 for contactless and contact-based operations, optimized for integration with an STM ST31P45054APB1 icoM PAY 6-pin module,
   d. wherein the antenna system is characterized by:
      the wire diameter of the antenna coil 4, the first coil 3, and the second coil 12 is within the range of 0.06 mm-0.1 mm,
      the wire pitch is variable, with the first coil 3 having a pitch of 0.17 mm+/−10%, the second coil 12 having a pitch of 0.5 mm+/−10%, and the antenna coil 4 having a pitch of 0.3 mm+/−10%
      the number of turns is 8 to 10 in the first coil 3, 2 to 5 in the antenna coil 4, and 10 to 13 in the second coil 12.
11. The smart card 1 according to item 10, wherein the wire diameter, wire pitch, and number of turns in each of the antenna coil 4, the first coil 3, and the second coil 12 are variably adjusted to:
   tune the resonant frequency of the entire smart card 1 to 13.8 MHz+0.5 MHz, thereby improving coupling efficiency with minimal delay, and
      ensure the Quality Factor is stabilized to 34 to enhance compliance with EMV standards.
12. The smart card 1 according to item 10 or item 11, wherein the antenna system reduces response timing errors and ensures compliance with CA144 digital timing standards.
13. The smart card 1 according to any of the preceding items 10-12, wherein the antenna coil 4, the first coil 3, and the second coil 12 have turns defining a perimeter enclosing a surface area, and wherein the surface area enclosed by the antenna coil 4 encompasses the surface areas enclosed by the first coil 3 and the second coil 12, wherein the surface areas enclosed by the first coil 3 and the second coil 12 are non-overlapping.
14. The smart card 1 according to item 13, wherein the surface area of the antenna coil 4 corresponding to ⅔ of the total surface area of the smart card 1, with a tolerance of ±10%,
15. A method for manufacturing a smart card 1, comprising:
   a. designing a dual-interface antenna system as described in any of the preceding items;
   b. Integrating the antenna system with a chip 6 selected from NXP P71 EMV 6-pin or STM ST31P45054APB1 icoM PAY 6-pin;
   c. tuning the antenna system to achieve a resonant frequency of 13.8 MHz±0.5 MHz and a quality factor (Q) between 34 and 40;
   d. adjusting the wire diameter, pitch, and turns to optimize coupling and reduce energy dissipation;
   e. testing the smart card 1 for compliance with EMV standards, including CAB111 analog interference and CA144 digital timing.

Protection may be sought for combinations of features which are disclosed in the referenced earlier patent application U.S. Ser. No. 18/680,339 of 31 May 2024 and U.S. Ser. No. 19/222,663 of 29 May 2025, the contents of which are herein incorporated by reference. It is disclosed there how these features combinations contribute to achieving the technical aim of the present application and they are thus comprised in the solution of the technical problem underlying the subject matter of the present application. The features and combinations which are disclosed in the reference documents implicitly belong to the description of the subject matter in the present application and thus to the content of the present application as filed.

REFERENCE NUMERAL LIST

| | |
|---|---|
| 1 | smart card |
| 2 | IC module/chipcard module |
| 3 | first coil |
| 4 | third coil |
| 5 | antenna substrate |
| 6 | microchip |
| 8 | IC module coil |
| 9 | module substrate |
| 10 | card substrates |
| 11 | engagement holes |
| 12 | second coil |
| 13 | dam-and-fill encapsulation material |
| 15 | capacitive element |
| 20 | alternative engagement holes |
| 21 | gold plating |
| 22 | Ni plating |
| 23 | copper foil |
| 24 | adhesive layer |
| 25 | electrodes |
| 26 | through-holes/via hole |
| 27 | wire bonding |
| 30 | overlay layer |
| 31 | PVC layer |
| 32 | printed layer |
| 34 | antenna sheet |
| 35 | compensation layer |
| 40 | first antenna bonding wire |
| 41 | second antenna bonding wire |
| 42 | first antenna chip pad |
| 43 | second antenna chip pad |
| 50 | first antenna end |
| 51 | second antenna contact pad/second antenna end |
| 55 | upper via end |
| 56 | lower via end |
| 57 | Bridge |
| 58 | lower bridge bonding contact area |
| 60 | conductive traces |
| 70 | ISO contact pad |
| 71 | Pin #1 ISO contact pad VCC |
| 72 | Pin #2 ISO contact pad Reset |
| 73 | Pin #3 ISO contact pad CLOCK |
| 74 | Pin #4 ISO contact pad AS/Application Specific |
| 75 | Pin #5 ISO contact pad GND/Ground |
| 76 | Pin #6 ISO contact pad VPP/NC/Not Connected |
| 77 | Pin #7 ISO contact pad I/O, In/out |
| 78 | Pin #8 ISO contact pad AS/Application Specific |
| 80 | Encapsulation material/Providing encapsulation material |
| 81 | ISO contact set |
| 82 | antenna side |
| 83 | bonding side |
| 84 | contact side |
| 85 | LA first antenna chip pad |
| 86 | LB second antenna chip pad |
| 87 | Bonding side Cu foil/Bonding side conductive |
| | foil layer/Side conductive foil layer |
| 88 | Au layer |
| 89 | Contact side Cu layer/Contact side conductive |
| | foil layer/Side conductive foil layer |
| 90 | bonding hole |
| 91 | Conductive paste/Conductive material |
| 92 | Chip adhesive |
| 93 | Insulating substrate layer |
| 94 | Insulating substrate layer of the module substrate |
| 200 | External reader |
| 1000 | method for forming a smart card |
| 1002 | method step 1 |
| 1004 | method step 2 |
| 1006 | method step 3 |
| 1008 | method step 4 |
| 1010 | method step 5 |
| 1012 | method step 6 |

1. A smart card comprising:
a substrate supporting a dual-interface antenna system and a chipcard module with an IC chip and an IC module coil;
wherein the chipcard module is integrated into the antenna system, the antenna system comprising a first coil, an antenna coil and a second coil, wherein the antenna system is configured to interface with external systems for contactless and contact-based operations, the second coil comprising wire which comprises copper, gold, steel, or silver;
wherein the chipcard module comprises:
a number of conductive traces, including those forming the IC module coil;
a module substrate having an antenna side, a bonding side and a contact side, the module substrate comprising an insulating substrate layer disposed between a bonding side conductive foil layer and a contact side conductive foil layer, wherein the bonding side conductive foil layer and the contact side conductive foil layer are adhered to the insulating substrate layer by means of an adhesive layer; and
a bridge formed from a conductive material layer, connecting the antenna side to the bonding side, the bridge being disposed over an insulating layer that partially covers the conductive traces, such that the bridge serves an electrical interconnection element between the IC chip and one end of the IC module coil, which is located on the antenna side; and
wherein the IC chip is mounted on the bonding side of the module substrate using a chip adhesive.

2. A smart card comprising:
a substrate supporting a dual-interface antenna system and a chipcard module with an IC chip and an IC module coil,
wherein the chipcard module is integrated into the antenna system, the antenna system comprising a first coil, an antenna coil and a second coil, wherein the antenna system is configured to interface with external systems for contactless and contact-based operations, the second coil comprising wire which comprises copper, gold, steel, or silver,
wherein the chipcard module comprises:
a number of conductive traces, including those forming the IC module coil,
an ISO contact set with a number of ISO contact pads,
a module substrate having an antenna side and a contact side,
a bonding side conductive foil layer at a bonding side of an insulating substrate layer which is part of the module substrate,
the conductive traces and contact pads being provided in the bonding side conductive foil layer,
a via hole in the bonding side conductive foil layer and in the insulating substrate layer,
a contact-side conductive foil layer at a contact side of the insulating substrate layer which corresponds to the contact side of the module substrate, wherein the contact side conductive foil layer includes conductive traces and contact pads, and
conductive material in the via hole, electrically connecting a section of the conductive traces in the bonding side conductive foil layer and a section of the contact side conductive foil layer,
wherein the IC chip is located above the bonding side of the module substrate,
wherein a first predetermined contact pad of the IC chip is connected to an antenna contact pad surface area above the bonding side conductive foil layer by a first antenna bonding wire,
wherein a second predetermined contact pad of the IC chip is located above a bonding side surface of the ISO contact pads and is connected by a bond wire passing through a bonding hole, and
wherein the conductive material in the via hole electrically connects a section of the conductive traces to one of the ISO standard contact pads C6, C4, or C8, and the second predetermined contact pad of the IC chip is connected above a bonding side surface of the same ISO standard contact pad C6, C4, or C8.
